(19) United States
(12) Patent Application Publication
(10) Pub. No.: US 2025/0166026 A1
(43) Pub. Date: May 22, 2025

(54) PRODUCT REVIEWS GENERATION AND ANALYSIS PLATFORM

(71) Applicant: Roku, Inc., San Jose, CA (US)

(72) Inventors: Arthur Man Lok, New York City, NY (US); Michael Richard Sanders, Cambridge (GB); Ritwick Babbar, Fremont, CA (US); Ronica Jethwa, Mountain View, CA (US); Sunil Ramesh, Saratoga, CA (US)

(73) Assignee: Roku, Inc., San Jose, CA (US)

(21) Appl. No.: 18/788,469

(22) Filed: Jul. 30, 2024

Related U.S. Application Data
(63) Continuation-in-part of application No. 18/511,873, filed on Nov. 16, 2023.

(51) Int. Cl. G06Q 30/0282

(52) U.S. Cl. CPC G06Q 30/0282

(57) ABSTRACT

There is significant manual work in analyzing product reviews. Even if there are sufficient resources, human reviews can be inconsistent and subjective. A product review analysis platform leveraging engineered prompts and a large language model can address some of these issues. The platform includes a pipeline to summarize reviews, produce sentiment scores to rating categories, detect negative sentiment, extract main categories tags, extract sub-categories tags within a main categories tag, and produce weekly summaries. A dashboard can be included to visualize the enriched reviews. In some cases, synthetic users may fill in data gaps. An action recommendation engine can be included to determine appropriate resolutions. In some cases, the feature vectors generated by the large language model in response to receiving an engineered prompt can be stored in a vector database along with appropriate resolutions, such that incoming reviews can be routed appropriately using the vector database.

### CROSS-REFERENCES TO RELATED APPLICATIONS

This non-provisional application is a Continuation-in-Part application of U.S. non-provisional application, titled “USE A GENERATIVE MODEL TO CREATE SYNTHETIC USERS FOR TESTING AND ANALYSIS”, Ser. No. 18/511,873, and filed on Nov. 16, 2023. The US non-provisional application is hereby incorporated by reference in its entirety.

### TECHNICAL FIELD

This disclosure relates generally to data analysis platforms, and more specifically, platforms to generate and/or analyze product reviews.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates using a large language model (LLM) to generate summaries and sentiment scores, according to some embodiments of the disclosure.

FIG. 2 illustrates a component to generate a summarize prompt, according to some embodiments of the disclosure.

FIG. 3 illustrates a component to generate a rate sentiment prompt, according to some embodiments of the disclosure.

FIG. 4 illustrates using an LLM to generate negative sentiment Boolean flags, main categories tags, and sub-categories tags, according to some embodiments of the disclosure.

FIG. 5 illustrates a component to generate a negative sentiment detection prompt, according to some embodiments of the disclosure.

FIG. 6 illustrates a component to generate a main categories issue tagging prompt, according to some embodiments of the disclosure.

FIG. 7 illustrates a component to generate a sub-categories issue tagging prompt, according to some embodiments of the disclosure.

FIG. 8 illustrates using an LLM to generate time-period positive and negative summaries and a component to combine sentiment scores, according to some embodiments of the disclosure.

FIG. 9 illustrates a component to generate a time-period summarize prompt, according to some embodiments of the disclosure.

FIG. 10 illustrates a dashboard to visualize weekly summaries and enriched reviews, and an action recommendation engine, according to some embodiments of the disclosure.

FIG. 11 illustrates a graphical user interface displaying an average customer rating and average sentiment scores, according to some embodiments of the disclosure.

FIG. 12 illustrates a graphical user interface displaying average sentiment scores over time, according to some embodiments of the disclosure.

FIG. 13 illustrates a graphical user interface displaying proportions of different issue categories, according to some embodiments of the disclosure.

FIG. 14 illustrates a graphical user interface displaying proportions of different issue categories over time, according to some embodiments of the disclosure.

FIG. 15 illustrates a graphical user interface displaying frequencies of different issue categories over time, according to some embodiments of the disclosure.

FIG. 16 illustrates a graphical user interface displaying week over week changes of different issue categories, according to some embodiments of the disclosure.

FIG. 17 illustrates a graphical user interface displaying week over week changes of different issue sub-categories, according to some embodiments of the disclosure.

FIG. 18 illustrates a graphical user interface displaying proportions of different issue sub-categories within each issue category, according to some embodiments of the disclosure.

FIG. 19 illustrates a graphical user interface displaying weekly summaries, according to some embodiments of the disclosure.

FIG. 20 illustrates a graphical user interface displaying weekly summaries, according to some embodiments of the disclosure.

FIG. 21 illustrates identifying gaps and generating synthetic product reviews, according to some embodiments of the disclosure.

FIG. 22 illustrates user data used to build synthetic user memories, according to some embodiments of the disclosure.

FIG. 23 illustrates examples of structured data and examples of unstructured data, according to some embodiments of the disclosure.

FIG. 24 illustrates creating synthetic user memory, according to some embodiments of the disclosure.

FIG. 25 illustrates evaluation of a generated response and modification of synthetic user memory, according to some embodiments of the disclosure.

FIG. 26 illustrates obtaining synthetic population responses and storing the responses in a database for further analysis, according to some embodiments of the disclosure.

FIG. 27 illustrates a content delivery pipeline and a quality control process, according to some embodiments of the disclosure.

FIG. 28 illustrates using an LLM to generate summaries and sentiment scores, according to some embodiments of the disclosure.

FIG. 29 illustrates using an LLM to generate negative sentiment Boolean flags, main categories tags, and sub-categories tags, according to some embodiments of the disclosure.

FIG. 30 illustrates a dashboard to visualize enriched quality reviews, and an action recommendation engine, according to some embodiments of the disclosure.

FIG. 31 is a flow chart illustrating a method for analyzing reviews, according to some embodiments of the disclosure.

FIG. 32 is a flow chart illustrating a method for generating reviews, according to some embodiments of the disclosure.

FIG. 33 is a flow chart illustrating a method for predicting resolutions to reviews, according to some embodiments of the disclosure.

FIG. 34 is a block diagram of an exemplary computing device, according to some embodiments of the disclosure.

### DETAILED DESCRIPTION

### Overview

Products and competitors' products are frequently reviewed by purchasers on e-commerce platforms or through customer service portals. Product reviews may include natural language text written or spoken by the purchasers of a product. An example of a product review can include:

This Glarium PixelBrite TV is such a waste of money. I paid like 5 grand for it thinking it would be good but man did I get ripped off big time! The picture quality sucks even though its 8K resolution. Images look blurry and fuzzy like an old TV. The colors are really ugly too, looking all faded and washed out even with HDR mode on. Blacks look gray and brights are blown out. And if you don't sit right in front the picture gets way worse from the angles, all smudgy and gross looking.
The motion is terrible as well. Everything has crazy shudder and blur when stuff is moving fast on screen. The 240 hz refresh rate or whatever can't fix it at all, still looks super crappy. And the smart TV stuff feels straight out of the 90s—missing all the apps I need and the menus are slow as molasses.
Setup was a total hassle too. I struggled for hours just to get it on Wi-Fi because the instructions made zero sense. The remote feels cheap and flimsy.
Overall this PixelBrite just looks chintzy and low quality despite being marketed as a premium high-end TV. It's got thick chunky bezels and the stand wobbles around unsteadily.
When you add it all up, this Glarium is a complete overpriced piece of crap TV. The picture and motion quality is terrible, the smart features are lame, and the build quality stinks. There's no way it's worth the insane prices they're asking. I'm probably just gonna return this garbage and get my money back because it's not even worth a fraction of what I paid. Don't make my mistake and stay far away from the PixelBrite Max ripoff!

The above example of a product is lengthy and addresses a number of issues. While the language suggests a strong negative sentiment, some other reviews may have more nuanced sentiment. It can be time consuming and difficult for a human analyst to digest the review and note insights from the review. At the same time, it can be beneficial for a product engineer, designer, seller, and manufacturer to better understand, at a large scale, purchasers' opinions and reviews about a company's products and competitors' products.

There is significant manual work in analyzing product reviews. One may appreciate that processing the example product review is not an easy task. Manual analysis of product reviews include reading, understanding, extracting insights, and tracking changes over time. It can be difficult to easily scale review analysis to large quantities of reviews across a wide breadth of products.

Even if there are sufficient resources, human analysis can be inconsistent and subjective. Training of human analysts may ameliorate the issue, but the human factor remains. It can be difficult to have human analysts apply a consistent standard so that the outputs of the analysis wouldn't depend on who is conducting it.

A product review analysis platform leveraging engineered prompts and a large language model can address some of these issues. The platform includes a pipeline to summarize reviews, produce sentiment scores to rating categories, detect negative sentiment, extract main categories tags, extract sub-categories tags within a main categories tag, and produce time-period summaries. The platform utilizes one or more prompt generators and one or more LLMs.

The platform can output summaries. A summarize prompt may be generated by a prompt generator and input into an LLM, and the LLM can generate a summary in response to receiving the summarize prompt. The summarize prompt may include a product review and an instruction to summarize the product review in under, e.g., 50 words. The summarize prompt may include a role definition for the LLM. The summarize prompt may include domain information as context. The summarize prompt may include few-shot examples. The summarize prompt may include a further instruction to cover all feedback mentioned in the product review in a succinct way. The summarize prompt may include a further instruction to maintain the perspective of the user (the reviewer) in the summarized output. The summarize prompt may include a further instruction to return a null value if the product review is unintelligible. The summarize prompt may include a further instruction to return a null value if the product review is blank. A null value may be represented as null or NULL.

The platform can output integer valued sentiment scores, e.g., from 0 to 5, (or a null value) to various rating categories, such as “picture score”, “sound score”, “ease of use score”, “price/value score”. “customer service score”, “overall sentiment score”, etc. A rate sentiment prompt may be generated by a prompt generator and input into an LLM. In response to receiving the rate sentiment prompt, the LLM can generate key-value pairs, where keys correspond to the various rating categories, and the values correspond to the integer valued sentiment scores or a null value. The rate sentiment prompt may include a product review, a rating instruction to return either an integer sentiment score or a null value for each one of the rating categories, a weighing instruction to increase a value for the integer sentiment score for a presence of keyword(s) having a specific connotation (e.g., “reviews that contains words like ‘great’, ‘excellent’, or ‘love’ should be more heavily weighted towards 5 as they have a highly positive connotation”). The rate sentiment prompt may include a role definition for the LLM. The rate sentiment prompt may include domain information as context. The rate sentiment prompt may include few-shot examples. The rate sentiment prompt may further include the rating categories and definitions associated with the rating categories. The rate sentiment prompt may include an instruction requesting an integer sentiment score to be returned if the rating category is relevant. The rate sentiment prompt may include an instruction requesting an integer sentiment score to be returned only when there is an explicit mention of the rating category. The rate sentiment prompt may include a guiding instruction to include an integer sentiment score for a rating category (e.g., “price/value score”), for a presence of keyword(s) associated with the rating category (e.g., “for price/value, the review MUST contain keywords like ‘price’, ‘cheap’, ‘expensive’, or ‘value’ to return a score”). The rate sentiment prompt may include an instruction to include an overall sentiment score of the product review. The rate sentiment prompt may include an instruction to return the key-value pairs in a specific format.

The platform can output a negative sentiment Boolean flag that indicates whether a product review is at least partly negative or doesn't have a completely positive sentiment. In some embodiments, the negative sentiment Boolean flag gates whether issue tagging will be performed for a given product review. A negative sentiment detection prompt may be generated by a prompt generator and input into an LLM. In response to receiving the negative sentiment detection prompt, the LLM can generate the negative sentiment Boolean flag. The flag=1 indicates that the product review is not completely positive or is partly negative. The flag=0 indicates that the product review is completely positive. The negative sentiment detection prompt may include a product review. The negative sentiment detection prompt may include a role definition for the LLM. The negative sentiment detection prompt may include few-shot examples. The negative sentiment detection prompt may include a weighing instruction to return a value of 0 when the product review is completely positive without reservations. The negative sentiment detection prompt may include a further weighing instruction to return a value of 0 when the product review is incomplete or missing. The negative sentiment detection prompt may include a further weighing instruction to return a value of 1 when the product review is at least partly negative or has a qualifying statement.

The platform can output one or more main categories tags if the product review has a negative sentiment. In response to determining or detecting that the product review has a negative sentiment, the LLM may be instructed by a main categories tagging prompt to select from a list of provided main categories tags the ones that are relevant to the negative sentiment in the product review, and output the selected main categories tag(s). The one or more main categories tags can include one or more main issues relating to the product, e.g. “hardware”, “remote”, “content”, “operating system”, “video”, “audio”, “setup”, “connectivity”, “mobile app”, “miscellaneous”, “customer support”, “shopping experience”, etc. A main categories tagging prompt may be generated by a prompt generator and input into an LLM. In response to receiving the main categories tagging prompt, the LLM can generate a list of one or more main categories tags. The main categories tagging prompt may include a product review and a plurality of main categories tags. The main categories tagging prompt may include a role definition for the LLM. The main categories tagging prompt may include domain information as context. The main categories tagging prompt may include few-shot examples. The main categories tagging prompt can include one or more sub-categories associated with each one of the main categories tags. main categories tagging prompt can include a guiding instruction to include a first main categories tag (e.g., “remote”) rather than a second main categories tag (e.g., “hardware”) for a third presence of an issue associated with the first main categories tag. The main categories tagging prompt can include an instruction to first determine whether the product review has a negative sentiment, and output one or more main categories tags only if the product review is determined to have a negative sentiment. The main categories tagging prompt can include a further instruction to output no main categories tags if the product review is determined to have no negative sentiment at all.

The platform can output one or more sub-categories tags if a main categories tag was identified. In some embodiments, in response to determining or detecting that a main categories tag was relevant to the product review, the LLM may be instructed by a sub-categories tagging prompt to select from a list of provided sub-categories tags the ones that are relevant to the negative sentiment in the product review, and output the selected sub-categories tag(s). The one or more sub-categories tags falling under a main categories tag, e.g., “hardware” can include one or more specific issues relating to the product, e.g., “hardware | device is too hot”, “hardware | accessory is damaged or missing”, “hardware | accessory feedback”, “hardware | device is turning on/off unprompted”, etc. A sub-categories tagging prompt may be generated by a prompt generator and input into an LLM. In response to receiving the sub-categories tagging prompt, the LLM can generate a list of one or more sub-categories tags. The sub-categories tagging prompt may include a product review and a table. The table may include first sub-categories tags falling under a first main categories tag in a first column, first descriptions of the first sub-categories tags in a second column, and first examples of product reviews falling under the first sub-categories tags in a third column. The sub-categories tagging prompt may include a role definition for the LLM. The sub-categories tagging prompt may include domain information as context. The sub-categories tagging prompt may include few-shot examples. The sub-categories tagging prompt can include an instruction to first determine whether the product review has a negative sentiment, and output one or more sub-categories tags only if the product review is determined to have a negative sentiment. The sub-categories tagging prompt can include a further instruction to output no sub-categories tags if the product review is determined to have no negative sentiment at all.

The platform can output a time-period summary, such as a weekly summary, which may summarize a group of reviews for a time-period, such as a week. The time-period summary may include a first natural language summary of positive sentiment, one or more first topics associated with positive sentiment, one or more first examples associated with each one of the one or more first topics, a second natural language summary of negative sentiment, one or more second topics associated with negative sentiment, and one or more second examples associated with each one of the one or more second topics. In some cases, the time-period summary can include a first number of mentions for each one of the one or more first topics and a second number of mentions for each one of the one or more second topics. A time-period summarize prompt may be generated by a prompt generator and input into an LLM. In response to receiving the time-period summarize prompt, the LLM can generate the time-period summary. The time-period summary prompt includes one or more (product review) summaries that the LLM generated in response to receiving summarize prompts. The time-period summary prompt may include a role definition for the LLM. The time-period summary prompt may include domain information as context. The time-period summary prompt may include an instruction to output the first natural language summary of positive sentiment, the one or more first topics associated with positive sentiment, the one or more first examples associated with each one of the one or more first topics, the second natural language summary of negative sentiment, the one or more second topics associated with negative sentiment, and the one or more second examples associated with each one of the one or more second topics. In some cases, the time-period summary prompt may include a further instruction to output the first number of mentions for each one of the one or more first topics and the second number of mentions for each one of the one or more second topics. The time-period summary prompt may include an instruction to summarize a group of reviews for positive sentiment. The time-period summary prompt may include an instruction to summarize the group of reviews for negative sentiment. The time-period summary prompt may include an instruction to list one or more first (positive sentiment) topics in the group of reviews. The time-period summary prompt may include an instruction to list one or more second (negative sentiment) topics in the group of reviews. The time-period summary prompt may include an instruction to list the one or more first topics in descending order of prevalence in the group of reviews. The time-period summary prompt may include an instruction to list the one or more second topics in descending order of prevalence in the group of reviews. The time-period summary prompt may include a task-specific instruction to ignore a product review in the summaries and topics if the product review is unintelligible. The time-period summary prompt may include a task-specific instruction to ignore a product review in the summaries and topics if the product review is uninformative. The time-period summary prompt may include a task-specific instruction to maintain a specific format but leave blank as necessary if there are not enough data in the provided product reviews to summarize. The time-period prompt may include a specific format and a formatting instruction to utilize the specific format in the response.

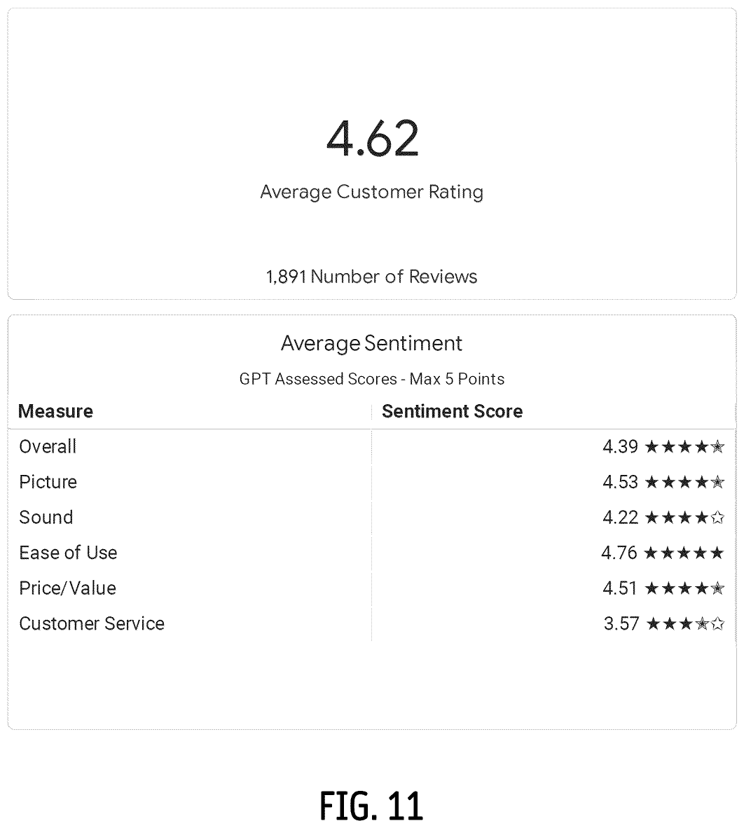

The LLM, when prompted with engineered prompts, can output structured product review data, which is referred to herein as enriched reviews. Enriched reviews can be processed to gain insights. The dashboard can be included to visualize the enriched reviews and insights. The enriched reviews represent a dataset that would allow human analysts to easily understand and analyze trends, issues, and how users feel about different aspects of a product across thousands of reviews and different product lines without having to rely on human analysts to go through the thousands of reviews manually. Examples of graphical user interfaces of the dashboard are shown in FIGS. 11-20.

Not only the platform can analyze reviews at a large scale, but the platform can also apply a consistent standard for how reviews are tagged/scored/and summarized. In some embodiments, the temperature (a hyperparameter) of the LLM is set to zero or a relatively low value to minimize variation and randomness in the generated outputs. The platform can be used to consistently and systematically compare reviews of products without issues typically caused by human bias.

In some cases, synthetic users may fill in data gaps. The enriched reviews database may have data gaps, and the data gaps may be identified based on the enriched database. Some products may have insufficient product reviews. A product may have insufficient product reviews from a specific demographic. Synthetic users may be built using a memory log, a prompt chain generated from the memory log, and an LLM. Synthetic users may be used to generate product reviews, e.g., product reviews to help fill the data gaps. In some cases, a synthetic user may be prompted to output a predicted resolution to a product review.

An action recommendation engine can be included to determine appropriate resolutions. In some cases, the action recommendation engine may process the enriched reviews to perform issue to action mapping. In some cases, the action recommendation engine may process the enriched reviews to perform sentiment score to severity mapping. In some cases, the action recommendation engine may perform trend to escalation ladder mapping. Results from the action recommendation engine may be output to a user via a dashboard.

In some cases, the action recommendation engine may include a vector database. Feature vectors (or feature embeddings, or latent feature representations of the prompts) generated by the large language model in response to receiving an engineered prompt can be stored in a vector database as keys along with appropriate resolutions as values to the keys. Incoming reviews can be routed appropriately using the vector database. An incoming product review may be put into a suitable prompt (such as one of the engineered prompts described herein), and the prompt may be input into an LLM to generate a feature vector. The feature vector may be used to search for one or more matching feature vectors in the keys of the vector database. One or more values in the vector database corresponding to the one or more matching feature vectors can include one or more resolutions to the incoming product review.

The present disclosure discusses embodiments applied to product reviews of a consumer electronics device. In some cases, the product is a content item. The product reviews may include natural language texts written by quality control reviewers about a quality control aspect of a pipeline that delivers content item to the quality control reviewer. It is envisioned that the embodiments can be extended to other types of products and services.

### Large Language Models

Various embodiments of the product reviews generation and analysis platform described herein involve one or more large language models. A large language model is a type of artificial intelligence system that uses deep learning techniques, specifically transformers and self-attention mechanisms, to process and generate human-like text based on patterns learned from vast amounts of training data. A large language model has a transformer-based architecture. The transformer is one of the building blocks of a large language model. The transformer is a type of neural network that uses self-attention mechanisms to capture long-range dependencies in sequential data, such as text. The transformer architecture includes an encoder and a decoder, both having multiple (multi-head) attention layers and feed-forward neural network layers.

A large language model may include embeddings layer, an encoder, a decoder, and output layer. Embeddings layer converts the input text into numerical vector representations called embeddings. These embeddings represent the semantic and syntactic properties of words, allowing the large language model to understand the meaning and context of the input. Since the transformer architecture does not have an inherent notion of word order, positional encodings can be added to the input embeddings to provide the model with information about the position of each word in the sequence. The encoder processes the input sequence and creates a context-aware representation. The encoder includes multiple attention layers and feed-forward neural network layers. The decoder takes the encoded input representation from the encoder and generates the output sequence, token by token. The decoder can autoregressively generate output tokens one by one, attending to the encoded input and the previous output. The decoder includes multiple attention layers and feed-forward neural network layers. The output layer takes the representations from the decoder and can output probability distributions over the vocabulary for the next token in the sequence.

The attention layers allow the model to weigh different parts of the input sequence when producing the output. The attention mechanism enables the model to focus on the most relevant parts of the input for a given task, such as generating a coherent and contextually appropriate response. Multi-head attention is a technique that allows the large language model to attend to different representations of the input simultaneously. Multi-head attention may include several attention heads, each of which learns to attend to different aspects of the input, improving the model's ability to capture complex relationships and patterns.

Feed-forward neural network layers apply non-linear transformations to the output of the attention layers, allowing the model to learn more complex representations of the input data.

The input text, or a sequence of input tokens, received and processed by a large language model is referred to as a prompt. A prompt may include a sequence of words and characters. The words and characters may be converted by the large language model into a sequence of tokens.

An output of a layer, e.g., an output of the encoder, in a large language model may produce a feature vector, or a feature embedding. The feature vector can include latent representations of the input text or the sequence of input tokens.

Various embodiments of the product generation and analysis platform may include a large language model. The large language model may be a pre-trained large language model. The large language model may be a fine-tuned large language model that is trained for a specific task or domain. There may be more than one large language model, e.g., different fine-tuned large language models, used in the various embodiments.

### Product Reviews Analysis Platform

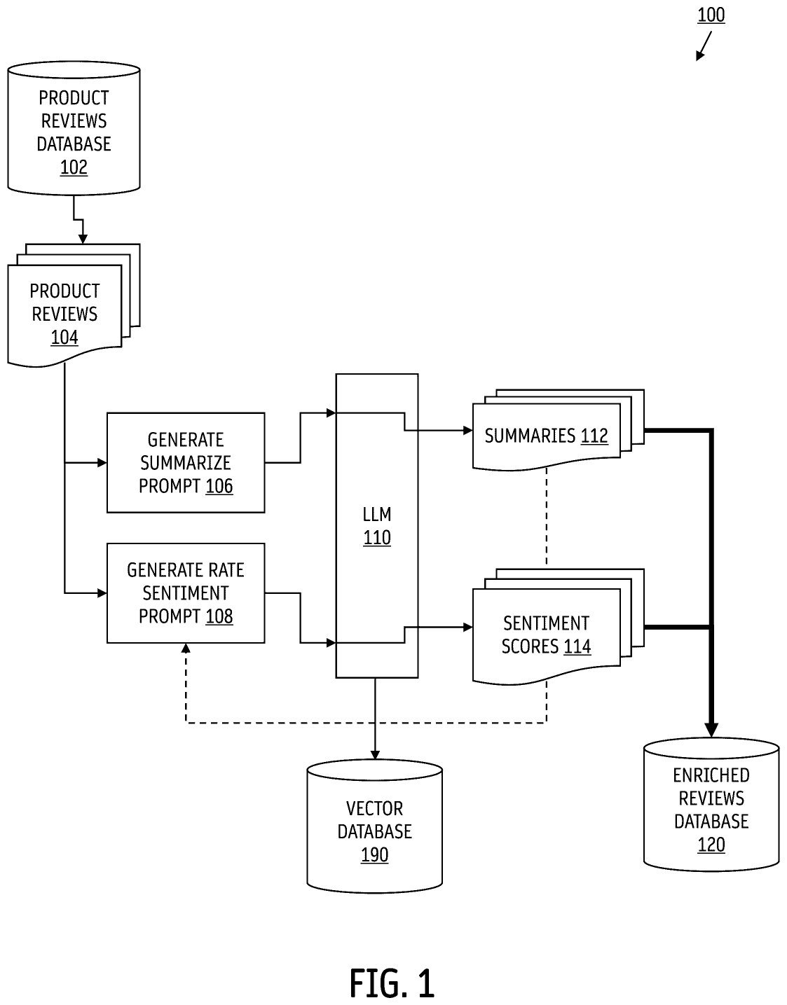

FIG. 1 illustrates using an LLM to generate summaries and sentiment scores, according to some embodiments of the disclosure. System 100 can include one or more of: product reviews database 102, product reviews 104, generate summarize prompt 106, generate rate sentiment prompt 108, LLM 110, vector database 190, summaries 112, sentiment scores 114, and enriched reviews database 120.

Product reviews database 102 may store reviews of products. A product review may include natural language text that represents evaluations or assessments of products. A product review may include natural language text written by a purchaser of the consumer electronics device about one or more of: a user experience of the purchaser using the consumer electronics device and a purchasing experience of the purchaser purchasing the consumer electronics device. A product review can be written by customers who have purchased and used the product. A product review can provide feedback, opinions, and insights about various aspects of the product, such as its quality, performance, features, durability, value for money, and overall user experience. Product reviews can be found on various platforms, including e-commerce websites, dedicated review sites, social media platforms, and personal blogs. Product reviews may be provided via customer service portals. Examples of products can include electronics, appliances, content items, books, movies, restaurants, and services.

One or more product reviews 104 may be retrieved from product reviews database 102. The one or more product reviews 104 may be associated with a specific product. The one or more product reviews 104 may be associated with a specific product series (e.g., professional series, standard series, low-cost series, etc.). One or more product reviews 104 may be associated with a specific user. One or more product reviews 104 may be associated with a specific demographic of users.

System 100 includes one or more prompt generators, e.g., generate summarize prompt 106, and generate rate sentiment prompt 108. A prompt generator may receive a first product review for a product (shown as one or more product reviews 104).

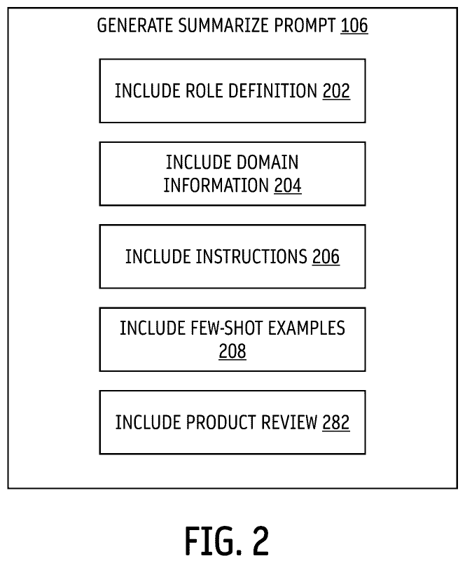

Generate summarize prompt 106 may generate a first summarize prompt. The first summarize prompt is engineered to instruct LLM 110 to produce a summary of the first product review. Generate summarize prompt 106 may input the first summarize prompt into LLM 110. The first summarize prompt may include the first product review. Generate summarize prompt 106 and examples of a summarize prompt are described in greater detail in FIG. 2. LLM 110 may generate a first summary of the first product review generated in response to LLM 110 receiving the first summarize prompt. The first summary may be received and stored in enriched reviews database 120.

Generate summarize prompt 106 may be used to generate a plurality of summarize prompts for different product reviews, such as different product reviews for a particular product, different product reviews for a particular product series, different product reviews from a specific demographic, different product reviews dated within a particular time-period, etc. LLM 110 may generate summaries 112 in response to receiving the summarize prompts. Summaries 112 may be stored in enriched reviews database 120. Summaries 112 (instead of the unprocessed product reviews 104) may be used by a subsequent part of the platform.

In some embodiments, generate summarize prompt 106 may receive a second product review for the product. The first product review and the second product review may be associated with a same time-period, e.g., the past week, the past month, the past 3 months, etc. Generate summarize prompt 106 generate a second summarize prompt. Generate summarize prompt 106 may input the second summarize prompt into LLM 110. The second summarize prompt may include the second product review. LLM 110 may generate a second summary of the first product review generated in response to LLM 110 receiving the second summarize prompt. The second summary may be received and stored in enriched reviews database 120.

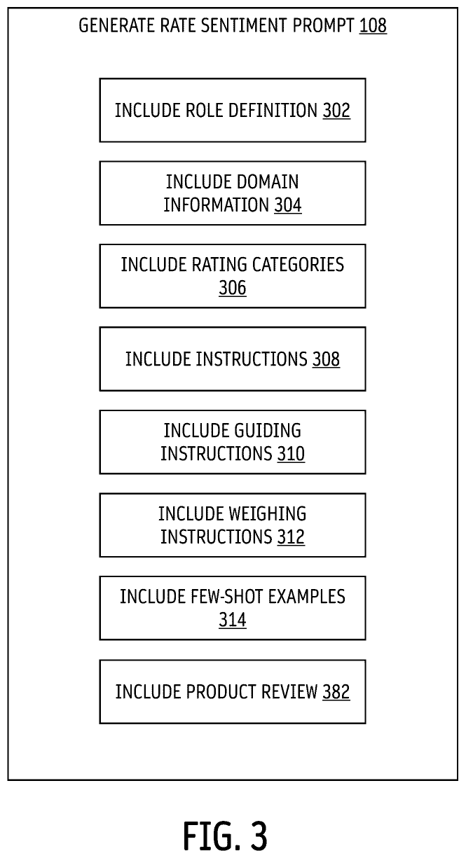

Generate rate sentiment prompt 108 may generate a rate sentiment prompt. Generate rate sentiment prompt 108 may input the rate sentiment prompt into LLM 110. The rate sentiment prompt is engineered to instruct LLM 110 to produce sentiment scores relating to different rating categories based on the first product review. The sentiment scores may be organized as key-value pairs. The rate sentiment prompt can include the first product review. The rate sentiment prompt can include a first rating instruction to return either an integer sentiment score or a null value for each one of a plurality of rating categories. The rate sentiment prompt can include a first weighing instruction to increase a value for the integer sentiment score for a first presence of one or more first keywords having a specific connotation. Generate rate sentiment prompt 108 and examples of a rate sentiment prompt are described in greater detail in FIG. 3. LLM 110 may generate one or more key-value pairs in response to receiving the rate sentiment prompt. The key-value pairs represent sentiment scores, preferably in a structured format, extracted from the first product review. The keys may correspond to the plurality of rating categories. The values may correspond to the integer sentiment score or a null value. The one or more key-value pairs generated in response to LLM 110 receiving the rate sentiment prompt may be received and stored enriched reviews database 120.

Generate rate sentiment prompt 108 may be used to generate a plurality of rate sentiment prompts for different product reviews, such as different product reviews for a particular product, different product reviews for a particular product series, different product reviews from a specific demographic, different product reviews dated within a particular time-period, etc. LLM 110 may generate sentiment scores 114 in response to receiving the rate sentiment prompts. Sentiment scores 114 may be stored in enriched reviews database 120. Sentiment scores 114 may be used by a subsequent part of the platform.

While not shown explicitly, system 100 may include a post processing component to 110 are stored in enriched reviews database 120.

Vector database 190 may store and efficiently retrieve high-dimensional vector data, such as numerical data representations of text. LLM 110 may produce feature vectors that are numerical data representations of the engineered prompts that LLM 110 receives. Vector database 190 may store the feature vectors that LLM 110 generates in a specialized data structure or data store optimized for fast similarity searches. The feature vectors may be stored as keys in vector database 190. The keys may have corresponding values associated with the keys. In some embodiments, feature vectors that LLM 110 generates in response to receiving a summarize prompt may be stored in vector database 190. In some embodiments, feature vectors that LLM 110 generates in response to receiving a rate sentiment prompt may be stored in vector database 190.

FIG. 2 illustrates a component to generate a summarize prompt, according to some embodiments of the disclosure. Generate summarize prompt 106 may receive a product review and produce a summarize prompt for the product review. The summarize prompt may include an instruction to summarize reviews in under a certain number of words (e.g., 50 words). The summarize prompt may include an instruction to retain all feedback in the product review in a succinct way. The summarize prompt may include few-shot examples to influence the style and structure of LLM 110's generated summary. Generate summarize prompt 106 may include one or more of: include role definition 202, include domain information 204, include instructions 206, include few-shot examples 208, and include product review 282.

Include role definition 202 may include natural language text in the summarize prompt that defines a role of LLM 110. Role definition may influence how LLM 110 may respond. An example of a role definition to be included as part of the summarize prompt is as follows:

You are an Artificial Intelligence assistant that performs product review analysis. The reviews to be analyzed are Glarium product reviews.

Include domain information 204 may include natural language text in the summarize prompt that provides contextual or background information about the product review. Domain information may influence how LLM 110 may respond. An example of domain information to be included as part of the summarize prompt is as follows:

Glarium's primary product is its streaming platform, which comes installed on TVs (third party manufacturers or Glarium manufactured) and Glarium streaming players (plugs into HDMI port with Glarium Operating System installed). From the Glarium home screen, users can find and access a broad selection of free and paid movies and TV episodes, as well as live TV, news, sports, hit movies, popular shows, and more, that are available from the thousands of streaming channels.
Glarium also sells audio products and smart home devices such as cameras and security systems. Products are sold by various retailers such as TechTopia, Silicon Alley, ElectroMart, or Glarium itself.
The specific product being reviewed will be named at the beginning of the review.

Include instructions 206 may include natural language text in the summarize prompt that provides task-specific instruction(s) of how LLM 110 should produce the summary.

Instruction(s) has an influence on how LLM 110 may respond. An example of one or more instructions to be included as part of the summarize prompt is as follows:

You return a summary of each review which is 50 words long at most. It should cover all feedback mentioned in the review in a succinct way and maintain the perspective from the reviewer's POV.
If the review is unintelligible or blank, return NULL.
Please perform a product review analysis on the following review.

### [INSERT PRODUCT REVIEW]

Include few-shot examples 208 may include several examples in the summarize prompt that provides examples of product reviews and corresponding summaries. The few-shot examples have an influence how LLM 110 may respond. In some embodiments, include few-shot examples 208 may retrieve examples which are related to the product. In some embodiments, include few-shot examples 208 may retrieve examples which are related to a certain demographic of users. Examples of few-shot examples to be included as part of the summarize prompt is as follows:

```
[
  (“Disappointed that it does not have an Ethernet jack. They all should in this day and
age of streaming.”, ‘Would like an Ethernet port. Expects it to be standard for streaming on
TVs'),
  (“I've had this tv for 14 months and it has been awesome! Not sure what's up with the
people giving it a bad review! Good picture good sound what's not to like. If you expect 4k
picture quality and movie theater sound out of a $100 tv your out of your minds! This thing
works just like advertised and you will not be disappointed”, ‘Good picture and sound quality
for a $100 TV.’),
  (“”,‘null’)
]
```

Include product review 282 may insert the product review of interest into the summarize prompt. In some cases, include product review 282 may preprocess the product review to remove certain words or punctuation before the product review is inserted into the summarize prompt. In some cases, include product review 282 may preprocess the product review to insert the product name into the product review.

FIG. 3 illustrates a component to generate a rate sentiment prompt, according to some embodiments of the disclosure. Generate rate sentiment prompt 108 may receive a product review and produce a rate sentiment prompt for the product review. The rate sentiment prompt may include an instruction to return a sentiment score (e.g., out of 3, out of 5, out of 10, etc.) in one or more rating categories. Examples of rating categories for a product may include “picture score”, “sound score”, “ease of use”, “price/value”, and “overall”. The “overall” score is not necessarily a function of the sentiment scores of the rating categories. The summarize prompt may include an instruction to not return a score if the product review is not relevant to the rating category. For example, a product review consisting of, “Great picture quality!” should return a highest sentiment score (e.g., a 5 out of 5) for picture rating category, but a null value for other rating categories. The rate sentiment prompt may include few-shot examples to influence the style and structure of LLM 110's generated summary. Generate rate sentiment prompt 108 may include one or more of: include role definition 302, include domain information 304, include rating categories 306, include instructions 308, include guiding instructions 310, include weighing instructions 312, include few-shot examples 314, and include product review 382.

Include role definition 302 may be implemented similarly or the same as include role definition 202. Include domain information 304 may be implemented similarly or the same as include domain information 204.

Include rating categories 306 may include natural language text in the rate sentiment prompt that lists the rating categories and definitions associated with the rating categories. The rating categories and definitions thereof restrict LLM 110 to respond to specific rating categories of interest. The definitions provide LLM 110 with keywords and context for the different rating categories so that LLM 110 may better pick up subtle cues in the product review. An example of the rating categories and definitions to be included as part of the rate sentiment prompt is as follows:

1. Picture: Feedback related to picture quality, screen brightness, colors, screen issues. Keywords include “picture”, “clear”, “screen”, or “value”.
2. Sound: Feedback related to sound quality, volume, needing to get separate audio products to supplement the TV audio. Keywords include “sound”, “soundbar”, “speakers”, or “audio”.
3. Ease of use: Feedback related to UI/UX, case of device setup, or any other difficulties the customer is having using the product. Keywords include “easy to use” or “installation”.
4. Price/Value: Feedback related to price or value of the product. Keywords include “price”, “cheap”, “expensive”, or “value”.
5. Customer Service: Feedback related to customer's experience with either Glarion or retailer's employees in purchasing the product.

Include instructions 308 may include natural language text in the rate sentiment prompt that provides task-specific instruction(s) of how LLM 110 should produce the sentiment scores (e.g., the key-value pairs). An instruction may include a rating instruction to return either an integer sentiment score or a null value for each one of a plurality of rating categories. An instruction may include a specific format and an instruction to utilize the specific format in the response, such as key-value pairs. Instruction(s) has an influence on how LLM 110 may respond. An example of one or more instructions to be included as part of the rate sentiment prompt is as follows:

Your primary task is to determine if the review gives any feedback on these different categories of the product:

### [INSERT RATING CATEGORIES AND DEFINITIONS]

If the category is applicable, return an integer sentiment score from 1 to 5 for that category.
Please ensure there is an explicit mention of the category or keywords when returning a score. For example, “good quality” on its own does not refer to picture or sound.
Otherwise, return NULL.

### [INSERT PRODUCT REVIEW]

Please determine if the review is related to any of the 5 categories and provide a sentiment score from 1-5 if so: Picture, Sound, Ease of Use, Price/Value, or Customer Service.
Also, provide an overall sentiment score for the review.
Please use the format: {“sentiment_picture”: #, “sentiment_sound”: #, “sentiment_ease_of_use”: #, “sentiment_price_value”: #, “sentiment_cs”: #, “sentiment_overall”: #}
For example, if the review raves about picture and sound quality and leaves no other feedback, then return {“sentiment_picture”: 5, “sentiment_sound”: 5, “sentiment_ease_of_use”: null, “sentiment_price_value”: null, “sentiment_cs”: null, “sentiment_overall”: 5}
Another example: If no categories are relevant but it was an overall positive review, then return {“sentiment_picture”: null, “sentiment_sound”: null, “sentiment_ease_of_use”: null, “sentiment_price_value”: null, “sentiment_cs”: null, “sentiment_overall”: 4}
Please don't add any other comments or notes as the answer must be in the exact format specified.

Include guiding instructions 310 may include natural language text in the rate sentiment prompt that provides information to assist LLM 110 to disambiguate between rating categories and guide LLM 110 to associate certain words in product reviews to a specific rating category. A guiding instruction may include an instruction to include an integer sentiment score for a first rating category in the plurality of rating categories for a second presence of one or more second keywords associated with the first rating category (in the product review). The guiding instruction(s) has an influence on how LLM 110 may respond and improve accuracy of LLM 110. An example of one or more guiding instructions to be included as part of the rate sentiment prompt is as follows:

For price/value, the review MUST contain keywords like “price”, “cheap”, “expensive”, or “value” to return a score.

Include weighing instructions 312 may include natural language text in the rate sentiment prompt that biases LLM 110 to give a higher or lower sentiment score when certain words having a strong positive or strong negative connotation is used. A weighing instruction may include an instruction to increase a value for the integer sentiment score for a first presence of one or more first keywords having a specific connotation (in the product review). The weighing instruction(s) has an influence on how LLM 110 may respond and improve accuracy of LLM 110. In some cases, LLM 110 may respond neutrally if a weighing instruction is not included in the rate sentiment prompt. An example of one or more weighing instructions to be included as part of the rate sentiment prompt is as follows:

Reviews that contain words like “great”, “excellent”, or “love” should be more heavily weighted towards 5 as they have a highly positive connotation.

Include few-shot examples 314 may include several examples in the rate sentiment prompt that provides examples of product reviews and corresponding sentiment scores. The few-shot examples have an influence on how LLM 110 may respond. In some embodiments, include few-shot examples 208 may retrieve examples which are related to the product. In some embodiments, include few-shot examples 208 may retrieve examples which are related to a certain demographic of users. Examples of few-shot examples to be included as part of the rate sentiment prompt is as follows:

For this review, “The Glarion 4K TV is outstanding. Incredible picture quality with vibrant 4K HDR images. Powerful built-in audio enhances movies and shows. Operating system for the TV is user-friendly with handy voice controls. An amazing all-around 4K TV that exceeds expectations for picture, sound, and ease of use. Highly recommended.”, you should return ““sentiment_picture”: 5, “sentiment_sound”: 5, “sentiment_ease_of_use”: 5, “sentiment_price_value”: NULL, “sentiment_cs”: NULL, “sentiment_overall”: 5}”
For this review, “The Glarion HD TV is fantastic. Super easy setup process. Customer service was extremely patient and helpful when I had questions. Been using it daily for weeks-very user-friendly and exceeds expectations. Highly recommend this product from Glarion based on the great experience from start to finish.”, you should return ““sentiment_picture”: NULL, “sentiment_sound”: NULL, “sentiment_case_of_use”: 5, “sentiment_price_value”: NULL, “sentiment_cs”: 5, “sentiment_overall”: 5}”
For this review, “While the picture quality on the Glarion 4K TV isn't as good as my previous higher-end set, it's still perfectly acceptable for the extremely affordable price.
At under $500 for a massive 65″ 4K display, it's an absolute steal. You get decent detail and brightness, plus smart capabilities-great value for casual viewing. The picture won't blow you away, but exceeds expectations considering the bargain cost. An acceptable budget 4K TV if you don't need premium image quality.”, you should return ““sentiment_picture”: 2, “sentiment_sound”: NULL, “sentiment_case_of_use”: NULL, “sentiment_price_value”: 4, “sentiment_cs”: NULL, “sentiment_overall”: 3}”
For this review, “While the picture quality on the Glarion 4K TV isn't as good as my previous higher-end set, it's still perfectly acceptable for the extremely affordable price.
At under $500 for a massive 65” 4K display, it's an absolute steal. You get decent detail and brightness, plus smart capabilities-great value for casual viewing. The picture won't blow you away, but exceeds expectations considering the bargain cost. An acceptable budget 4K TV if you don't need premium image quality.”, you should return ““sentiment_picture”: 2, “sentiment_sound”: NULL, “sentiment_case_of_use”: NULL, “sentiment_price_value”: 4, “sentiment_cs”: NULL, “sentiment_overall”: 3}”
For this review, “While the Glarion HD TV delivers excellent picture and audio quality, the compact remote is frustratingly small and difficult to use comfortably. An updated remote design would be a welcome improvement for this otherwise stellar TV.”, you should return ““sentiment_picture”: 5, “sentiment_sound”: 5, “sentiment_case_of_use”: 2, “sentiment_price_value”: NULL, “sentiment_cs”: NULL, “sentiment_overall”: 4}”

Include product review 382 may insert the product review of interest into the rate sentiment prompt. In some cases, include product review 382 may preprocess the product review to remove certain words or punctuation before the product review is inserted into the summarize prompt. In some cases, include product review 382 may preprocess the product review to insert the product name into the product review. In some embodiments, include product review 382 may insert a summary of the product review that LLM 110 may have generated in response to a summarize prompt with the product review, to reduce a number of input tokens into LLM 110 and/or remove filler content that is irrelevant to the rating categories. In some embodiments, include product review 382 inserts the (full) product review to allow LLM 110 to pick up on nuances in the product review and offer a more accurate set of sentiment scores.

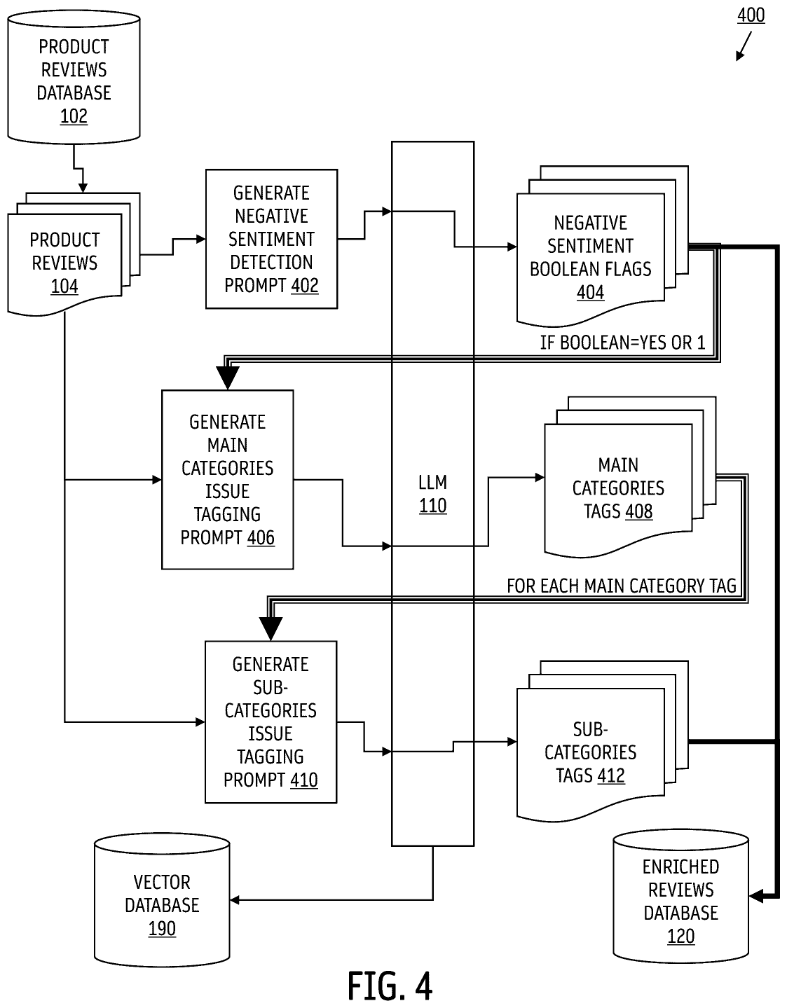

FIG. 4 illustrates using an LLM to generate negative sentiment Boolean flags, main categories tags, and sub-categories tags, according to some embodiments of the disclosure. System 400 implements a multi-part, progressive, or hierarchical approach to extracting negative sentiment, main categories tags, and sub-categories tags. One technical problem the architecture or structure of the pipeline in system 400 solves is that issue tagging is a highly complex task. The task involves LLM 110 being able to extract and understand nuances of a dozen categories and close to 100 sub-categories well enough to extract tags accurately. System 400 breaks down the complex task into smaller tasks to enable LLM 110 to perform the overall task more effectively. In some embodiments, the complex task is broken into three smaller tasks: (1) detect if there is negative sentiment, (2) identify main categories tags, and (3) identify sub-categories tags. Task (2) may be performed (only) if there is negative sentiment detected. Task (3) may be performed for each main categories tag identified in task (2). System 400 can include one or more of: product reviews database 102, product reviews 104, generate negative sentiment detection prompt 402, generate main categories issue tagging prompt 406, generate sub-categories issue tagging prompt 410, negative sentiment Boolean flags 404, LLM 110, vector database 190, main categories tags 408, sub-categories tags 412, and enriched reviews database 120.

System 400 includes one or more prompt generators, e.g., generate negative sentiment detection prompt 402, generate main categories issue tagging prompt 406, and generate sub-categories issue tagging prompt 410. A prompt generator may receive a first product review for a product (shown as one or more product reviews 104).

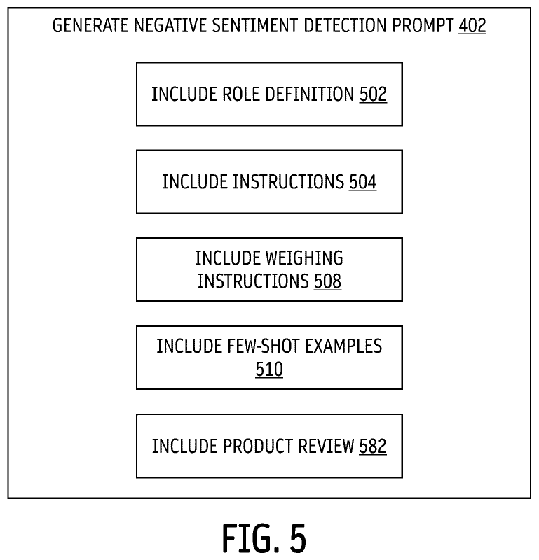

Generate negative sentiment detection prompt 402 may generate a negative sentiment detection prompt. The negative sentiment detection prompt is engineered to instruct LLM 110 to determine whether the first product review has a negative sentiment or not. A product review is considered to have a negative sentiment if the product review is not completely positive. A product review is considered to have a negative sentiment even if the product review is partly positive. Generate negative sentiment detection prompt 402 may input the negative sentiment detection prompt into LLM 110. The negative sentiment detection prompt may include the first product review. Generate negative sentiment detection prompt 402 and examples of a negative sentiment detection prompt are described in greater detail in FIG. 5. LLM 110 may generate a negative sentiment Boolean flag in response to LLM 110 receiving the first negative sentiment detection prompt. The negative sentiment Boolean flag may be received. The negative sentiment Boolean flag may be stored in enriched reviews database 120. A negative sentiment Boolean flag may have a value of “1” or “YES” if LLM 110 detects negative sentiment in the first product review (or that the first product review is at least partly or partially negative). A negative sentiment Boolean flag may have a value of “0” or “NO” if LLM 110 does not detect negative sentiment in the first product review (or that the first product review is completely positive).

Generate negative sentiment detection prompt 402 may be used to generate a plurality of negative sentiment detection prompts for different product reviews, such as different product reviews for a particular product, different product reviews for a particular product series, different product reviews from a specific demographic, different product reviews dated within a particular time-period, etc. LLM 110 may generate negative sentiment Boolean flags 404 in response to receiving the negative sentiment detection prompts. Negative sentiment Boolean flags 404 may be stored in enriched reviews database 120. Negative sentiment Boolean flags 404 may be used by a subsequent part of the platform.

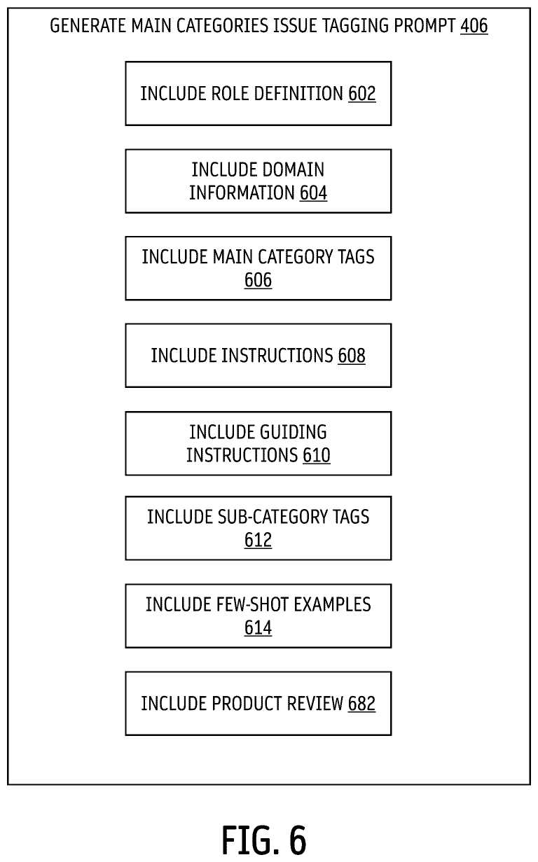

Generate main categories issue tagging prompt 406 may generate a main categories tagging prompt. Generate main categories issue tagging prompt 406 may generate a main categories tagging prompt in response to a negative sentiment Boolean flag in negative sentiment Boolean flags 404 indicating that a product review has negative sentiment. The main categories tagging prompt is engineered to instruct LLM 110 to extract one or more main issues present in the first product review. Issues are associated with negative sentiment. A product review's positive statements do not correspond to issues. Generate main categories issue tagging prompt 406 may input the main categories tagging prompt into LLM 110. The main categories tagging prompt may include the first product review, and a plurality of main categories tags. Generate main categories issue tagging prompt 406 and examples of a main categories tagging prompt are described in greater detail in FIG. 6. LLM 110 may generate one or more main categories tags in response to receiving the main categories tagging prompt. The one or more main categories tags may be received and stored in enriched reviews database 120. In some embodiments, the one or more main categories tags may be selected from the main category tags included in the main categories tagging prompt.

Generate main categories issue tagging prompt 406 may be used to generate a plurality of main categories tagging prompts for different product reviews, such as different product reviews for a particular product, different product reviews for a particular product series, different product reviews from a specific demographic, different product reviews dated within a particular time-period, etc. LLM 110 may generate main categories tags 408 in response to receiving the main categories tagging prompts. Main categories tags 408 may be stored in enriched reviews database 120. Main categories tags 408 may be used by a subsequent part of the platform.

In some embodiments, generate main categories issue tagging prompt 406 is invoked or triggered to produce a main categories tagging prompt if LLM 110 outputs a negative sentiment Boolean flag that indicates a negative sentiment is detected in the first product review.

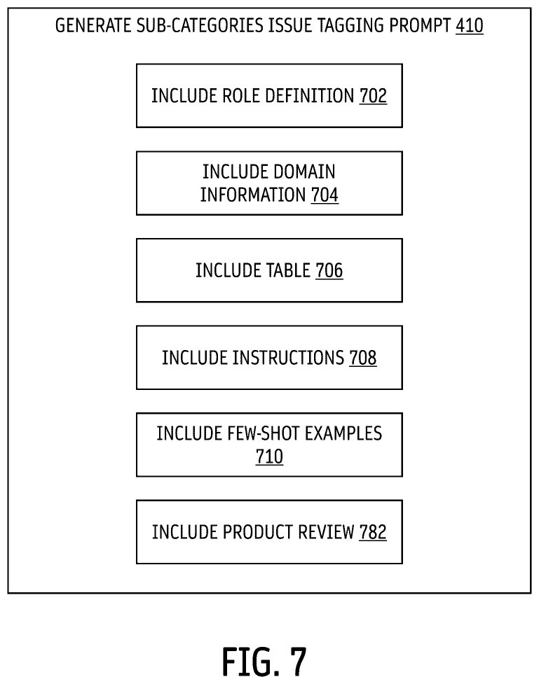

Generate sub-categories issue tagging prompt 410 may generate a first sub-categories tagging prompt. Generate sub-categories issue tagging prompt 410 may generate a sub-categories tagging prompt in response to a first main categories tag being identified for a first product review. The first sub-categories tagging prompt is engineered to instruct LLM 110 to extract one or more fine-grained issues within a particular main issue present in the first product review. A main issue may have half a dozen to a dozen fine-grained issues falling under the main issue. Generate sub-categories issue tagging prompt 410 may input the first sub-categories tagging prompt into LLM 110. The first sub-categories tagging prompt can include the first product review, and a first table having first sub-categories tags falling under the first main categories tag in a first column, first descriptions of the first sub-categories tags in a second column, and first examples of product reviews falling under the first sub-categories tags in a third column. Generate sub-categories issue tagging prompt 410 and examples of a sub-categories tagging prompt are described in greater detail in FIG. 7. LLM 110 may generate one or more first sub-categories tags in response to receiving the first sub-categories tagging prompt. The one or more first sub-categories tags may be received. The one or more first sub-categories tags may be stored in enriched reviews database 120.

Generate sub-categories issue tagging prompt 410 may generate a second sub-categories tagging prompt. Generate sub-categories issue tagging prompt 410 may generate the second sub-categories tagging prompt in response to the second main categories tag being identified for the first product review. Generate sub-categories issue tagging prompt 410 may input the second sub-categories tagging prompt into LLM 110. The second sub-categories tagging prompt can include the first product review, and a second table having second sub-categories tags falling under the second main categories tag in a first column, second descriptions of the second sub-categories tags in a second column, and second examples of product reviews falling under the second sub-categories tags in a third column. LLM 110 may generate one or more second sub-categories tags in response to receiving the first sub-categories tagging prompt. The one or more second sub-categories tags may be received. The one or more second sub-categories tags may be stored in enriched reviews database 120.

In some embodiments, generating different sub-categories tagging prompts for different main categories tags for the first product review to extract the sub-categories tags when different main categories tags are output by LLM 110 can help LLM 110 focus on a particular main categories tag and accurately identify the sub-categories tags that fall under the particular main categories tag.

Generate sub-categories issue tagging prompt 410 may be used to generate a plurality of sub-categories tagging prompts for different product reviews, such as different product reviews for a particular product, different product reviews for a particular product series, different product reviews from a specific demographic, different product reviews dated within a particular time-period, etc. LLM 110 may generate sub-categories tags 412 in response to receiving the sub-categories tagging prompts. Sub-categories tags 412 may be stored in enriched reviews database 120. Sub-categories tags 412 may be used by a subsequent part of the platform.

In some embodiments, generate sub-categories issue tagging prompt 410 is invoked or triggered to produce a sub-categories tagging prompt if LLM 110 outputs one or more main categories tags for a product review. In some embodiments, generate sub-categories issue tagging prompt 410 generates a sub-categories tagging prompt for each one of the main categories tags extracted from the first product review. In some embodiments, generate sub-categories issue tagging prompt 410 generates a sub-categories tagging prompt for all of the main categories tags extracted from the first product review.

While not shown explicitly, system 400 may include a post processing component to 110 are stored in enriched reviews database 120.

Vector database 190 may store and efficiently retrieve high-dimensional vector data, such as numerical data representations of text. LLM 110 may produce feature vectors that are numerical data representations of the engineered prompts that LLM 110 receives. Vector database 190 may store the feature vectors that LLM 110 generates in a specialized data structure optimized for fast similarity searches. The feature vectors may be stored as keys in vector database 190. The keys may have corresponding values associated with the keys. In some embodiments, feature vectors that LLM 110 generates in response to receiving a negative sentiment detection prompt may be stored in vector database 190. In some embodiments, feature vectors that LLM 110 generates in response to receiving a main categories tagging prompt may be stored in vector database 190. In some embodiments, feature vectors that LLM 110 generates in response to receiving a sub-categories tagging prompt may be stored in vector database 190.

FIG. 5 illustrates a component to generate a negative sentiment detection prompt, according to some embodiments of the disclosure. Generate negative sentiment detection prompt 402 may receive a product review and produce a negative sentiment detection prompt for the product review. The negative sentiment detection prompt may include an instruction to check whether there is negative sentiment in the review. The negative sentiment detection prompt may include instructions for when a value of “1” for the negative sentiment Boolean flag is appropriate. The negative sentiment detection prompt may include instructions for when a value of “0” for the negative sentiment Boolean flag is appropriate. The negative sentiment detection prompt may include few-shot examples. Generate negative sentiment detection prompt 402 may include one or more of: include role definition 502, include instructions 504, include weighing instructions 508, include few-shot examples 510, and include product review 582.

Include role definition 502 may include natural language text in the negative sentiment detection prompt that defines a role of LLM 110. Role definition may influence how LLM 110 may respond. An example of a role definition to be included as part of the summarize prompt is as follows:

You are an Artificial Intelligence assistant that performs product review analysis.

Include instructions 504 may include natural language text in the negative sentiment detection prompt that provides task-specific instruction(s) of how LLM 110 should produce the negative sentiment Boolean flag. Instruction(s) has an influence on how LLM 110 may respond. An example of one or more instructions to be included as part of the negative sentiment detection prompt is as follows:

Does this review have any negative feedback or negative sentiment?

### [INSERT PRODUCT REVIEW]

The specific product being reviewed will be named at the beginning of the review.

Include weighing instructions 508 may include natural language text in the negative sentiment detection prompt that instructs LLM 110 to give a certain value for the negative sentiment Boolean flag for one or more situations. In some cases, the weighing instruction(s) may include rating instruction(s). In some cases, the weighing instructions(s) may include guiding instructions(s). A second weighing instruction may include an instruction to return a value of 1 when the first product review is completely positive without reservations. A third weighing instruction may include an instruction to return a value of 0 when the first product review is incomplete or missing. A fourth weighing instruction may include an instruction to return a value of 0 when the first product review is at least partly negative or has a qualifying statement. The weighing instruction(s) has an influence on how LLM 110 may respond and improve accuracy of LLM 110. In some cases, LLM 110 may respond incorrectly if the weighing instructions are not included in the negative sentiment detection prompt. An example of one or more weighing instructions to be included as part of the negative sentiment detection prompt is as follows:

Return 1 if yes, 0 if the review is completely positive without reservations.
Also, return 0 if the review seems incomplete/missing.
Even minor negative feedback or qualifying statements in the review should return 1.

Include few-shot examples 510 may include several examples in the negative sentiment detection prompt that provides examples of product reviews and corresponding negative sentiment Boolean flag. The few-shot examples have an influence on how LLM 110 may respond. In some embodiments, include few-shot examples 208 may retrieve examples which are related to the product. In some embodiments, include few-shot examples 208 may retrieve examples which are related to a certain demographic of users. An example of few-shot examples to be included as part of the negative sentiment detection prompt is as follows:

```
[
  (“Disappointed that it does not have an Ethernet jack. They all should in this day and
age of streaming.”, ‘1’),
  (“I've had this tv for 14 months and it has been awesome! Not sure what's up with the
people giving it a bad review! Good picture good sound what's not to like. If you expect 4k
picture quality and movie theater sound out of a $100 tv your out of your minds! This thing
works just like advertised and you will not be disappointed”, ‘0’),
  (“The picture is very sharp for a fairly inexpensive tv. The sound isn't amazing, but it is
clear and tv speakers are never the best quality.”,‘1’)
]
```

Include product review 582 may insert the product review of interest into the negative sentiment detection prompt. In some cases, include product review 582 may preprocess the product review to remove certain words or punctuation before the product review is inserted into the summarize prompt. In some cases, include product review 582 may preprocess the product review to insert the product name into the product review. In some embodiments, include product review 582 may insert a summary of the product review that LLM 110 may have generated in response to a summarize prompt with the product review, to reduce a number of input tokens into LLM 110 and/or remove filler content that is irrelevant to the rating categories. In some embodiments, include product review 582 inserts the (full) product review to allow LLM 110 to pick up on nuances in the product review and offer a more accurate negative sentiment Boolean flag.

In some embodiments, domain information is not needed or purposefully omitted for the negative sentiment detection prompt to avoid confusing LLM 110. Domain information is not necessarily relevant for sentiment analysis.

FIG. 6 illustrates a component to generate a main categories issue tagging prompt, according to some embodiments of the disclosure. Generate main categories issue tagging prompt 406 may receive a product review and produce a main categories tagging prompt for the product review. Negative sentiment may have been detected in the product review, e.g., by LLM 110 in response to receiving a negative sentiment detection prompt. The main categories tagging prompt may include an instruction to check if there is negative sentiment in the product review. If there is, the main categories tagging prompt may include an instruction to determine which issue categories are relevant. A list of relevant issue categories can be retrieved for the product and inserted into the main categories tagging prompt. Descriptions and optionally examples of the main category tags are included in the main categories tagging prompt. The main categories tagging prompt may include an instruction to LLM 110 to output one or more main category tags. The main categories tagging prompt may include an instruction to output the one or more main category tags in a certain format. Generate main categories issue tagging prompt 406 may include one or more of: include role definition 602, include domain information 604, include main category tags 606, include instructions 608, include guiding instructions 610, include sub-category tags 612, include few-shot examples 614, and include product review 682.

Include role definition 602 may be implemented similarly or the same as include role definition 202. Include domain information 604 may be implemented similarly or the same as include domain information 204.

Include main category tags 606 may include natural language text in the main categories tagging prompt that lists the main category tags of interest. The main category tags restrict LLM 110 to respond to specific main category of interest. An example of the main category tags to be included as part of the main categories issue tagging prompt is as follows:

All tagged categories must be in this list: “Hardware”, “Remote”, “Content”, “OS”, “Video”, “Audio”, “Setup”, “Connectivity”, “Mobile App”, “Misc.”, “Customer Support”, and “Shopping Experience”. Do not use any other values and do not use sub-categories.

Include instructions 608 include natural language text in the main categories tagging prompt that provides task-specific instruction(s) of how LLM 110 should extract main category tags. An instruction may include a third instruction to first determine whether the first product review has a negative sentiment, and output one or more main categories tags only if the first product review is determined to have a negative sentiment. An instruction may include a fourth instruction to output no main categories tags if the first product review is determined to have no negative sentiment at all. An instruction may include a specific format and an instruction to return the one or more main category tags in the specific format. An example of the specific format may include, e.g., a Python list of strings with no additional text or comments and ensure all main category tags are wrapped in quotation marks. An instruction may include an explanation that a product review may be tagged with multiple main category tags. Instruction(s) has an influence on how LLM 110 may respond. An example of one or more instructions to be included as part of the main categories tagging prompt is as follows:

First, determine if the review has negative feedback about an aspect of the product or buying experience. Then, using only categories from the below list, tag these reviews with categories corresponding to the negative feedback.
If it is a completely positive review, there should be no categories tagged. A review praising picture quality with complaints about audio should only be tagged with “Audio” and not “Video”.
Return in the format of a Python list of strings with no additional text or comments. Ensure all categories are wrapped in quotation marks. Example: [“Audio”, “Hardware”]
Reviews can be tagged with multiple categories if multiple issues are discussed, separated by commas such as [“Audio”, “Hardware”].
Please tag the following review with the appropriate categories. Tagged categories should only be related to the negative sentiment of the review.

### [INSERT PRODUCT REVIEW]

Include guiding instructions 610 include natural language text in the main categories tagging prompt that provides information to assist LLM 110 to disambiguate between main category tags and guide LLM 110 to extract a first main category tag in the presence of issues relating to the first main category tag as opposed to a related main category tag. A guiding instruction may include a second guiding instruction to include a first main categories tag rather than a second main categories tag for a third presence of an issue associated with the first main categories tag. The guiding instruction(s) has an influence on how LLM 110 may respond and improve accuracy of LLM 110. An example of one or more guiding instructions to be included as part of the main categories tagging prompt is as follows:

Please consider any remote issues in the “Remote” category rather than “Hardware” category.

Include sub-category tags 612 may include natural language text in the main categories tagging prompt that lists main category tags and sub-category tags that fall under each main category tag. The main categories tagging prompt may include one or more sub-categories associated with each one of the main category tags. The main category tags and sub-category tags that fall under each main category tag provide LLM 110 with definitions, keywords, and context for the different main category tags so that LLM 110 may better pick up subtle cues in the product review. An example of the main category tags and sub-category tags that fall under each main category tag to be included as part of the main categories tagging prompt is as follows:

Below is a list of sub-categories to help determine when something should be tagged or not. If the review mentions something similar to the sub-category, it should be tagged with the respective main category.
Main category tag “Hardware” has these sub-categories: “Device Stopped Working”, “Device Will Not Turn On”, “Device Port Doesn't Work”, “Dead Pixels or Display Lines”, “Misc.”
Main category tag “Audio” has these sub-categories: “Poor Audio Quality”, “Out of Sync”, “Volume issues”, “Misc.”
. . .
Main category tag “Remote” has these sub-categories: “Remote Buttons Not Working”, “Remote Response Issue”, “Other Remote Issue”

Include few-shot examples 614 include several examples in the main categories issue tagging prompt that provides examples of product reviews and corresponding one or more main category tags. The few-shot examples have an influence on how LLM 110 may respond. In some embodiments, include few-shot examples 208 may retrieve examples which are related to the product. In some embodiments, include few-shot examples 208 may retrieve examples which are related to a certain demographic of users. Examples of few-shot examples to be included as part of the main categories issue tagging prompt is as follows:

```
[
  (“A little more than 2 months and the remote is not working”, ‘[“Remote”]’),
  (“Sound quality coming from wireless soundbar is of no significant improvement over
the Glarion TV itself. It has a tinny, harsh quality that is far below that of what was expected.”,
‘[“Audio”]’),
  (“Amazing TV, easy setup, quick delivery”,‘[ ]’)
]
```

Include product review 682 may insert the product review of interest into the main categories tagging prompt. In some cases, include product review 682 may preprocess the product review to remove certain words or punctuation before the product review is inserted into the summarize prompt. In some cases, include product review 682 may preprocess the product review to insert the product name into the product review. In some embodiments, include product review 682 may insert a summary of the product review that LLM 110 may have generated in response to a summarize prompt with the product review, to reduce a number of input tokens into LLM 110 and/or remove filler content that is irrelevant to the rating categories. In some embodiments, include product review 682 inserts the (full) product review to allow LLM 110 to pick up on nuances in the product review and offer a more accurate set of main category tags.

FIG. 7 illustrates a component to generate a sub-categories issue tagging prompt, according to some embodiments of the disclosure. Generate sub-categories issue tagging prompt 410 may receive a product review and produce a sub-categories tagging prompt for the product review. One or more main category tags may have been detected in the product review, and generate sub-categories issue tagging prompt 410 may generate a sub-categories issue tagging prompt for each one of the main category tags, e.g., extracted by LLM 110 in response to receiving a main categories issue tagging prompt. The sub-categories tagging prompt may include instructions for how to identify sub-category tags. The sub-categories tagging prompt may include a table that includes possible sub-category tags, descriptions of the sub-category tags, and examples of the sub-category tags. A column may include the main category tag (in some embodiments, this column may be omitted to reduce the number of input tokens). A column may include the sub-category tags. In some cases, a column may include the main category tag and respective sub-category tags (e.g., “Hardware/Other”, “Hardware/Battery is dead”, “Hardware/Light won't turn on”, etc.). A column may include a definition or a use-when description. A column may include examples of product reviews for the different sub-category tags”. The sub-categories tagging prompt may include an instruction to one or more main category tags. The main categories tagging prompt may include an instruction to output the one or more sub-category tags in a certain format. Generate sub-categories issue tagging prompt 410 may include one or more of: include role definition 702, include domain information 704, include table 706, include instructions 708, include few-shot examples 710, and include product review 782.

Include role definition 702 may be implemented similarly or the same as include role definition 202. Include domain information 704 may be implemented similarly or the same as include domain information 204.

Include table 706 may include a table represented by delimited natural language text into a sub-categories tagging prompt. The table offers keywords, descriptions, context, and examples to help LLM 110 identify sub-categories accurately. Depending on the main category tag detected, the table corresponding to the main category tag may be retrieved for the main category tag. For a first main category tag, the sub-category issues tagging prompt may include a first table having first sub-categories tags falling under the first main categories tag in a first column, first descriptions of the first sub-categories tags in a second column, and first examples of product reviews falling under the first sub-categories tags in a third column. For a second main category tag, the sub-category issues tagging prompt may include a second table having second sub-categories tags falling under the second main categories tag in a first column, second descriptions of the second sub-categories tags in a second column, and second examples of product reviews falling under the second sub-categories tags in a third column. A different table may be inserted into the sub-categories issue tagging prompt for a different main category tag. An example of the table to be included as part of the sub-category issue tagging prompt is as follows (using this format: First column | Second column | Third column, where | is used as a delimiter):

In the table, the first column contains a high-level main category, then the sub-category separated by /. The second column is a description of the sub-category. The third column has examples of product reviews that would fit in that sub-category.
Main category tag/sub-category | use-when | examples
Hardware/Device is Too Hot | Device is warm or hot to the touch, runs hot while in use, is seeing an overheating message |—The player runs warm; —The camera gets hot; —I keep getting an message that says my device is overheating
Hardware/Accessory is Damaged or Missing | There is an issue with an included accessory (this is separate from general feedback). |—I need HDMI extender or it won't fit my TV. Why wasn't this included?; —The remote was missing from the package; —The TV legs and screws weren't in the box; —The HDMI cable doesn't work, I had to buy my own to get the player to work; —The remote batteries were dead on arrival, I had to use my own
Hardware/Accessory Feedback | Not an issue, just feedback: Cord too short, Low quality HDMI, |—The HDMI cord is low quality, you'll have to buy your own; —The power cord is way too short
Hardware/Device is Turning On/Off Unprompted | Device is randomly powering on or off. Usually a TV. |—My TV turns on in the middle of the night; —My TV keeps turning off while I'm watching a show
Hardware/Device Will Not Turn On | The device is not powering on at all. Usually a TV or IOT product. |—My TV stopped turning on; —I got the TV home and it wouldn't turn on; —The doorbell camera won't power on, even after I charged it
Hardware/Low Power Warning | Customer is seeing a message on the screen titled “Insufficient Power” or “Low Power” |—You cannot watch anything, it constantly pops up insignificant power; —I get a low power warning that says that the USB may not be providing enough power
Hardware/Rapid battery drain | The device's battery life is unusually short, causing the customer to recharge their device every couple days or weeks. Some devices may not hold a charge at all. Usually seen on Remotes or Cameras. |—The battery life is awful, I have to recharge it everyday; —The camera won't hold a charge, as soon as I unplug it, it dies; —The remote battery only lasts 2 weeks before I have to plug it back in
Hardware/Rapid battery drain—with PL | A customer who mentions rapid battery drain AND that they are using headphones, earphones, private listening, PL. |—I have to recharge everyday but I use private listening every evening; —The headphones drain the battery on this thing
Hardware/Device Stopped Working | Customer states that their device stopped working (frequently without an explanation of what caused it) |—It stopped working after 2 months; —This doesn't last, you'll have to buy a new one a year
Hardware/Frequent Unplug or Reboot Required | Customer must frequently must Unplug or Restart the device for it operate |—I have to unplug it everyday in order for it to work; —Once a week I have to reboot it, otherwise it's great
Hardware/Unable to Update | Customer cannot complete an update of the product's hardware or software. Most frequently seen on SW updates during set up, resulting in a reboot loop. | —After setting up the device, it immediately prompts for an update—then it loops continuously!; —Set up and it went to update then just restarted and started the same process over and over; —The FW update won't complete. Every time I open the app, it tries to update my camera and never completes
Hardware/Device Port Doesn't Work | There is an issue with the hardware's plugs or ports. Power connector, HDMI port, optical port, etc. |—The power connection is loose. The cord falls out really easily; —The HDMI port doesn't work at all
Hardware/Device Port Request Upgrade | This is a feature request or feedback. Customers who would like to see the product have an Ethernet port, a MicroSD port, a USB port, Gigabit Ethernet connectivity, etc. |—This TV should have an Ethernet port; —My older player had a MicroSD port, why doesn't this one??; —I can't believe there's not gigabit Ethernet on this thing
Hardware/Bluetooth Feature Request | This is a feature request or feedback. Customers will describe the desire to use Bluetooth with their TV or player. This is usually to connect to Bluetooth headphones or an external speaker |—I only wish I could connect to my headphones; —It says it has Bluetooth, but it doesn't. There's no way to pair my speaker Hardware/Dead Pixels or Display Lines | A display panel has permanently bright or dead pixels. Or the display has lines in on the screen. Usually seen on TVs. |—The TV is brand new and there are a few dead pixels in the corner; —The panel has lines on the top and bottom of the picture

### Hardware/Other Hardware Request ∥

Another example of the table to be included as part of the sub-category issue tagging prompt is as follows (using this format: First column | Second column | Third column, where | is used as the delimiter):

In the table, the first column contains a high-level main category, then the sub-category separated by /. The second column is a description of the sub-category. The third column has examples of product reviews that would fit in that sub-category.
Main category tag/sub-category | use-when | examples
Shopping Experience/Received a Used Item | Customer claims that the item they received was not new. Either by the packaging or because the device had account information already setup |—This isn't new!! The box was clearly already opened.; —I ordered a new one and got a used one.; —I went to set it up and it already had someone else's account information on it. I thought I bought a new one?!
Shopping Experience/Delivery or Return Issue | Complaints regarding Shipping, Delivery, Return experiences |—The shipping took forever, but whatever; —I missed the return window, so now I'm stuck with this; —The delivery driver left it on my driveway instead of the porch!
Shopping Experience/Arrived Damaged | Product arrived physically broken. Usually related to a TV screen or panel. |—Cracked screen right out of the box!; —Arrived with a busted panel; —It was already broken before I opened the box
Shopping Experience/Retailer Complaint | A complaint that is specific to a retailer like TechTopia, Silicon Alley, ElectroMart, etc. Complaints about curbside pickup, inventory, retailer employees, Pricing is different online vs. Instore etc. |—TechTopia's employees are useless. The geeks doesn't even show up.; —I waited at curbside pickup for 30 minutes. No one ever came out!; —Walmart doesn't even have this in stock, it said it was available online;

### Shopping Experience/Other Shopping Experience Issue ∥

Include instructions 708 can include natural language text in the sub-categories tagging prompt that provides task-specific instruction(s) of how LLM 110 should extract sub-category tags. An instruction may include requesting LLM 110 to first determine whether the first product review has a negative sentiment, and output one or more sub-categories tags only if the first product review is determined to have a negative sentiment. An instruction may include a request to output no sub-categories tags if the first product review is determined to have no negative sentiment at all. An instruction may include a specific format and a request to LLM 110 return the one or more sub-category tags in the specific format. An example of the specific format may include, e.g., a Python list of strings with no additional text or comments and ensure all sub-category tags are wrapped in quotation marks. An instruction may include an explanation that a product review may be tagged with multiple sub-category tags. Instruction(s) has an influence on how LLM 110 may respond. An example of one or more instructions to be included as part of the sub-categories tagging prompt is as follows:

First, determine if the review has negative feedback about an aspect of the product or buying experience. Then, using the table of categories provided below, tag these reviews with categories corresponding to the negative feedback.
If it is a completely positive review, there should be no categories tagged. A review praising picture quality with qualms about audio quality should only be tagged with “Audio/Poor Audio Quality” and no “Video” tag.
Using values from the first column, you will tag these reviews according to the issues they describe (if one exists). This is a subset of categories that we have determined to be relevant so please do not tag with any other values.
Return in the format of a Python list of strings with no additional text or comments. Ensure all categories are wrapped in quotation marks. Example: [“Audio/Poor Audio Quality”]
Reviews can be tagged with multiple categories if multiple issues are discussed, separated by commas such as [“Audio/Poor Audio Quality”, “Hardware/Other Hardware Issue”].
If the review doesn't appear to fit any category, please tag it as the appropriate “other” category, for example “Audio/Other Audio Issue”.
Please tag the following review with the appropriate categories from given areas. Tagged categories should only be related to the negative sentiment of the review.

### [INSERT PRODUCT REVIEW]

Include few-shot examples 710 may include several examples in the sub-categories issue tagging prompt that provides examples of product reviews and corresponding sub-categories tags. The few-shot examples have an influence on how LLM 110 may respond. In some embodiments, include few-shot examples 710 may retrieve examples which are related to the product. In some embodiments, include few-shot examples 710 may retrieve examples which are related to a certain demographic of users. An example of few-shot examples to be included as part of the sub-categories issue tagging prompt is as follows:

```
[
  (“The picture is very clear. My problem is with having to use two remotes, one for the
t,v, and one for cable features. I won't buy this t.v. Again”, ‘[“Remote / Other Remote
Issue”]’),
  (“Sound quality coming from wireless soundbar is of no significant improvement over
the Roku TV itself. It has a tinny, harsh quality that is far below that of what was expected.”,
‘[“Audio / Poor Audio Quality”]’),
  (“Amazing TV, easy setup”,‘[ ]’)
]
```

Include product review 782 may insert the product review of interest into the sub-categories issue tagging prompt. In some cases, include product review 782 may preprocess the product review to remove certain words or punctuation before the product review is inserted into the sub-categories issue tagging prompt. In some cases, include product review 582 may preprocess the product review to insert the product name into the product review before the product review is inserted into the sub-categories issue tagging prompt. In some embodiments, include product review 782 may insert a summary of the product review that LLM 110 may have generated in response to a summarize prompt with the product review, to reduce a number of input tokens into LLM 110 and/or remove filler content that is irrelevant to the sub-categories of interest. In some embodiments, include product review 782 inserts the (full) product review to allow LLM 110 to pick up on nuances in the product review and offer a more accurate set of sub-category tags.

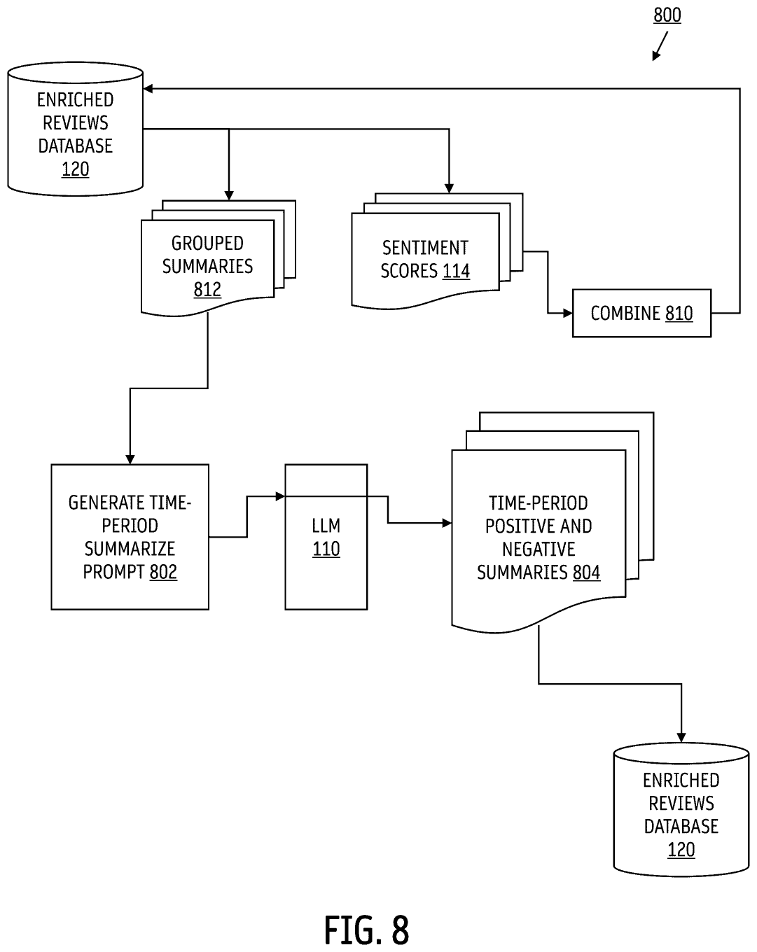

FIG. 8 illustrates using an LLM to generate time-period positive and negative summaries and a component to combine sentiment scores, according to some embodiments of the disclosure. System 800 operates on grouped summaries 812 (including summaries produced by LLM 110 as described with FIG. 1) to gather insights over a time-period and produce time-period summaries, e.g., time-period positive and negative summaries 804. Various examples described herein are described where time-period is a week. It is envisioned that other time-periods can be used, e.g., a month, three months, a year, etc. One technical problem the architecture or structure of the pipeline in system 800 solves is that using (full) product reviews to produce time-period summaries may make the number of input tokens too big. System 800 operates on summaries of product reviews in grouped summaries 812 instead of (full) product reviews to reduce the number of input tokens to LLM 110 while retaining salient information of the product reviews. The architecture or structure of the pipeline in system 800 further performs the technical task of calculating statistical measures of and extract aggregated insights from sentiment scores 114 produced by LLM 110. System 800 can include one or more of LLM 110, grouped summaries 812, sentiment scores 114, combine 810, generate time-period summarize prompt 802, time-period positive and negative summaries 804, and enriched reviews database 120.

While some of the examples described focuses on aggregating summaries over a same time-period, it is envisioned that system 800 may be used to aggregate summaries for a particular product, a particular product series, or a specific demographic.

System 800 includes a prompt generator, e.g., generate time-period summarize prompt 802. Generate time-period summarize prompt 802 may receive grouped summaries 812. Grouped summaries 812 may be retrieved using a query from enriched reviews database 120, where the query may specify a grouping criterion. The prompt generator may receive grouped summaries 812 grouped by product and associated with a same time-period. The prompt generator may receive grouped summaries 812 grouped by product series and associated with a same time-period. The prompt generator may receive grouped summaries 812 grouped by a specific demographic and associated with a same time-period. The prompt generator may receive grouped summaries 812 grouped by product and a specific demographic and associated with a same time-period. The prompt generator may receive grouped summaries 812 grouped by product series and a specific demographic and associated with a same time-period.

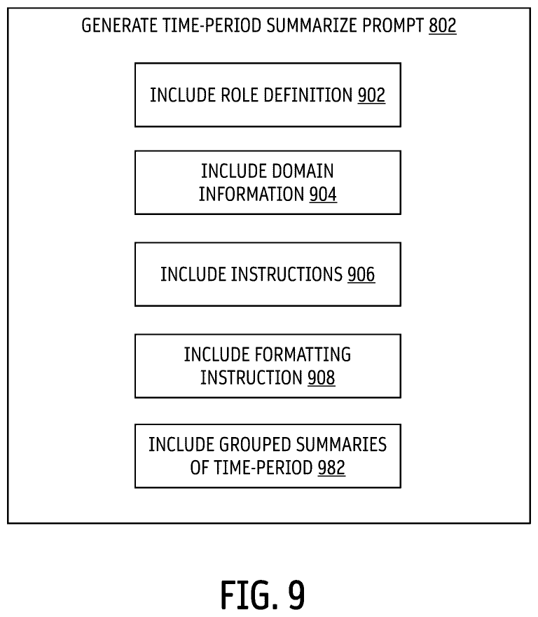

Generate time-period summarize prompt 802 may generate a time-period summarize prompt. The time-period summarize prompt is engineered to instruct LLM 110 to summarize positive reviews and summarize negative reviews. The time-period summarize prompt is engineered to instruct LLM 110 to identify positive topics and list out examples for each positive topic. The time-period summarize prompt is engineered to instruct LLM 110 to identify negative topics and list out examples for each negative topic. Uniquely, the time-period summarize prompt does not include a list of specific topics so that LLM 110 is not restricted to a specific list but is able to (freely) identify the positive topics and negative topics present in the group of product reviews associated with the time-period. Generate time-period summarize prompt 802 may input the time-period summarize prompt into LLM 110. The time-period summarize prompt can include grouped summaries, including the first summary and the second summary (and any other summaries associated with the same time-period). Generate time-period summarize prompt 802 and examples of a time-period summarize prompt are described in greater detail in FIG. 9. LLM 110 may generate a time-period positive and negative summary in response to LLM 110 receiving the time-period summarize prompt. The time-period positive and negative summary may be stored in enriched reviews database 120. An example of a time-period positive summary may be as follows:

Customers are generally satisfied with the Glarion Select Series FHD TV. The TV has a clear picture, is easy to use, and integrates well with other devices. Customers appreciate the fair price and the ability to add more channels for free or minimal charge. The TV is great for small spaces like kitchens, bedrooms, and covered porches.

### Topics:

1. Picture Quality (mentioned in 10 reviews)
“Great picture quality and easy to use. Integrates well with other devices. Fair price.”
“Clear picture and easy setup.”
“Loves the sound and picture quality of the Roku 32\″ Smart TV.”
“Crystal clear picture and easy to operate. Great for a dining room.”
“Good picture quality. Very satisfied with purchase.”
“Beautiful picture. Perfect size for bedroom wall.”
“Clear picture and good size for the price.”
“Good features and quality for a bedroom TV.”
“Good for small spaces, entertainment cabinets, dorm rooms, and covered back porches.”
“TV has a clear picture.”
   2. Ease of Use (mentioned in 8 reviews)
“Great picture quality and easy to use. Integrates well with other devices. Fair price.”
“Great for the kitchen. Simple and easy to use. Better streaming than phone.”
“Clear picture and easy setup.”
“Great TV for bedroom viewing with easy to use features, especially for seniors.”
“Convenient and great TV with extra free add-on.”
“Easy setup and good picture quality. Perfect for outdoor porch.”
“Crystal clear picture and easy to operate. Great for a dining room.”
“Easy to use and reliable. Would buy again.”
   3. Price (mentioned in 4 reviews)
“Pleased with the TV and happy with the price.”
“Great picture quality and easy to use. Integrates well with other devices. Fair price.”
“Convenient and great TV with extra free add-on.”
“Good value for a smart TV.”
   4. Size (mentioned in 3 reviews)
“Perfect size for a bookcase in a guest exercise room. Has all the necessary features.”
“Beautiful picture. Perfect size for bedroom wall.”
“Good for small spaces, entertainment cabinets, dorm rooms, and covered back porches.”
   5. Additional Channels (mentioned in 2 reviews)
“Has everything the reviewer wanted for viewing. Can add more channels for free or minimal charge. Would buy again.”
“Good TV with plenty of channels. Picture quality could be better.”

An example of a time-period negative summary may be as follows:

Some customers have experienced issues with the TV freezing and the remote not working well unless directly in front of the TV. One customer was disappointed that the TV is not Bluetooth headphone compatible and that the salesman gave false information. Some customers feel that the picture quality could be better.

### Topics:

1. Technical Issues (mentioned in 2 reviews)
“TV has a problem with the schedule and time showing incorrectly after being turned off. Requires a system restart every time.”
“Remote does not work well unless directly in front of TV. TV has frozen a few times.”
   2. Bluetooth Compatibility (mentioned in 1 review)
“Disappointed that it is not Bluetooth headphone compatible. Salesman gave false information.”
   3. Picture Quality (mentioned in 1 review)
“Good TV with plenty of channels. Picture quality could be better.”

Generate time-period summarize prompt 802 may be used to generate a plurality of time-period summarize prompts for one or more of different grouping criteria: different groups of product reviews associated with different time-periods, for different groups of product reviews of different products associated with the same time-period, for different groups of product reviews of different product series associated with the same time-period. LLM 110 may generate time-period positive and negative summaries 804 in response to receiving the time-period summarize prompts. Time-period positive and negative summaries 804 may be stored in enriched reviews database 120. Time-period positive and negative summaries 804 may be used by a subsequent part of the platform, such as a dashboard.

In some embodiments, combine 810 may receive sentiment scores 114 and calculate statistical measures based on sentiment scores 114. Combine 810 may receive sentiment scores 114 produced by LLM 110 (as discussed with FIG. 1). Combine 810 may retrieve sentiment scores 114 based on one or more aggregation criterion from enriched reviews database 120. Examples of statistical measures may include: mean, median, mode, range, variance, standard deviation, skewness of distribution, kurtosis of distribution, outliers, unusual scores, percentile statistics, etc. Examples of aggregation criterion may include: sentiment scores extracted from product reviews associated with different time-periods, sentiment scores extracted from product reviews of different products associated with the same time-period, sentiment scores extracted from product reviews of different product series associated with the same time-period, etc.

In some embodiments, combine 810 may receive sentiment scores 114 and identify temporal trends.

In some embodiments, combine 810 may receive sentiment scores 114 and identify one or more anomalies.

In some embodiments, combine 810 may receive sentiment scores 114 and identify parameters of model of the sentiment scores 114 (e.g., identify parameters of a linear regression model). In some embodiments, combine 810 may receive sentiment scores 114 and identify factors that influence sentiment scores 114 in a statistically significant manner.

While not shown explicitly, system 800 may include a post processing component to 110 are stored in enriched reviews database 120.

FIG. 9 illustrates a component to generate a time-period summarize prompt, according to some embodiments of the disclosure. Generate time-period summarize prompt 802 may receive grouped summaries of time-period and produce a time-period summary prompt. The time-period summary prompt may include one or more instructions for how to summarize positive sentiment and one or more topics associated with positive sentiment. The time-period summary prompt may include one or more instructions for how to summarize negative sentiment and topics associated with negative sentiment. The time-period summary prompt may include an instruction to list topics in the order of prevalence. The time-period summary prompt may include a specific format and a formatting instruction to utilize the specific format in the response. Generate time-period summarize prompt 802 may include one or more of: include role definition 902, include domain information 904, include instructions 906, include formatting instruction 908, and include grouped summaries of time-period 982.

Include role definition 902 may be implemented similarly or the same as include role definition 202. Include domain information 904 may be implemented similarly or the same as include domain information 204.

Include instructions 906 may include, in a time-period summary prompt, an instruction to output the first natural language summary of positive sentiment, the one or more first topics associated with positive sentiment, the one or more first examples associated with each one of the one or more first topics, the second natural language summary of negative sentiment, the one or more second topics associated with negative sentiment, and the one or more second examples associated with each one of the one or more second topics. In some cases, include instructions 906 may include, in a time-period summary prompt, a further instruction to output the first number of mentions for each one of the one or more first topics and the second number of mentions for each one of the one or more second topics. Include instructions 906 may include, in a time-period summary prompt, an instruction to summarize a group of reviews for positive sentiment. Include instructions 906 may include, in a time-period summary prompt, an instruction to summarize the group of reviews for negative sentiment. Include instructions 906 may include, in a time-period summary prompt, an instruction to list one or more first (positive sentiment) topics in the group of reviews. Include instructions 906 may include, in a time-period summary prompt, an instruction to list one or more second (negative sentiment) topics in the group of reviews. Include instructions 906 may include, in a time-period summary prompt, an instruction to list the one or more first topics associated with positive sentiment in descending order of prevalence in the group of reviews. Include instructions 906 may include, in a time-period summary prompt, an instruction to list the one or more second topics associated with negative sentiment in descending order of prevalence in the group of reviews. Include instructions 906 may include, in a time-period summary prompt, a task-specific instruction to ignore a product review in the summaries and topics if the product review is unintelligible. Include instructions 906 may include, in a time-period summary prompt, include a task-specific instruction to ignore a product review in the summaries and topics if the product review is uninformative. Instructions(s) have an influence on how LLM 110 may respond. An example of one or more instructions to be included as part of the time-period summary prompt is as follows:

You summarize a group of reviews given to you with 3-5 sentences for positive and negative sentiment, respectively. Each review is separated by line.
You list the positive and negative topics in those reviews.
You list the topics in a numbered list in descending order of prevalence in the group of reviews.
If there are unintelligible or uninformative reviews, please ignore those reviews in the summaries and topics.
The reviews listed below are for [INSERT PRODUCT NAME] Using only the review data below, can you 1) summarize the positive and negative sentiment and 2) return the most prevalent topics in reviews, split by positive and negative sentiment?

### [INSERT GROUPED SUMMARIES]

Include formatting instruction 908 may include one or more formatting instructions in the time-period summary prompt. Formatting instructions can help ensure the response can be read or interpreted easily by a human analyst. Include formatting instruction 908 may include, in a time-period summary prompt, a task-specific instruction to maintain a specific format but leave blank as necessary if there are not enough data in the provided product reviews to summarize. Include formatting instruction 908 may include, in a time-period summary prompt, a specific format and a formatting instruction to utilize the specific format in the response. The formatting instruction(s) can influence the formatting of a response generated by LLM 110. An example of one or more formatting instructions (and specific format) to be included as part of the time-period summary prompt is as follows:

If there isn't enough data to summarize, please still maintain the format below but leave blank as necessary.
The format should be:

### - - - Positive Summary and Topics - - -

### Summary:

3-5 sentence summary of positive sentiment

### Topics:

1. Topic 1 (mentioned in X reviews)
2. Topic 2 (mentioned in X reviews)
****************************************

### - - - Negative Summary and Topics - - -

### Summary:

3-5 sentence summary of negative sentiment

### Topics:

1. Topic 1 (mentioned in X reviews)
2. Topic 2 (mentioned in X reviews)
″″″

Include grouped summaries of time-period 982 may insert grouped reviews of interest into the time-period summarize prompt. The grouped reviews of interest may be retrieved according to one or more grouping criteria. In some cases, include grouped summaries of time-period 982 may preprocess the grouped reviews to remove certain words or punctuation before the grouped reviews are inserted into the time-period summarize prompt. In some cases, include grouped summaries of time-period 982 may preprocess the grouped reviews to insert line breaks to separate the individual reviews before the grouped reviews are inserted into the time-period summary prompt. In some embodiments, include grouped summaries of time-period 982 may insert summaries of the product review that LLM 110 may have generated in response to summarize prompts with respective product reviews, to reduce a number of input tokens into LLM 110 and/or remove filler content that is irrelevant for summarization. In some embodiments, include grouped summaries of time-period 982 inserts the (full) product reviews to allow LLM 110 to pick up on nuances in the products review and offer a more accurate set of topics.

### Setting the Temperature of the LLM

The temperature (a hyperparameter) of LLM 110 can be set to zero to ensure consistency and remove variation and randomness in the generated outputs. In some cases, the temperature of LLM 110 may be set to a relatively low value to minimize variation and randomness in the generated outputs.

The temperature parameter of LLM 110 can control the randomness or certainty of the outputs produced by LLM 110. Specifically, a lower temperature (e.g. <1) makes the outputs of LLM 110 more deterministic, concentrating the predicted probability mass on a few high-scoring outputs. This results in outputs that are more confident and focused, but potentially less diverse. A higher temperature (e.g. >1) increases the entropy of the output distribution, making LLM 110 consider a wider range of possibilities beyond just the top few scored by the model. This can produce more diverse and creative outputs, at the risk of being less coherent or logical. For the context of product review analysis, it is preferable to have a lower temperature, a zero temperature, or a close to zero temperature.

### Exemplary Dashboard Graphical User Interfaces

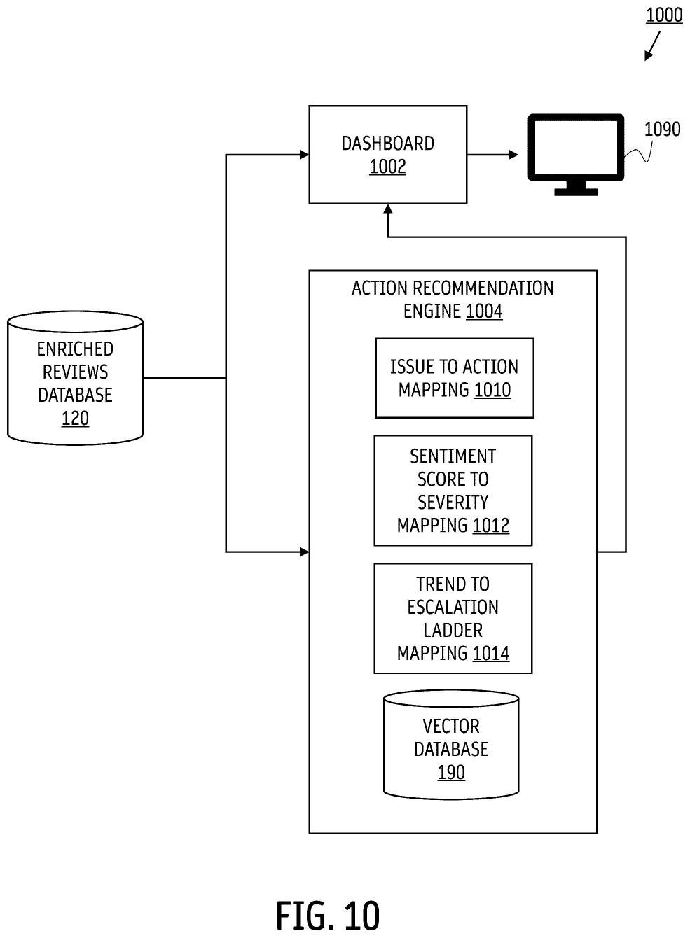

FIG. 10 illustrates a dashboard to visualize weekly summaries and enriched reviews, and an action recommendation engine, according to some embodiments of the disclosure. System 1000 may include one or more of: dashboard 1002, user input/output device 1090, enriched reviews database 120 and action recommendation engine 1004.

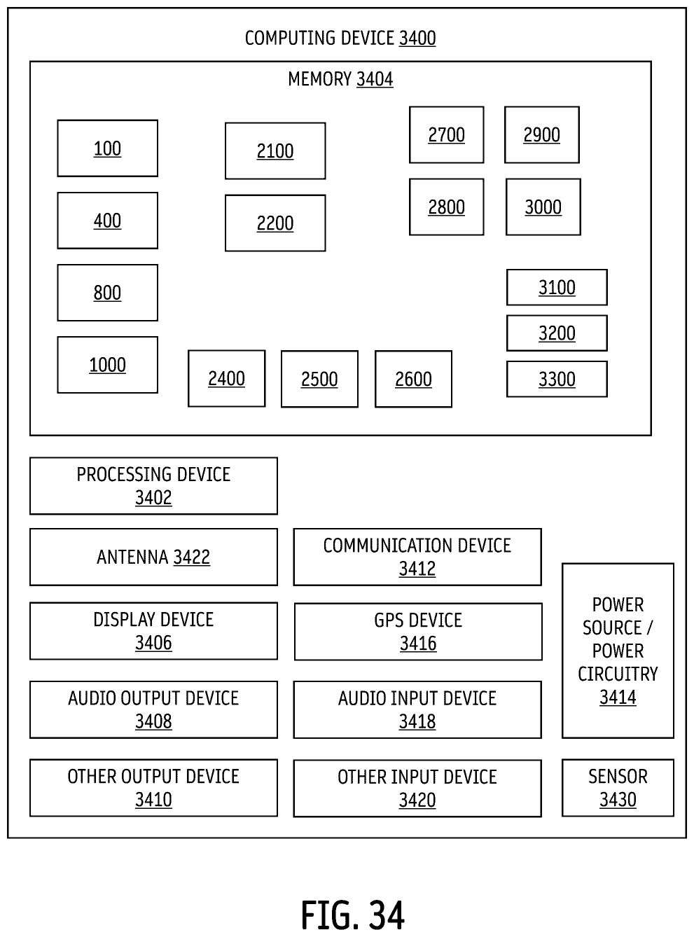

Dashboard 1002 may receive enriched reviews database 120 and generate visualizations for a graphical user interface. Dashboard 1002 may generate a graphical user interface based on information in enriched reviews database 120. User input/output device 1090 may render the graphical user interface for display to an end user. User input/output device 1090 may be a part of computing device 3400 of FIG. 34. Exemplary graphical user interfaces are depicted in FIGS. 11-20.

Enriched reviews database 120 includes structured data about product reviews to allow for systematic determination of resolutions to issues in the product reviews. A resolution may include an action to be performed, a routing action to the appropriate user, and/or an alert to a user. Action recommendation engine 1004 can include one or more of: issue to action mapping 1010, sentiment score to severity mapping 1012, trend to escalation ladder mapping 1014, and vector database 190.

Issue to action mapping 1010 may determine, from information in enriched reviews database 120, one or more main category tags and/or one or more sub-category tags. Appropriate predefined actions may be associated or assigned, e.g., using a look-up table or other similar data structure, to each one of: one or more main category tags and/or one or more sub-category tags. Upon determining the one or more main category tags and/or the one or more sub-category tags for a particular product review, issue to action mapping 1010 can determine corresponding actions for resolving the particular product review.

Sentiment score to severity mapping 1012 may determine, from information in enriched reviews database 120, one or more sentiment scores. Logic may be defined to determine severity based on one or more criteria of the sentiment scores. Upon determining the one or more sentiment scores for a particular product review, sentiment score to severity mapping 1012 can assign a severity to the particular product review.

Trend to escalation ladder mapping 1014 may determine from information in enriched reviews database 120, a trend (e.g., information determined by combine 810 of FIG. 8) in the product reviews. Logic or rules may be defined to map escalating criteria of certain trends to different parts of an escalation ladder. For example, escalating criteria may include progressively higher thresholds. If a certain trend crosses a threshold, the trend may cause a mapping to a particular part of an escalation ladder. Upon determining a trend in the product reviews, trend to escalation ladder mapping 1014 can output an escalation level of an escalation ladder. Different escalation levels of the escalation ladders may trigger different alerts to be output to an end user.

Vector database 190, as described herein, can be used to retrieve recommended actions/resolutions to an incoming product review. An incoming product review may be provided to LLM 110 to produce a feature vector. One or more matching keys in vector database 190 may be determined based on the feature vector. Vector database 190 may search for the one or more matching feature vectors in the keys of the vector database that matches the feature vector. A matching key may be a key with a highest or high amount of similarity, such as cosine similarity, lowest or low distance, etc. The corresponding value of a matching key may be determined. The value may include a predefined appropriate resolution or past action taken that successfully resolved the product review. Configured in this manner, vector database 190 can be used to determine one or more recommended actions or resolutions to the incoming product review.

FIG. 11 illustrates a graphical user interface displaying an average customer rating and average sentiment scores, according to some embodiments of the disclosure. An overall average customer rating (e.g., average of overall sentiment scores) is displayed. A total number of reviews is displayed. Average sentiment scores for different rating categories are displayed numerically and visually with a 5-star meter.

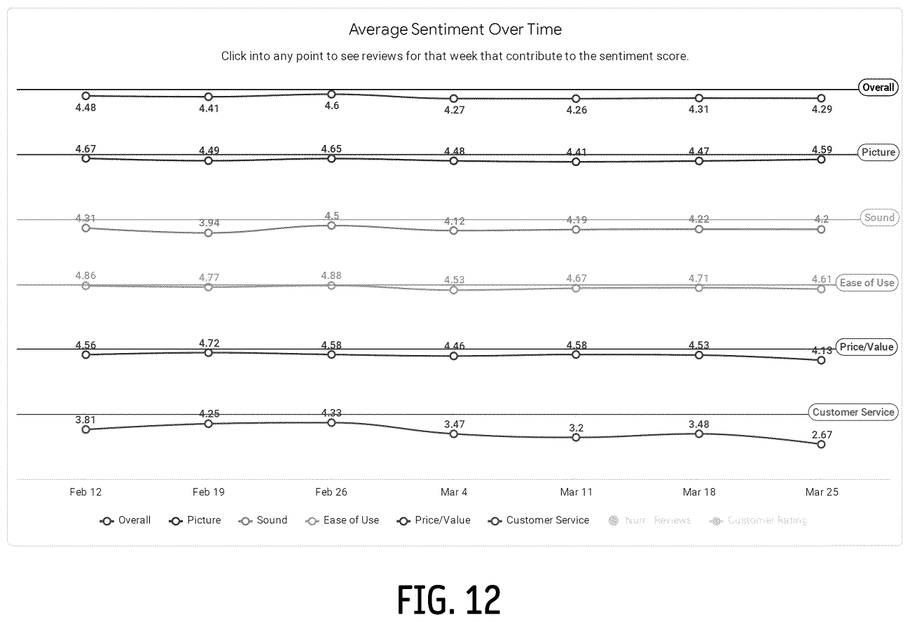

FIG. 12 illustrates a graphical user interface displaying average sentiment scores over time, according to some embodiments of the disclosure. Overall average sentiment scores and average sentiment scores for different rating categories are displayed in a time-series plot.

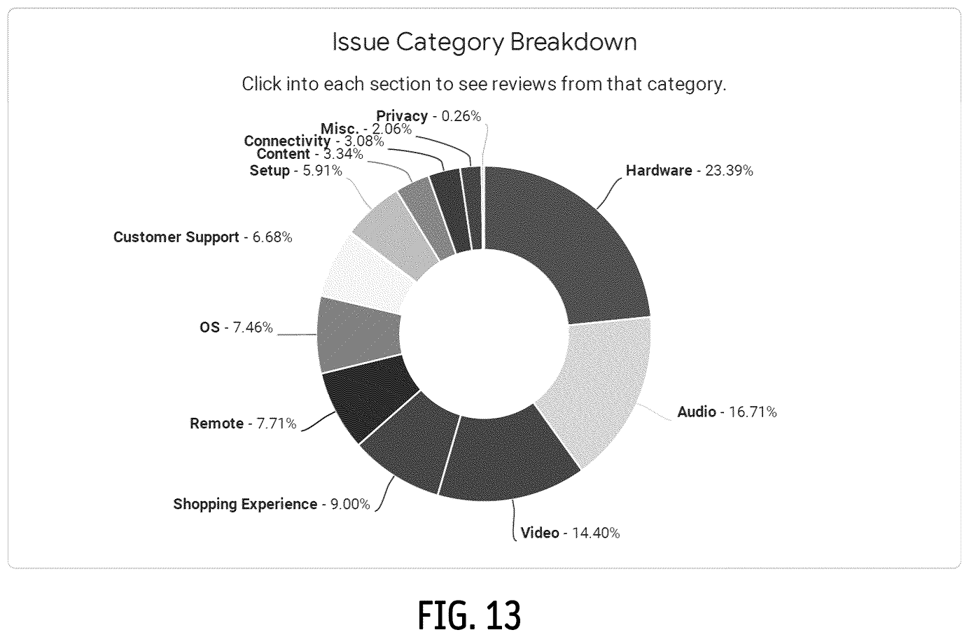

FIG. 13 illustrates a graphical user interface displaying proportions of different issue categories, according to some embodiments of the disclosure. Main category tags proportion breakdown is displayed using a donut visualization.

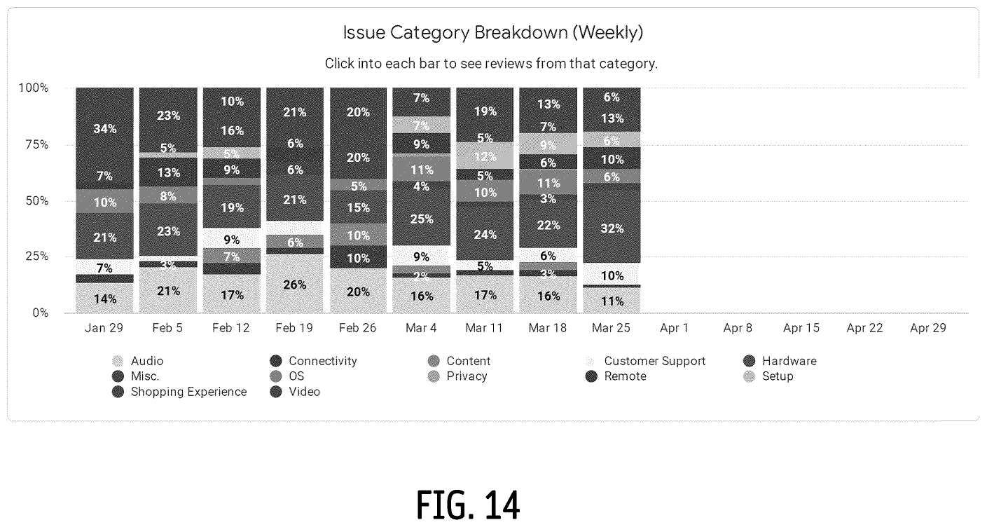

FIG. 14 illustrates a graphical user interface displaying proportions of different issue categories over time, according to some embodiments of the disclosure. Main category tags proportion breakdown over time is displayed using a 100% stacked column visualization.

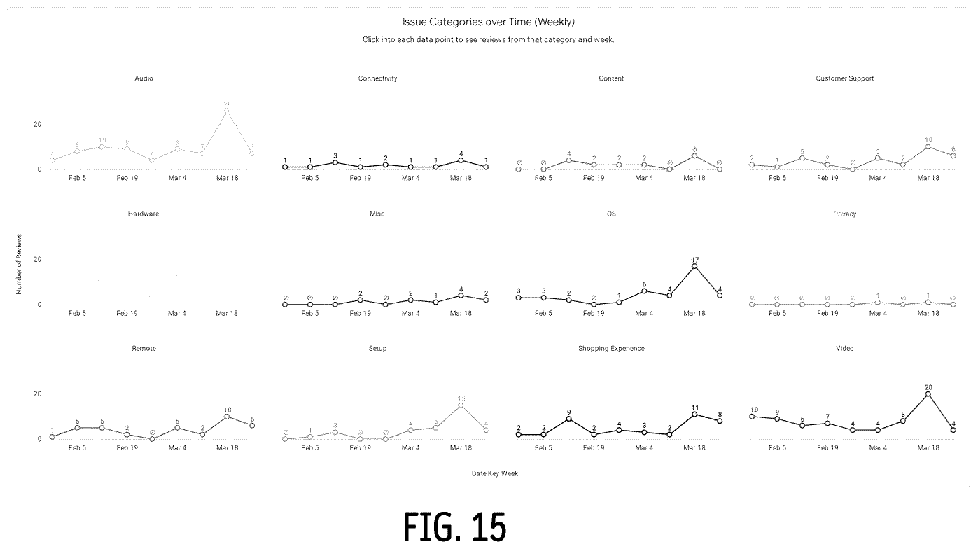

FIG. 15 illustrates a graphical user interface displaying frequencies of different issue categories over time, according to some embodiments of the disclosure. For each main category tag, a number of reviews over time is displayed in a time-series plot.

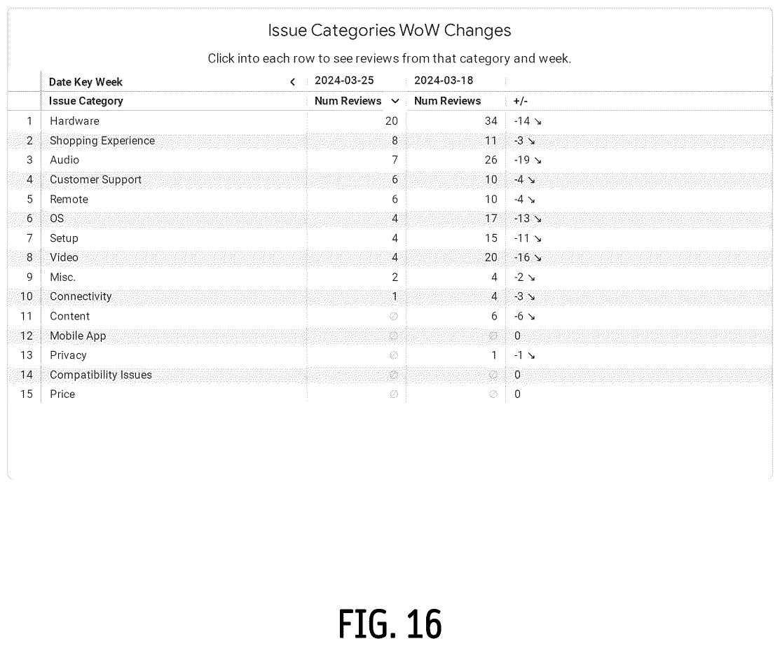

FIG. 16 illustrates a graphical user interface displaying week over week changes of different issue categories, according to some embodiments of the disclosure. The number of reviews for different main category tags are compared between weeks and the differences are displayed in a tabular format.

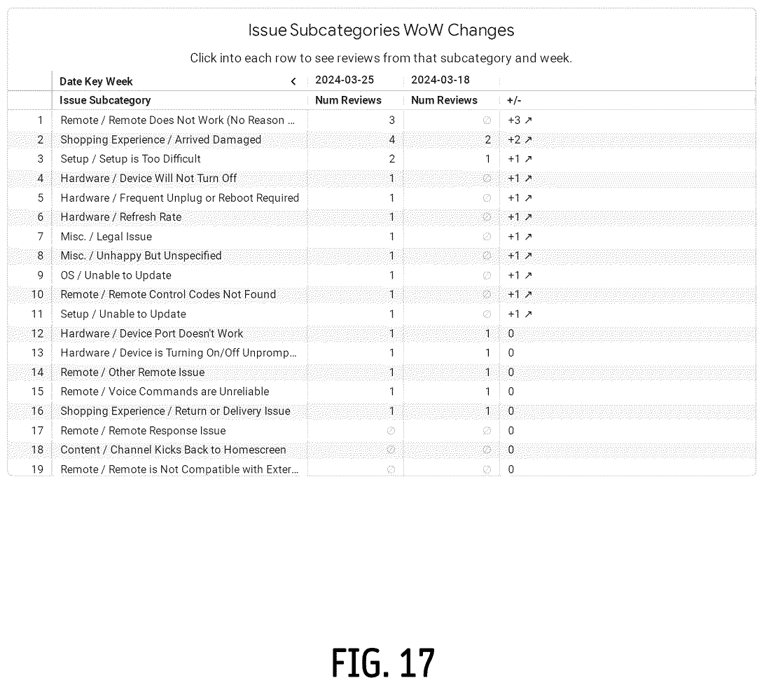

FIG. 17 illustrates a graphical user interface displaying week over week changes of different issue sub-categories, according to some embodiments of the disclosure. The number of reviews for different sub-category tags are compared between weeks and the differences are displayed in a tabular format.

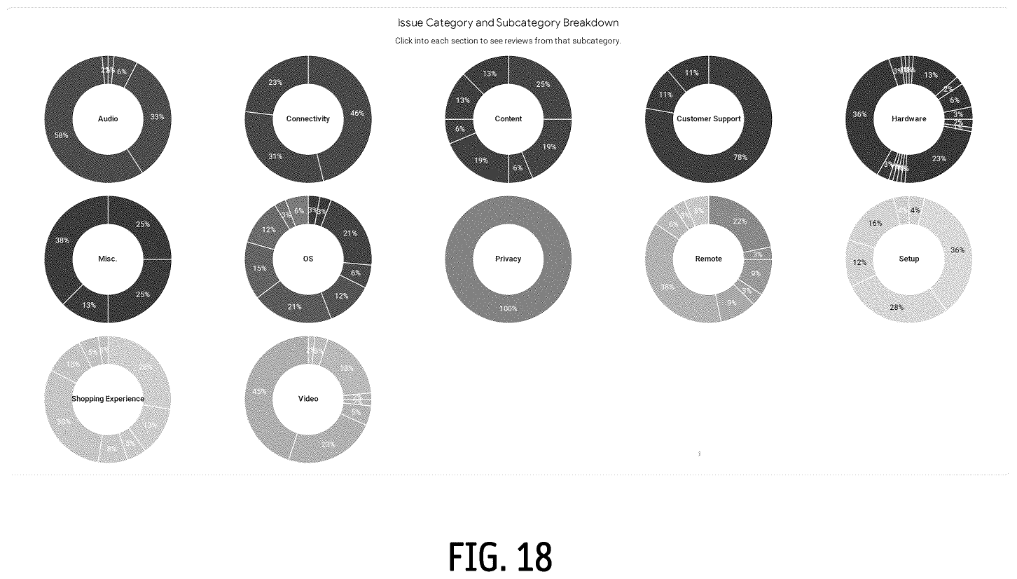

FIG. 18 illustrates a graphical user interface displaying proportions of different issue sub-categories within each issue category, according to some embodiments of the disclosure. For each main category tag, sub-category tags proportion breakdown is displayed using a donut visualization.

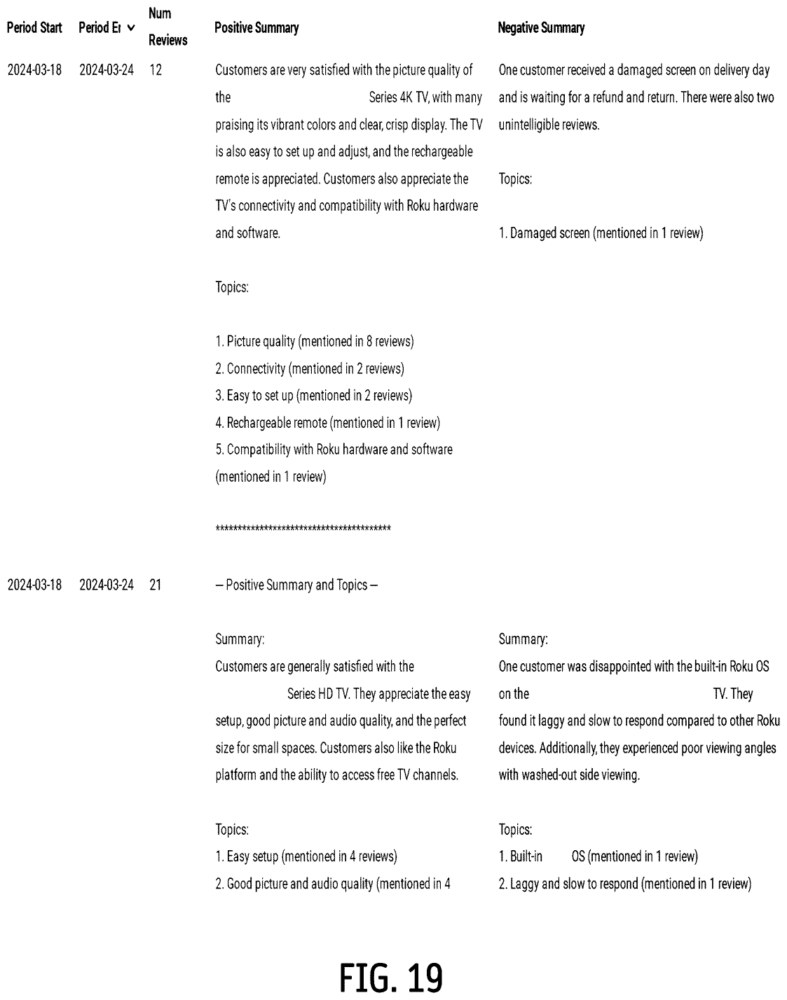

FIG. 19 illustrates a graphical user interface displaying weekly summaries, according to some embodiments of the disclosure. Time-period positive and negative summaries for two weekly periods are displayed in a tabular format.

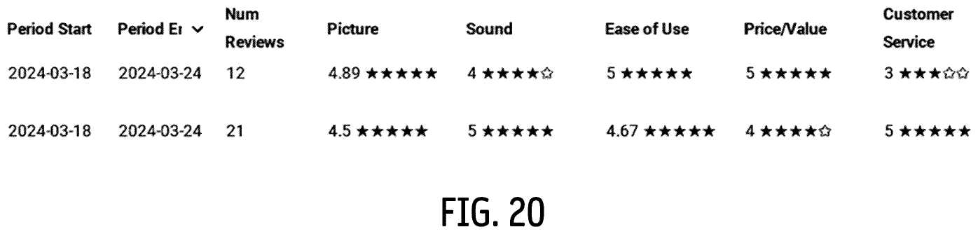

FIG. 20 illustrates a graphical user interface displaying weekly summaries, according to some embodiments of the disclosure. Average sentiment scores for different rating categories for two weekly periods are displayed in a tabular format. Average sentiment scores for different rating categories are displayed numerically and visually with a 5-star meter.

### Building Synthetic Users and Using Synthetic Users to Produce Product Reviews and Predicted Resolutions

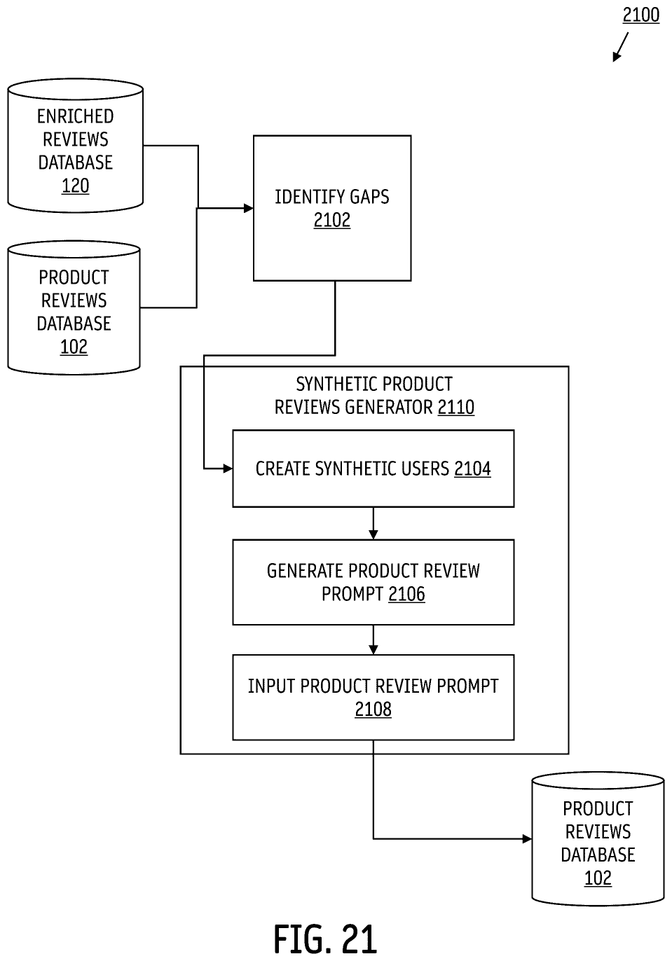

FIG. 21 illustrates identifying gaps and generating synthetic product reviews, according to some embodiments of the disclosure. System 2100 may utilize synthetic users to fill in one or more identified data gaps. System 2100 may include one or more of: enriched reviews database 120, identify gaps 2102, synthetic product reviews generator 2110, and product reviews database 102.

In many scenarios, product reviews may be sparse. It would be beneficial to build synthetic users to generate product reviews, and store them in product reviews database 102.

Identify gaps 2102 may identify one or more data gaps based on the enriched reviews database 120. Identify gaps 2102 may identify one or more data gaps based on the product reviews database 102. In some embodiments, identifying the one or more data gaps includes determining a number of product reviews for the product being less than a threshold. The threshold may be determined based on a percentage of products sold. In some embodiments, identifying the one or more data gaps includes determining that a number of product reviews for the product from a specific demographic being less than a threshold. The threshold may be determined based on a percentage of products sold to the specific demographic.

In response to identifying one or more data gaps by identify gaps 2102, synthetic product reviews generator 2110 may be triggered to build one or more synthetic user to generate one or more product reviews for the one or more data gaps.

Synthetic product reviews generator 2110 may include one or more of: create synthetic users 2104, generate product review prompt 2106, and input product review prompt 2108.

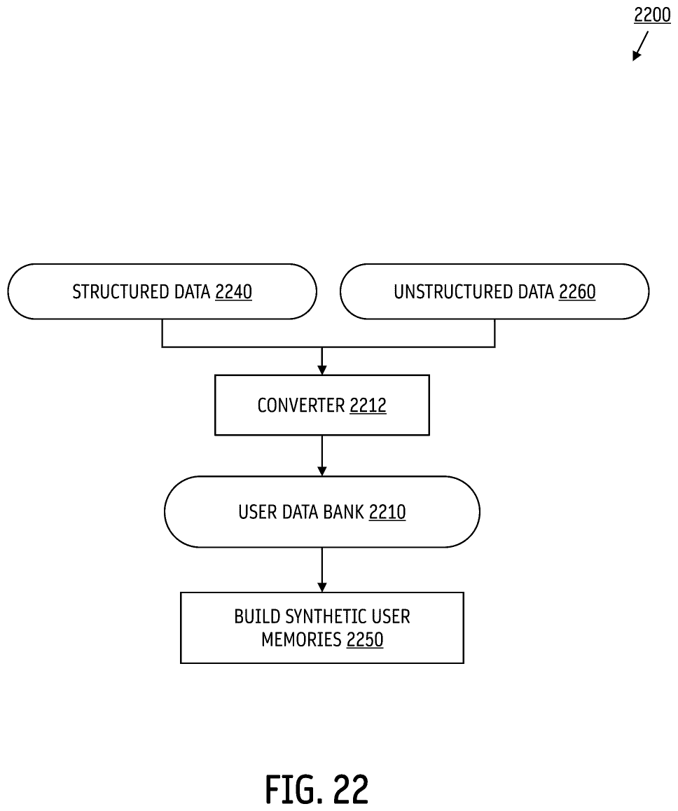

Create synthetic users 2104 involves creating a memory log using at least user data associated with a user or a demographic. The process is described in greater detail in FIGS. 22-25.

Generate product review prompt 2106 involves generating a prompt to review a particular product and utilizing at least some of the natural language log entries in the memory log created by create synthetic users 2104. The prompt can force a large language model into a specific vectorial space to output a response, such as a product review, that may be representative of what the user or the demographic would actually make (the product review may accurately reflect the opinions of the user or the demographic).

Input product review prompt 2108 may input the generated prompt from generate product review prompt 2106 into a large language model.

In some embodiments, a synthetic user may be built using a product review of a real user and other user data associated with the real user. The synthetic user can then review a further product and produce a product review for the further product. Synthetic product reviews generator 2110 may produce a generated product review for the further product using these operations:
create synthetic users 2104 can determine first user data corresponding to the first user;
create synthetic users 2104 can convert the first user data into first natural language log entries of a first memory log;
create synthetic users 2104 can incorporate a third product review of the product into the first memory log (this is the product review of the real user);
create synthetic users 2104 can prompt a model such as a large language model using a first subset of the first natural language log entries extracted from the first memory log using an extraction function;
create synthetic users 2104 can receive a first generated response in response to prompting using the first subset;
create synthetic users 2104 can incorporating the first generated response into the first memory log;
generate product review prompt 2106 can, after incorporating the first generated response, extract a second subset of the first natural language log entries from the first memory log using the extraction function;
input product review prompt 2108 can prompt the model using the second subset of the first natural language log entries (this may utilize a prompt generated by generate product review prompt 2106 and input product review prompt 2108 may input the prompt into a large language model); and
a second generated response may be received in response to the prompting using the second subset. The second generated response can include a fourth product review for a further product.

In some embodiments, a synthetic user may be built using user data of a real user. The synthetic user can then review a product and produce a product review for the product. Synthetic product reviews generator 2110 may produce a generated product review for the product using these operations:
create synthetic users 2104 can determine first user data corresponding to a first user who produced the first product review;
create synthetic users 2104 can convert the first user data into first natural language log entries of a first memory log;
create synthetic users 2104 can prompt a model using a first subset of the first natural language log entries extracted from the first memory log using an extraction function;
create synthetic users 2104 can receive a first generated response in response to prompting using the first subset;
create synthetic users 2104 can incorporate the first generated response into the first memory log;
generate product review prompt 2106 can, after incorporating the first generated response, extract a second subset of the first natural language log entries from the first memory log using the extraction function;
input product review prompt 2108 can prompt the model using the second subset of the first natural language log entries (this may utilize a prompt generated by generate product review prompt 2106 and input product review prompt 2108 may input the prompt into a large language model); and
a second generated response may be received in response to the prompting using the second subset, The second generated response may include the first product review.

Generated product reviews produced by synthetic product reviews generator 2110 may be stored in product reviews database 102. One or more systems downstream of product reviews database 102, such as system 100, system 400, system 1000, system 2100 may utilize and/or analyze the generated product reviews in product reviews database 102.

An operation in create synthetic users 2104 describes using user data to build the memory log. FIG. 22 illustrates user data used to build synthetic user memories, according to some embodiments of the disclosure. A (pre-trained, generic) model can be prompted to respond differently to different contextual information about different users using prompt chaining. Different prompt chains corresponding to different synthetic users can be created from different synthetic user memories. User data, e.g., in the form of data entries and/or natural language entries, may be stored in user data bank 2210, which may be used later to build synthetic user memories in build synthetic user memories 2250.

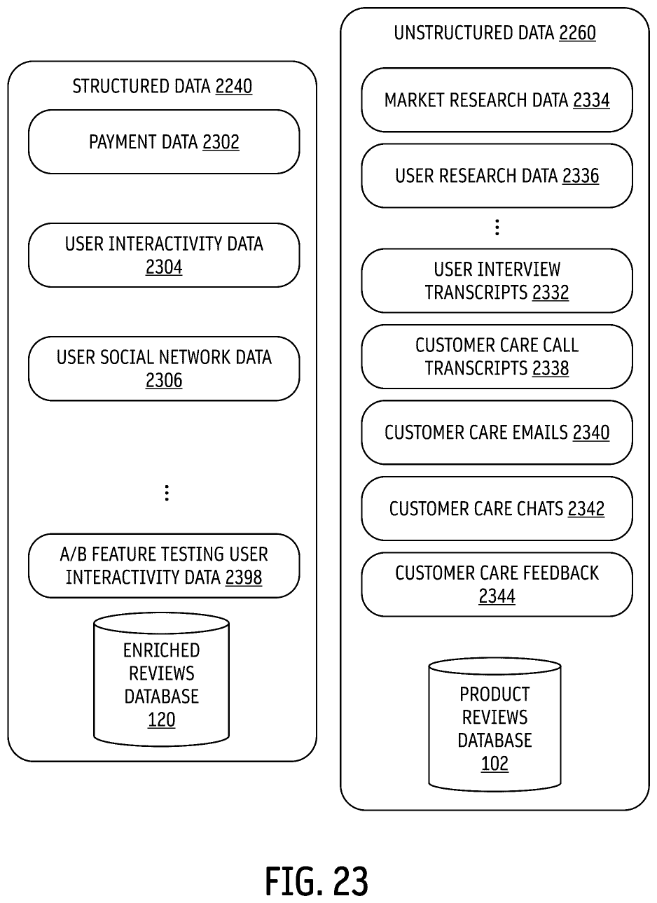

Synthetic user memories can capture different synthetic user experiences. Synthetic user memories can offer insights about the user and/or the behavior of the user. Synthetic user memories may be initialized using data about real human users. Data about real human users may include examples illustrated with structured data 2240 in FIG. 23. Data about real human users may include examples illustrated with unstructured data 2260 in FIG. 23. An example of data about real human users may include historical data gathered from focus group research (e.g., survey questions and survey answers, user demographic data, interview transcripts, etc.). Another example of data about real human users may include user interactivity data logged during past feature testing (e.g., A/B feature testing or other types of experiments). Another example of data about real human users may include user interactivity data logged while human users are using a content streaming platform (e.g., while users are using a recommendation engine to search for content). Another example of data about real human users may include user support chat logs or conversations with users. Another example of data about real human users may include payment and/or purchase history. Another example of data about real human users may include user profile data produced by business intelligence systems and/or big data systems.

Preferably, the model is a large language model, which takes natural language inputs and may generate natural language outputs. Accordingly, structured data 2240 may be converted into natural language entries that represent the structured data 2240. Unstructured data 2260 may be converted to natural language entries that represent the unstructured data 2260. The natural language entries can be stored in user data bank 2210.

In some embodiments, the data about real human users may include demographic information about the first user, one or more survey questions, and one or more survey answers. Converter 2212 may convert the demographic information into natural language entries, e.g., sentences and/or statements formed from the demographic information. Example: “Billy F. is a college student living in a dorm and plays video games 20 hours a week. Billy's is 17 years old.” Converter 2212 may convert the one or more survey questions and the one or more survey answers into natural language entries, e.g., sentences and/or statements about a user. Example: “Billy F. would pay $2 dollars a month extra for Animation Nation Network.”

In some embodiments, the data about real human users may include user interactivity data of the first user on the content streaming platform logged during an experiment. Converter 2212 may convert the user interactivity data into natural language entries, e.g., sentences that describe the user interactivity data. In some embodiments, converter 2212 may translate user interactivity data into natural language descriptions of the user interactivity data. In some embodiments, converter 2212 may translate user interactivity data comprising one or more user interface workflow steps into natural language descriptions of the one or more user interface workflow steps (e.g., describing what a user clicked on, what was shown to the user, what a user provided as input into the user interface, what the user did on the user interface). In some embodiments, converter 2212 may translate user interactivity data comprising one or more subscription workflow steps into natural language descriptions of the one or more subscription workflow steps (e.g., describing what was shown to the user, what the user subscribed to, how much the user paid for the subscription, how long the user kept the subscription, when the user cancelled the subscription, when the user upgraded the subscription, etc.). Example: “Billy F. launched ‘Cooking with Space Aliens’ after searching for ‘extraterrestrial adventure shows’.” Example: “Billy F. searched for ‘extraterrestrial adventure shows’. After skipping over ‘Glamping on the Moon’, and ‘Surviving on Venus’, Billy F. launched ‘Cooking with Space Aliens’” Example: “Billy F. cancelled a subscription to Animation Nation Network.” Example: “Billy F. subscribed to Animation Nation Network at a promotional price of $2.99 a month for the first three months. Billy F. used the subscription to watch shows for 12.5 hours. Billy F. cancelled the subscription a month after subscribing.” Example: “Billy F. binged watched ‘Cooking with Space Aliens’ for 7.5 hours.”

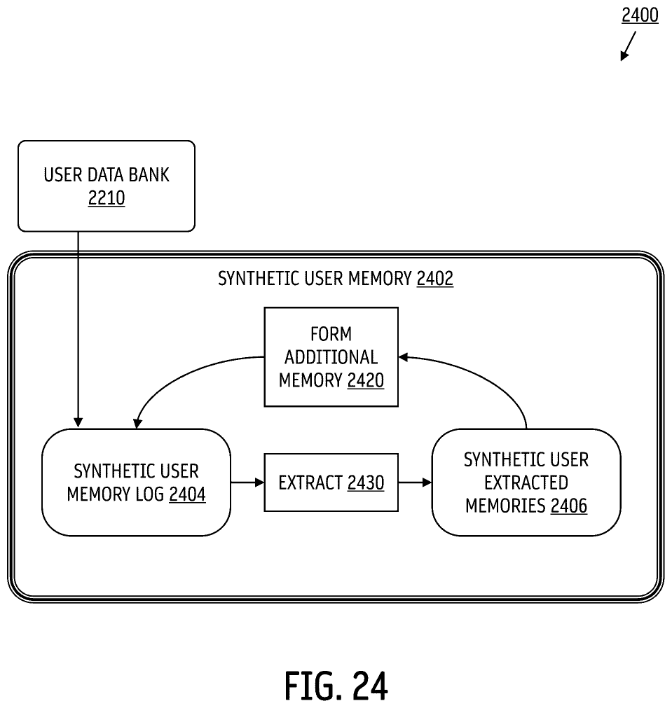

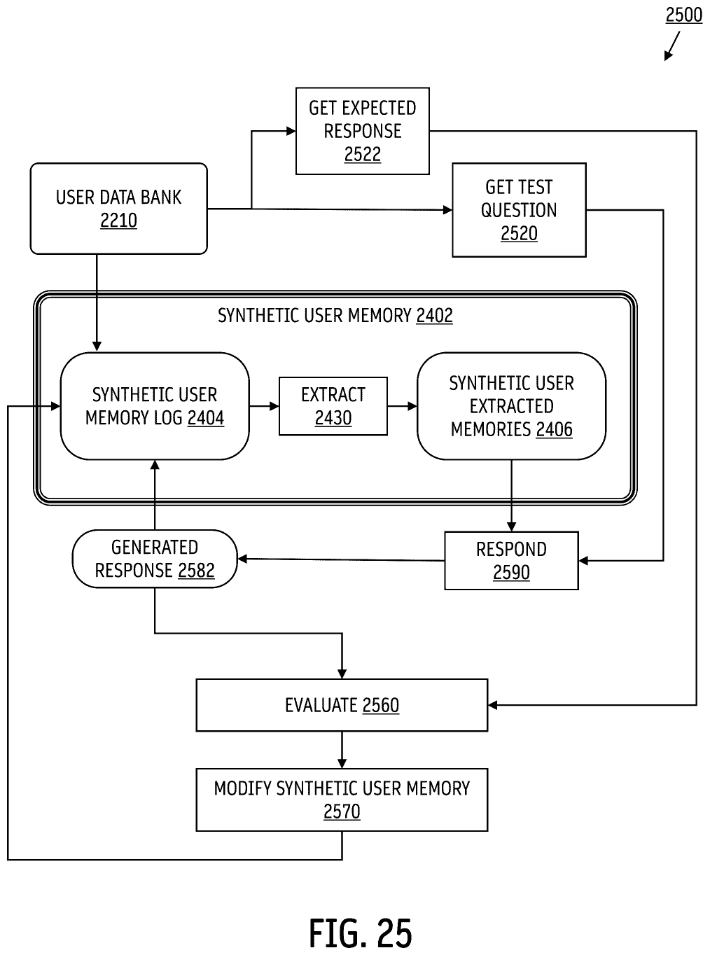

Natural language entries in user data bank 2210 may be used to build synthetic user memories in 2250. Additional details on building synthetic user memories are described with FIGS. 24-25.

FIG. 23 illustrates examples of structured data 2240 and examples of unstructured data 2260, according to some embodiments of the disclosure. Structured data 2240 may include logs of user activity or interactivity with a system. Structured data 2240 may include data collected from a content streaming platform. Structured data 2240 may include information in enriched reviews database 120 such as sentiment scores, main category tags, sub-category tags, negative sentiment Boolean flags, etc. Unstructured data 2260 may include text, audio, videos, emails. Unstructured data 2260 may include user communication data (e.g., conversations, question and answer, prompt and response, etc.). Unstructured data 2260 may include product reviews in product reviews database 102.

Structured data 2240 may include payment data 2302. Payment data 2302 may include logs of data relating to (financial) transactions on a content streaming platform. Data relating to transactions may include information about items which were purchased. Data relating to transactions may include information about credit card transactions, such as details of purchases made using credit cards, credit card number, transaction amount, item purchased, merchant information, whether the credit card was declined, date, time, whether credit limit has been reached, credit card expiration month and year, credit limit, etc. Data relating to transactions may include information about bank transfers, such as transaction amount, sender account number, date, time, etc. Data relating to transactions may include information about digital wallet transactions, such as information about payments made using digital wallet services, date, time, payment amounts, type of digital wallet service, etc. Data relating to transactions may include an indication whether the transaction is set as a recurring transaction. Data relating to transactions may include an indication of how long a recurring transaction is allowed to be repeated until the recurring transaction is paused or cancelled. Data relating to transactions may include an indication of how long until a recurring transaction is restarted after the recurring transaction is paused or cancelled. Data relating to transactions may include a number of recurring transactions for a user. Data relating to transactions may include a total monetary amount of recurring transactions for a user.

Structured data 2240 may include user interactivity data 2304. User interactivity data 2304 may include logs of user session data relating to interactions, behaviors, and/or activity on a content streaming platform. Data that may be tracked or monitored on the content streaming platform as part of user session data may include: session identifier, user identifier, content item impressions (viewed content items), content items that have been focused on, content items that have been previewed (viewed trailer), content items that have been clicked on for more information (viewed description), content items that have been launched (played by user), long watches, short watches, content items that have been skipped or ignored, features that have been utilized or not utilized, user settings, user preferences, language selection, Internet Protocol address, device identifier, software version identifier, streaming hours, purchases, etc. In some cases, user interactivity data 2304 may include one or more statistics about individual users that are derived from the logs. In some cases, user interactivity data 2304 may include one or more patterns about individual users that are derived from the logs.

Structured data 2240 may include user social network data 2306. User social network data 2306 may include social graphs or networks, and insights that is generated from the social graphs or networks. Social graphs or networks may be generated based on information from a variety of sources, including payment data 2302, user interactivity data 2304, social media posts, user public profiles, user event attendance information, demographics, content/activity publicly posted by users, relationship information between users, communities that users are in, location of users, etc. Insights may include user demographics, user interests, user behaviors, user engagement, trends, users' radius of influence, user sentiment, user feedback, etc.

Structured data 2240 may include A/B feature testing user interactivity data 2398. A/B feature testing user interactivity data 2398 may include logs of user session data relating to interactions, behaviors, and/or activity on a content streaming platform when users are presented different versions of a feature. Data that may be tracked or monitored on the content streaming platform as part of user session data during A/B feature testing may include: session identifier, user identifier, feature version identifier, content item impressions (viewed content items), content items that have been focused on, content items that have been previewed (viewed trailer), content items that have been clicked on for more information (viewed description), content items that have been launched (played by user), long watches, short watches, content items that have been skipped or ignored, features that have been utilized or not utilized, user settings, user preferences, language selection, Internet Protocol address, device identifier, software version identifier, streaming hours, purchases, etc.

Unstructured data 2260 may include market research data 2334, and/or user research data 2336, e.g., records, transcripts, responses, interactivity logs, behavior logs, analysis results, and/or data gathered through surveys, focus groups, interviews, and online analytics. Market research data 2334 may include generalized information about users. Market research data 2334 may include persona-specific information about users. Market research data 2334 may include user-specific information about different users.

Unstructured data 2260 may include user communication data, such as user interview transcripts 2332, customer care call transcripts 2338, customer care emails 2340, customer care chats 2342, and customer care feedback 2344. User communication data may include transcripts of conversations, question and answer, prompt and response, stimulus and reply, etc. User communication data may include data in natural language form. User communication data may include summaries or feature vectors which may be generated by semantic models.

FIG. 24 illustrates creating synthetic user memory, according to some embodiments of the disclosure. Synthetic user memory 2402 may correspond to a synthetic user. Relevant entries from user data bank 2210 may be used to form synthetic user memory 2402. The entries, e.g., user data corresponding to a user or a persona, may be stored in synthetic user memory log 2404.

In some embodiments, first user data corresponding to a first user may be determined. First user data may be obtained from user data bank 2210. Optionally, first user data may be converted into first natural language log entries. First user data may be stored as first natural language log entries of a first memory log (e.g., illustrated as synthetic user memory log 2404). The first memory log may be used to capture experiences and/or actions of the first user and higher-level memories generated for a first user.

An extraction function, e.g., in extract 2430, may be used to extract a first subset of first natural language log entries from the first memory log (e.g., illustrated as synthetic user memory log 2404). The first subset of the first natural language log entries may be presented as synthetic user extracted memories 2406. There may be a voluminous number of entries in synthetic user memory log 2404. An extraction function may serve to extract entries that are suitable for forming one or more additional memories, e.g., in form additional memory 2420, to improve synthetic user memory 2402.

In some embodiments, the extraction function may include a scoring function that scores the individual entries in synthetic user memory log 2404. The extraction function may select a top K number of entries which have the highest scores to be in the first subset of the first natural language log entries (e.g., illustrated as synthetic user extracted memories 2406). The scoring function may score (individual) first natural language log entries in the first memory log (e.g., illustrated as synthetic user memory log 2404). The scoring function may be based on freshness of an entry. Freshness may be defined based on how recent the entry was added in the synthetic user memory log 2404. Freshness of an entry may decay according to a decay rate in the synthetic user memory log 2404. Some decay rates may differ depending on the entry, e.g., type of entry, source of the entry, saliency of the entry, etc. The scoring function may be based on the accuracy of an entry. In some cases, the entry is generated by a model. The entry may or may not accurately reflect the first user data about the first user. The accuracy of the entry may be lower when the entry does not correspond with the first user data. The accuracy of the entry may be higher when the entry does correspond with the first user data. The accuracy of an entry may be measured based on an evaluation of a response generated by the model against the first user data. In some cases, the scoring function may be based on one or more other factors such as saliency, relevance, etc. The factors may be measured based on whether the model has identified an entry as being used in making a decision or performing an action.

In some embodiments, the extraction function may include a selection function that selects one or more responses generated by the model to be presented as synthetic user extracted memories 2406. The one or more responses may be included as part of the first subset of the first natural language log entries (e.g., illustrated as synthetic user extracted memories 2406). The one or more responses may enable a prompt chain to be created using the one or more responses as part of an input prompt to the model. In some cases, a prompt chain may include only responses generated by the model. In some cases, a prompt chain may include one or more responses generated by the model and one or more (raw) natural language log entries of synthetic user memory log 2404 retrieved from user data bank 2210.

In some embodiments, the extraction function may include a selection function that selects one or more clusters or categories of natural language log entries in synthetic user memory log 2404 to be presented as synthetic user extracted memories 2406. Entries in synthetic user memory log 2404 may be clustered so that similar entries are grouped in clusters. Entries in synthetic user memory log 2404 may be associated with different categories, e.g., raw user interactivity data, higher-level summary generated by the model, reasoning generated by the model, ranking generated by the model, action generated by the model, score generated by the model, etc.

Form additional memory 2420 may prompt a model (e.g., a large language model) using the first subset of the first natural language log entries (e.g., synthetic user extracted memories 2406). Form additional memory 2420 may prompt a model to summarize the synthetic user extracted memories 2406. Form additional memory 2420 may prompt a model to identify what was most interesting or important about the synthetic user extracted memories 2406. Form additional memory 2420 may prompt a model to provide a reasoning that explains the synthetic user extracted memories 2406. Form additional memory 2420 may prompt a model to generate a reaction to the synthetic user extracted memories 2406. Form additional memory 2420 may prompt a model to generate a action that follows the synthetic user extracted memories 2406. Form additional memory 2420 may receive a first generated response in response to prompting the model using the first subset or the synthetic user extracted memories 2406. Form additional memory 2420 may incorporate the first generated response, e.g., as a new memory or additional memory log entry, into the first memory log (e.g., synthetic user memory log 2404).

In some cases, form additional memory 2420 may input a question and the first subset of the first natural language log entries (e.g., synthetic user extracted memories 2406) to the model to generate an opinion about the first subset of the first natural language log entries.

In some cases, form additional memory 2420 may input a question and the first subset of the first natural language log entries to the model to generate a statement about the first subset of the first natural language log entries and a reasoning behind the statement. For example, form additional memory 2420 may present a description of a user liking a set of shows and a question to the model to summarize in 20 words why the user enjoyed watching these shows.

In some cases, after incorporating the first generated response, extract 2430 may extract a second subset of the first natural language log entries from the first memory log using the extraction function. Extract 2430 may extract a different subset of entries using the revised first memory log, and output synthetic user extracted memories 2406. Form additional memory 2420 may form another new memory or additional memory log entry based on the second subset of the first natural language log entries, by prompting the model using the second subset of the first natural language log entries. Form additional memory 2420 may receive a second generated response in response to the prompting using the second subset. Form additional memory 2420 may incorporate the second response into the first memory log (e.g., into synthetic user memory log 2404). The process of extraction in extract 2430 and forming additional memories in form additional memory 2420 may repeat and iteratively build up synthetic user memory 2402 and synthetic user extracted memories 2406 to better emulate/simulate the first user.

By iteratively prompting the model to generate responses and incorporating the responses in synthetic user extracted memories 2406, a prompt chain built using the synthetic user extracted memories 2406 can force the model to respond to the prompt chain within a certain vectorial space that corresponds to the user or persona. Phrased differently, the model may respond to the prompt chain by generating responses to the prompt chain that are most likely or probable for the particular user or persona.

The process illustrated for building the synthetic user memory for the first user may be performed for one or more other users, e.g., a second user. Second user data corresponding to a second user can be determined or obtained from user data bank 2210. The second user data may optionally be converted into second natural language log entries and stored in a second memory log (separate from the first memory log). Using one or more second natural language log entries (e.g., extracted using an extraction function), the model may generate one or more third responses to form one or more additional memories. The one or more third responses may be incorporated into the second memory log.

Performing the process for different users to build different synthetic user memories may result in capturing different representations and reactions of various users. Different prompt chains built from the different synthetic user memories may cause the model to operate and respond to the different prompt chains within different vectorial spaces. The model may be prompted to respond to the different prompt chains by generating responses that are most likely or probable for the different users or personae. The entries in synthetic user memories and responses generated by the model can be analyzed to better understand the behavior of various users and behavior of a population of users. In some cases, a test question can be input as a prompt to the model along with extracted natural language log entries of a memory log (e.g., thereby forming a prompt chain) to solicit a response from the model that is based on the contextual information encoded in the prompt chain. The same test question can be input as part of different prompt chains using different extracted natural language log entries of different memory logs. The responses to the test question can be collected and analyzed, e.g., to examine differences and/or similarities of responses of different users. For example, (1) a response generated by the model in response to a test question and one or more first natural language log entries of the first memory log, and (2) a response generated by the model in response to the test question and one or more second natural language log entries of the second memory log may be collected and analyzed.

FIG. 25 illustrates evaluation of a generated response and modification of synthetic user memory, according to some embodiments of the disclosure. Building a prompt chain is an iterative process of prompting a model to generate responses to the prompt chain. The final, resulting prompt chain can include sufficient context or memory about a particular user or persona using generated responses from the model, so that the model may respond in a vectorial space that accurately represents the particular user or persona. It is not trivial to evaluate whether a prompt chain or synthetic user memory accurately captures the user and the user's behaviors, and whether the model would generate responses that represent an accurate prediction of the user's actions or reactions. In some cases, user data about users, e.g., users of a content streaming platform, may have a priori knowledge (e.g., ground truth information) about the user's responses to certain prompts. The user data may already include one or more prompt and response pairs, which can be used to test whether the prompt chain is soliciting a response that matches an expected response. In some cases, the user data may include information from product reviews database 102 and/or enriched reviews database 120. Product reviews and derivation thereof can represent ground truth opinions from real users, which can be leveraged to evaluate and validate user memories. The result of the evaluation can be used to modify the prompt chain that is generated and/or the synthetic user memory being used to generate the prompt chain. Repeated evaluation and modification to tokens (e.g., words) being used in a prompt chain can help refine the prompt chain. Repeated evaluation of responses generated in response to different prompt chains can emulate a chain of thought process or a conversation chain with the model. The chain of thought process or the conversation chain can iteratively correct and/or remove incorrect responses. The chain of thought process or the conversation chain can reiterate and/or reemphasize the correct responses from the model. Iterative refining the prompt chain can help push the model to respond in a vectorial space that more accurately represents a particular user or persona.

Get test question 2520 may determine a first question from the user data. The user data may correspond to a user of a content streaming platform. The first question may come from user data bank 2210. The first question may come from synthetic user memory log 2404. Get expected response 2522 may determine a first expected response to the first question. The first expected response may come from user data bank 2210. The first expected response may come from synthetic user memory log 2404.

In some embodiments, the first question may include a survey question previously presented to the user. In some cases, the first expected response may include a survey response to the survey question provided by the user.

In some embodiments, the first question may include user interactivity data corresponding to a first time frame. The first expected response may include user interactivity data corresponding to a second time frame. The second time frame may be after the first time frame. The first expected response may represent a causal action being performed in response to the first question representing events that may have led to the casual action.

Similar to the extraction process described with FIG. 24, a first subset of natural language log entries in the synthetic user memory log 2404 may be extracted by extract 2430 to form synthetic user extracted memories 2406. The first subset of natural language log entries and the first question may be input as a prompt to a model (e.g., a large language model). The first subset of natural language log entries and the first question together may test the prompt chain that is formed using the first subset of natural language log entries. The first subset of natural language log entries and the first question together may test whether the model would respond as expected.

In respond 2590, the model may output a first generated response in response to the inputting of the first subset of natural language log entries and the first question into the model. In respond 2590, the model may produce a first generated response 2582. In some embodiments, the first generated response 2582 may be incorporated into the synthetic user memory log 2404, e.g., as a new memory or additional memory log entry.

In evaluate 2560, the first generated response 2582 may be evaluated against the first expected response obtained from get expected response 2522.

In modify synthetic user memory 2570, the synthetic user memory log 2404 may be modified based on the evaluating in evaluate 2560.

In evaluate 2560, accuracy of the first generated response may be determined based on the first expected response. Accuracy may be determined, e.g., based on similarity or dissimilarity of the first generated response and the first expected response. The first generated response and the first expected response may be provided as inputs to a model to obtain feature vectors that correspond to the first generated response and the first expected response. A dot product of the feature vectors having a low value may indicate that the first generated response and the first expected response are similar. A dot product of the feature vectors having a high value may indicate that the first generated response and the first expected response are dissimilar. The dot product of the feature vectors may be compared against a threshold to determine whether the first generated response and the first expected response are similar or not.

In modify synthetic user memory 2570, accuracy score of the first response in the memory log (e.g., synthetic user memory log 2404) may be set based on the evaluating. The accuracy score may be used in subsequent extraction of one or more subsets of natural language log entries (e.g., in extract 2430) for prompting the model. The accuracy score may be set to a low value (e.g., 0) if the result in evaluate 2560 indicates that the first response is not accurate. The accuracy score may be set to a high value (e.g., 100) if the result in evaluate 2560 indicates that the first response is accurate. The accuracy score may be set based on the dot product of the feature vectors determined in evaluate 2560. The accuracy score may have discrete values. The accuracy score may have continuous values. The accuracy score may be normalized.

In modify synthetic user memory 2570, the first response may be removed from the memory log (e.g., synthetic user memory log 2404).

In modify synthetic user memory 2570, the first response, the first question, and the first expected response may be removed from the memory log (e.g., synthetic user memory log 2404). In some cases, additional entries may be removed from the memory log. In some cases, at least a portion (e.g., at least one or more log entries) of the memory log may be reset or erased based on the evaluating in evaluate 2560.

After the synthetic user memory 2402 is modified based on the evaluating in evaluate 2560, the model may be prompted with a different prompt chain. Get test question 2520 may determine a second question from the user data. The second question may come from user data bank 2210. The second question may come from synthetic user memory log 2404. Get expected response 2522 may determine a second expected response to the second question. The second expected response may come from user data bank 2210. The second expected response may come from synthetic user memory log 2404. In respond 2590, a second subset of natural language log entries of the memory log and the second question may be input into the model. In respond 2590, the model may output a second generated response from the model in response to the inputting. In some cases, the second generated response may be incorporated into the memory log (e.g., synthetic user memory log 2404). In evaluate 2560, the second generated response may be evaluated against the second expected response. In modify synthetic user memory 2570, the memory log (e.g., synthetic user memory log 2404) may be modified based on the evaluating in evaluate 2560.

In some embodiments, evaluate 2560 may determine that the first generated response may not be entirely accurate, or may be partially accurate. Modify synthetic user memory 2570 may generate a modified version of the first generated response and incorporate the modified version of the first generated response into synthetic user memory log 2404. The modified version of the first generated response may omit a portion of the first generated response that is inaccurate and has a portion of the first generated response that is accurate. This modification to the first generated response can mean that at least some tokens of the first generated response can be used in a prompt chain while omitting certain tokens of the first generated response. The prompt chain, using the accurate tokens, can cause the model to get closer to the correct vectorial space that more accurately represents the user or persona.

In some embodiments, evaluate 2560 may determine that the first generated response may be at least partially inaccurate. Modify synthetic user memory 2570 may generate a modified version of the first response and incorporating the modified version of the first response into synthetic user memory log 2404. The modified version of the first response may include a correction to the portion of the first response that is inaccurate. For example, the modified version of the first response may include, e.g., “Billy F actually finds ‘Time Traveling with Alien Chefs’ repulsive, unrelatable, and unappetizing. Billy F would prefer to watch cooking shows such as ‘Cooking with Cat Helpers’ and ‘Healthy Stress Baking’”. This modification to the first generated response can mean that at least some tokens of the first generated response can be used in a prompt chain while correcting certain tokens of the first generated response. The prompt chain, using the accurate tokens and corrected tokens, can cause the model to get closer to the correct vectorial space that more accurately represents the user or persona, and farther away from the incorrect vectorial space that does not accurately represent the user or persona.

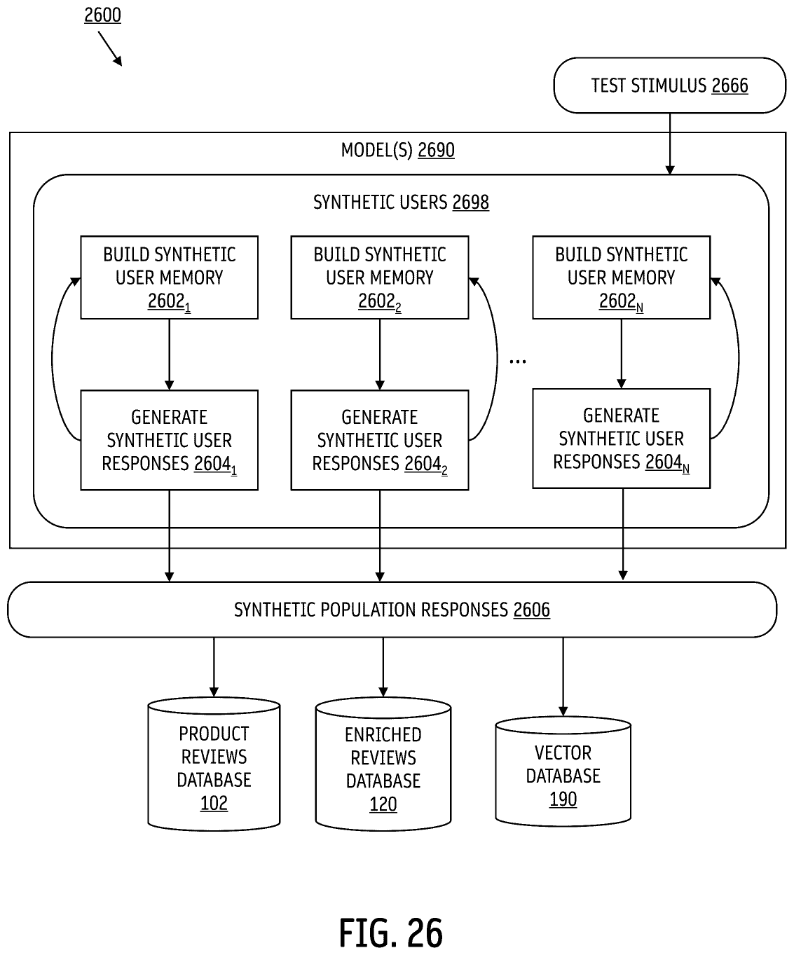

FIG. 26 illustrates obtaining synthetic population responses and storing the responses in a database for further analysis, according to some embodiments of the disclosure. Using processes illustrated in FIGS. 24-25, a population of synthetic users 2698 may be modeled in model(s) 2690. Build synthetic user memory 2602₁, build synthetic user memory 2602₂, . . . and build synthetic user memory 2602_{N}, may be implemented to build user memories corresponding to N different users. Model(s) 2690 (including one or more large language models) may be prompted using corresponding user memories or prompt chains made from the user memories to generate synthetic population responses 2606, e.g., by generate synthetic user responses 2604₁, generate synthetic user responses 2604₂, . . . and generate synthetic user responses 2604_{N}. Generated responses, e.g., synthetic population responses 2606, or responses generated by generate synthetic user responses 2604₁, generate synthetic user responses 2604₂, . . . and generate synthetic user responses 2604_{N}, may be used as subsequent input prompts to model(s) 2690 to perform prompt chaining. Generate synthetic user responses 2604ᵢ may be combined with or performed as a part of build synthetic user memory 2602ᵢ.

In some embodiments, the synthetic population responses 2606 may include simulated responses from a population of synthetic users 2698. The synthetic population responses 2606 may include simulated responses from a population of synthetic users 2698 in response to one or more test stimuli 2666 and respective prompt chains that have been created for the synthetic users 2698.

Test stimuli 2666 and prompt chains built for synthetic users 2698 may be used together to create prompts for prompting the model(s) 2690 to trigger generation of synthetic population responses 2606.

In some cases, test stimulus 2666 includes a request to review a particular product. In some cases, test stimulus 2666 includes asking how would you feel about a particular main issue, given a particular main issue has occurred (the main issue may describe one of the main category tags). In some cases, test stimulus 2666 includes asking how would you feel about a particular sub-issue, given a particular sub-issue has occurred (the sub-issue may describe one of the sub-category tags). The synthetic population responses 2606 generated in response to test stimulus 2666 may be stored in product reviews database 102. The synthetic population responses 2606 generated in response to test stimulus 2666 may be stored in enriched reviews database 120.

In some cases, test stimulus 2666 includes asking what action or resolution would resolve a particular product review, given that you have written this product review. In some cases, test stimulus 2666 includes asking what action or resolution would resolve a particular main issue, given a particular main issue has occurred (the main issue may describe one of the main category tags). In some cases, test stimulus 2666 includes asking what action or resolution would resolve a particular sub-issue, given a particular sub-issue has occurred (the sub-issue may describe one of the sub-category tags). The synthetic population responses 2606 generated in response to test stimulus 2666 may include a predicted resolution to a product review or a derivation of the product review (e.g., a main category tag, a sub-category tag, etc.). stored as values to corresponding keys in vector database 190.

### Quality Control Reviews Analysis Platform

Various illustrated embodiments of FIGS. 1-26 are described for product reviews. In some embodiments, the teachings can be used for product reviews where the product is a content item, and the product review comprises natural language text written by a quality control reviewer about a quality control aspect of a pipeline that delivers the content item to the quality control reviewer.

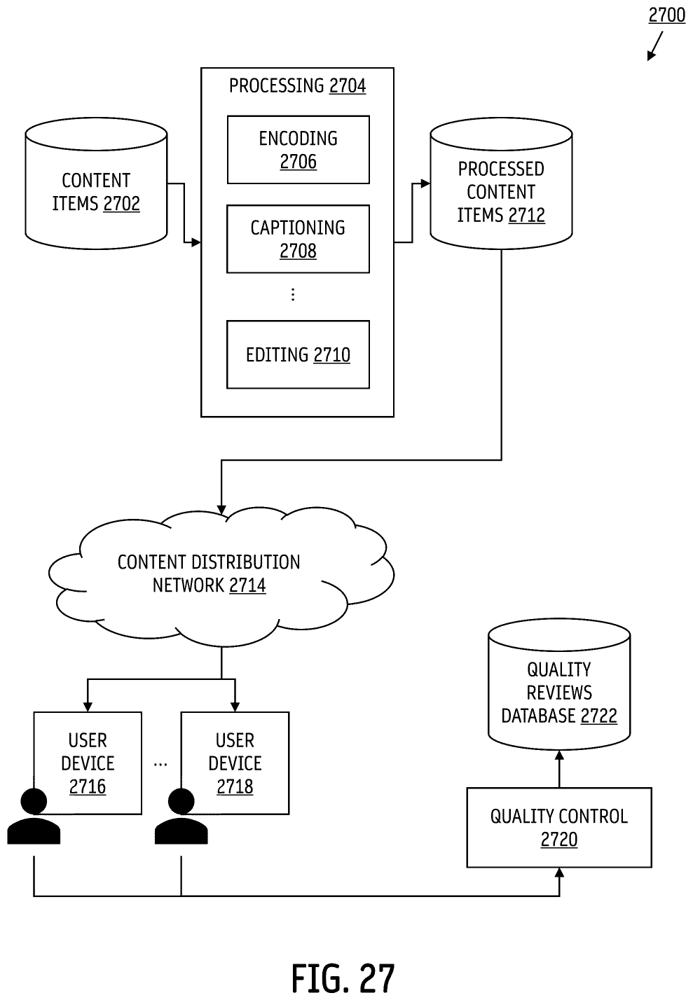

FIG. 27 illustrates a content delivery pipeline and a quality control process, according to some embodiments of the disclosure. System 2700 includes one or more of: content items 2702, processing 2704, processed content items 2712, content distribution network 2714, user device 2716, user device 2718, quality control 2720, and quality reviews database 2722.

Content items 2702 may include media content, such as audio content, video content, image content, extended reality (XR) content (which may include one or more of augmented reality (AR) content, virtual reality (VR) content, and/or mixed reality (MR) content), gaming content, books, podcasts, text content, articles, advertisements, shorts, etc.

In some cases, content items 2702 may be processed by processing 2704. Processing 2704 can include one or more of: encoding 2706 (e.g., for compression purposes), captioning 2708, and editing 2710 (e.g., to insert advertisements, to resize aspect ratio, to apply censoring, to remove certain portions of the content item, to impaint certain portions of the content item, etc.). In some cases, processing 2704 may include metadata generation, such as generation and addition of tags to the content items 2702. Content items processed by processing 2704 can be stored in processed content items 2712.

Processed content items 2712 may be distributed to a plurality of user devices, depicted as user device 2716, . . . user device 2718, via content distribution network 2714.

Users using the user devices may be quality control reviewers tasked to write a control reviews about the processed content items 2712. A part of content delivery pipeline (as part of system 2700) such as a part of processing 2704, content distribution network 2714, content items 2702, processed content items 2712, may encounter an error or issue. The error or issue may be noticed by quality control reviewers. The error or issue may be reported by the quality control reviewers and submitted to quality control 2720. The quality control reviews may be stored in quality reviews database 2722. Examples of quality control reviews may include:
Black video
No audio
Audio is off
Tagging is wrong
Please confirm this reconciles in entity search. Thanks!
Incorrect video

Quality control reviews may have their own set of main category tags. Quality control reviews may have their own set of sub-category tags. Domain information used in prompts may be different for quality control reviews. Guiding instructions, rating instructions, and weighing instructions in prompts can be different for quality control reviews. Few-shot examples in prompts can be different for quality control reviews.

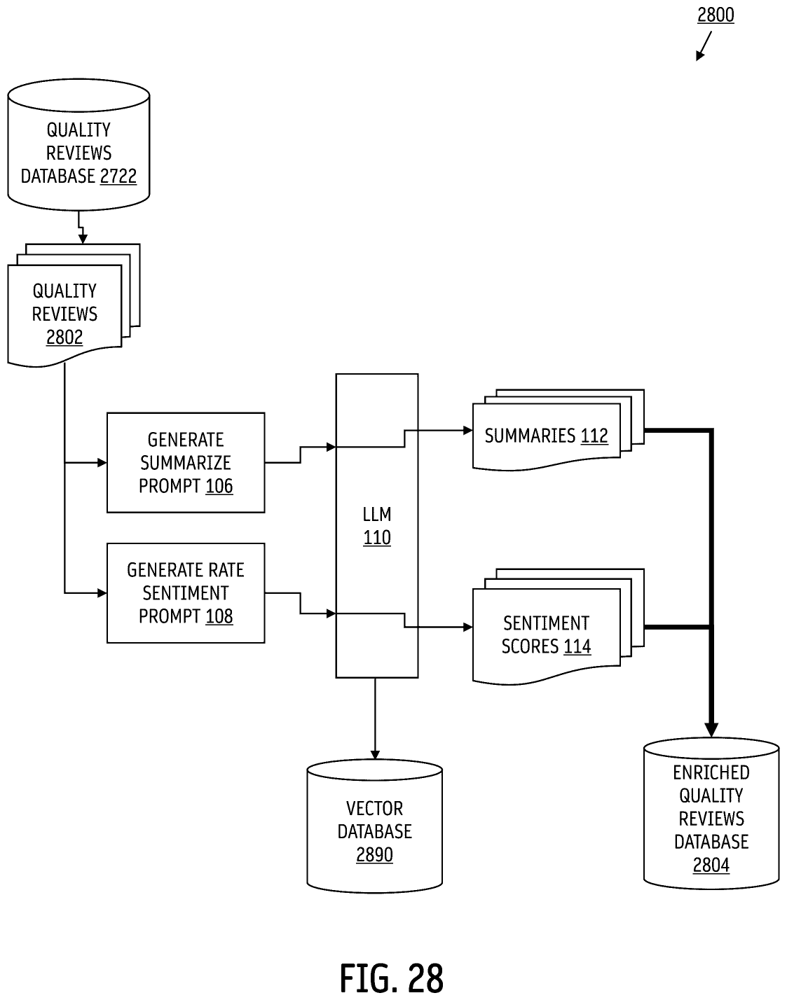

FIG. 28 illustrates using an LLM to generate summaries and sentiment scores, according to some embodiments of the disclosure. System 2800 may include one or more of: quality reviews database 2722, quality reviews 2802, generate summarize prompt 106, generate rate sentiment prompt 108, LLM 110, summaries 112, sentiment scores 114, vector database 2890, and enriched quality reviews database 2804. Quality reviews 2802 may be retrieved from quality reviews database 2722. A quality review in quality review 2802 can be used in place of a product review as described in FIGS. 1-26. A quality review in quality review 2802 can be used by prompt generators such as generate summarize prompt 106 and generate rate sentiment prompt 108. Feature vectors generated by LLM 110 may be stored in vector database 2890 (which may be implemented similarly to vector database 190). Outputs, such as summaries 112 and sentiment scores 114 may be stored in enriched quality reviews database 2804.

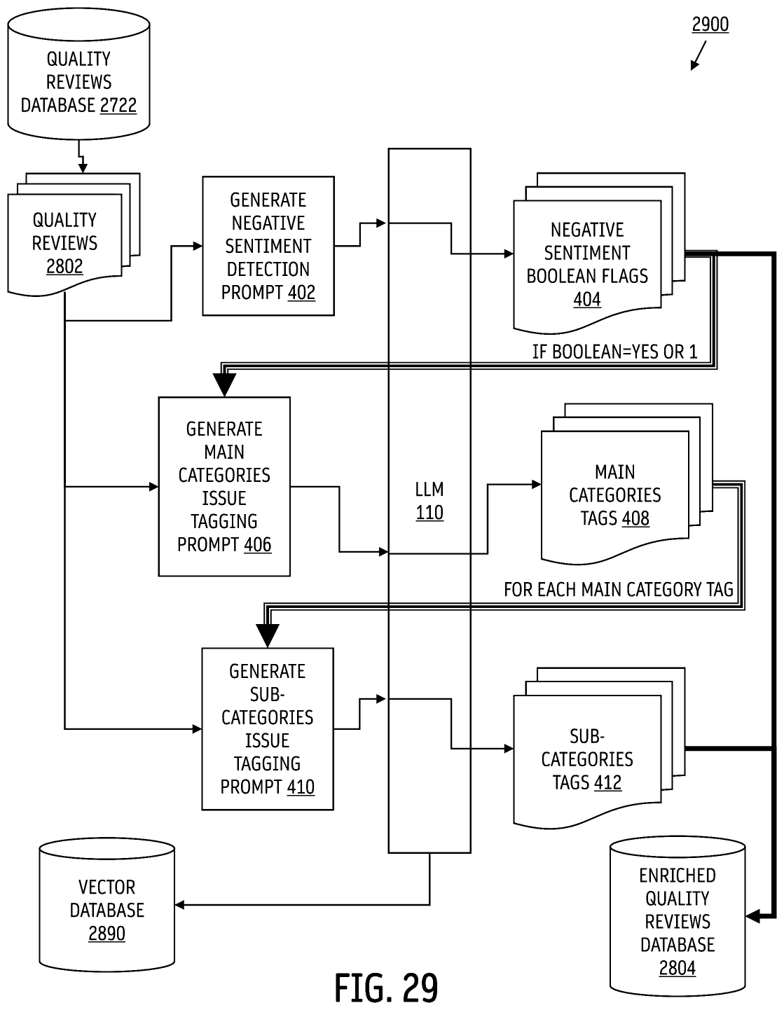

FIG. 29 illustrates using an LLM to generate negative sentiment Boolean flags, main categories tags, and sub-categories tags, according to some embodiments of the disclosure. system 2900 may include quality reviews database 2722, quality reviews 2802, generate negative sentiment detection prompt 402, generate main categories issue tagging prompt 406, generate sub-categories issue tagging prompt 410, LLM 110, negative sentiment Boolean flags 404, main categories tags 408, sub-categories tags 412, vector database 2890, and enriched quality reviews database 2804. A quality review in quality review 2802 can be used in place of a product review as described in FIGS. 1-26. A quality review in quality review 2802 can be used by prompt generators such as generate negative sentiment detection prompt 402, generate main categories issue tagging prompt 406, and generate sub-categories issue tagging prompt 410. Feature vectors generated by LLM 110 may be stored in vector database. Outputs, such as negative sentiment Boolean flags 404, main categories tags 408, and sub-categories tags 412 may be stored in enriched quality reviews database 2804.

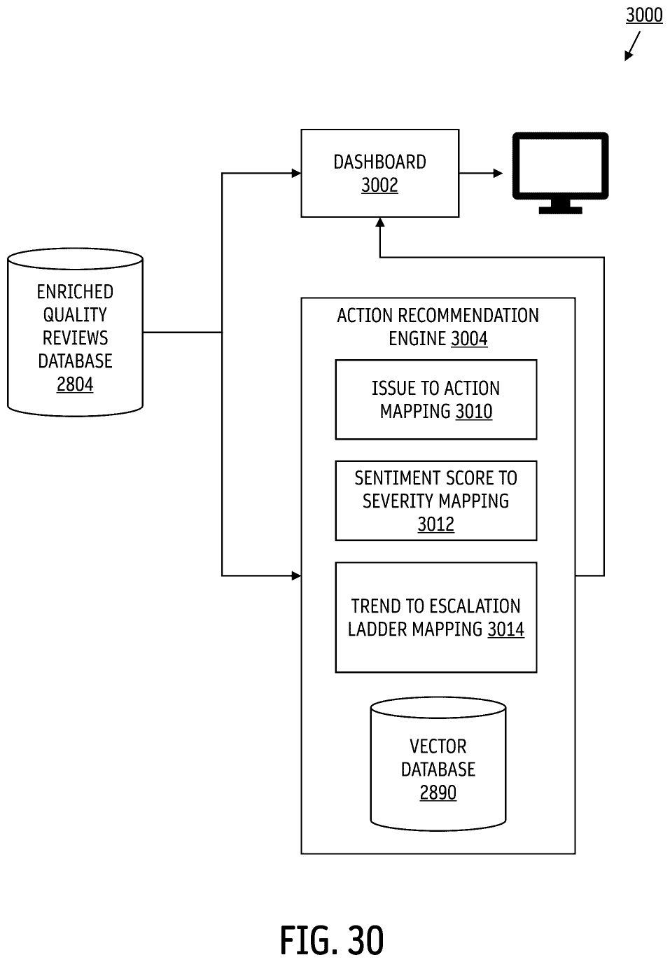

FIG. 30 illustrates a dashboard to visualize enriched quality reviews, and an action recommendation engine, according to some embodiments of the disclosure. Dashboard 3002 may be implemented similarly to dashboard 1002. Action recommendation engine 3004 may be implemented similarly to action recommendation engine 1004. Issue to action mapping 3010 may be implemented similarly to issue to action mapping 1010. Sentiment score to severity mapping 3012 may be implemented similarly to sentiment score to severity mapping 1012. Trend to escalation ladder mapping 3014 may be implemented similarly to trend to escalation ladder mapping 1014. Vector database 2890 may be implemented similarly to vector database 190. The values corresponding to appropriate resolutions of quality control reviews stored in vector database 2890 would be different from the values used in vector database 190.

### Method for Analyzing Reviews

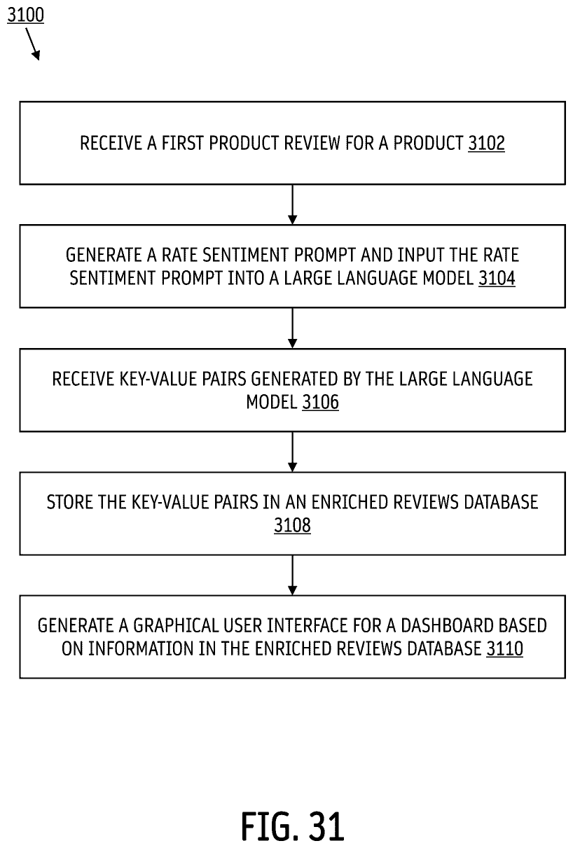

FIG. 31 is a flow chart illustrating a method for analyzing reviews, according to some embodiments of the disclosure. Method 3100 may be performed by systems described and illustrated herein. Method 3100 may be encoded as instructions on memory 3404 of FIG. 34.

In 3102, a first product review for a product is received.

In 3104, a rate sentiment prompt is generated and input into a large language model. The rate sentiment prompt may include the first product review, a first rating instruction to return either an integer sentiment score or a null value for each one of a plurality of rating categories, and a first weighing instruction to increase a value for the integer sentiment score for a first presence of one or more first keywords having a specific connotation.

In 3106, key-value pairs generated by the large language model in response to the large language model receiving the rate sentiment prompt are received. The key-value pairs can have keys corresponding to the plurality of rating categories and values corresponding to the integer sentiment score or a null value.

In 3108, the key-value pairs are stored in an enriched reviews database.

In 3110, a graphical user interface for a dashboard may be generated based on information in the enriched reviews database.

### Method for Generating Reviews

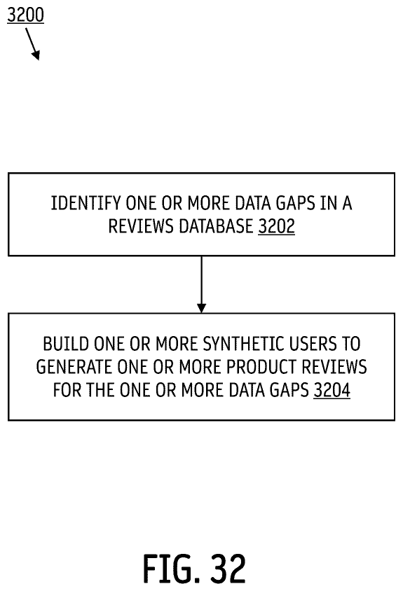

FIG. 32 is a flow chart illustrating a method for generating reviews, according to some embodiments of the disclosure. Method 3200 may be performed by systems described and illustrated herein. Method 3200 may be encoded as instructions on memory 3404 of FIG. 34.

In 3202, one or more data gaps may be identified in a reviews database. Examples of an enriched reviews database is described herein (e.g., product reviews database 102, enriched reviews database 120, quality reviews database 2722, and enriched quality reviews database 2804).

In 3204, in response to identifying the one or more data gaps, one or more synthetic user may be built to generate one or more product reviews for the one or more data gaps.

### Method for Predicting Resolutions to Reviews

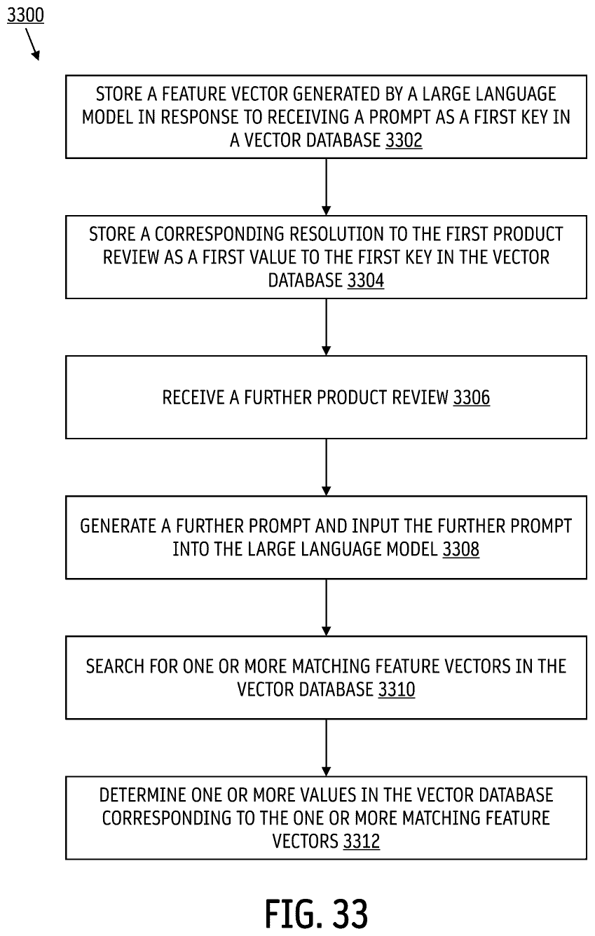

FIG. 33 is a flow chart illustrating a method for predicting resolutions to reviews, according to some embodiments of the disclosure. Method 3300 may be performed by systems described and illustrated herein. Method 3300 may be encoded as instructions on memory 3404 of FIG. 34.

In 3302, a feature vector generated by an LLM in response to receiving a prompt may be stored as a first key in a vector database. The prompt may include a first product review and may be a prompt generated by one of the prompt generators described herein.

In 3304, a corresponding resolution to the first product review may be stored as a first value to the first key in the vector database.

In 3306, a further product review may be received.

In 3308. a further prompt may be generated and input into the LLM. The further prompt may include the further product review and may be a prompt generated by one of the prompt generators described herein. A same prompt generator may be used to generate the prompt and the further prompt.

In 3310, the method involves searching for one or more matching feature vectors in the keys of the vector database that matches a further feature vector generated by the LLM in response to receiving the further prompt.

In 3312, one or more values in the vector database corresponding to the one or more matching feature vectors may be determined. The one or more determined values include one or more resolutions to the further product review.

### Exemplary Computing Device

FIG. 34 is a block diagram of an exemplary computing device 3400, according to some embodiments of the disclosure. One or more computing devices 3400 may be used to implement the functionalities described with the FIGS. and herein. A number of components illustrated in FIG. 34 are included in computing device 3400, but any one or more of these components may be omitted or duplicated, as suitable for the application. In some embodiments, some or all of the components included in the computing device 3400 may be attached to one or more motherboards. In some embodiments, some or all of these components are fabricated onto a single system on a chip (SoC) die. Additionally, in various embodiments, the computing device 3400 may not include one or more of the components illustrated in FIG. 34, and the computing device 3400 may include interface circuitry for coupling to the one or more components. For example, the computing device 3400 may not include a display device 3406, and may include display device interface circuitry (e.g., a connector and driver circuitry) to which a display device 3406 may be coupled. In another set of examples, the computing device 3400 may not include an audio input device 3418 or an audio output device 3408 and may include audio input or output device interface circuitry (e.g., connectors and supporting circuitry) to which an audio input device 3418 or audio output device 3408 may be coupled.

The computing device 3400 may include a processing device 3402 (e.g., one or more processing devices, one or more of the same type of processing device, one or more of different types of processing device). The processing device 3402 may include electronic circuitry that process electronic data from data storage elements (e.g., registers, memory, resistors, capacitors, quantum bit cells) to transform that electronic data into other electronic data that may be stored in registers and/or memory. Examples of processing device 3402 may include a central processing unit (CPU), a graphical processing unit (GPU), a quantum processor, a machine learning processor, an artificial intelligence processor, a neural network processor, an artificial intelligence accelerator, an application specific integrated circuit (ASIC), an analog signal processor, an analog computer, a microprocessor, a digital signal processor, a field programmable gate array (FPGA), a tensor processing unit (TPU), a data processing unit (DPU), etc.

The computing device 3400 may include a memory 3404, which may itself include one or more memory devices such as volatile memory (e.g., DRAM), nonvolatile memory (e.g., read-only memory (ROM)), high bandwidth memory (HBM), flash memory, solid state memory, and/or a hard drive. Memory 3404 includes one or more non-transitory computer-readable storage media. In some embodiments, memory 3404 may include memory that shares a die with the processing device 3402.

In some embodiments, memory 3404 includes one or more non-transitory computer-readable media storing instructions executable to perform operations described with the FIGS. and herein, such as the methods illustrated in FIGS. 31-33, including method 3100, method 3200, and method 3300.

Memory 3404 may store instructions that encode one or more exemplary parts. Exemplary parts that may be encoded as instructions and stored in memory 3404 are depicted. The instructions stored in the one or more non-transitory computer-readable media may be executed by processing device 3402. Exemplary parts may include one or more components of system 100 of FIG. 1. Exemplary parts may include one or more components of system 400 of FIG. 4. Exemplary parts may include one or more components of system 800 of FIG. 8. Exemplary parts may include one or more components of system 1000 of FIG. 10. Exemplary parts may include one or more components of system 1000 of FIG. 21. Exemplary parts may include one or more components of system 2200 of FIG. 22. Exemplary parts may include one or more components of system 2400 of FIG. 24. Exemplary parts may include one or more components of system 2500 of FIG. 25. Exemplary parts may include one or more components of system 2600 of FIG. 26. Exemplary parts may include one or more components of system 2700 of FIG. 27. Exemplary parts may include one or more components of system 2800 of FIG. 28. Exemplary parts may include one or more components of system 2900 of FIG. 29. Exemplary parts may include one or more components of system 3000 of FIG. 30.

In some embodiments, memory 3404 may store data, e.g., data structures, binary data, bits, metadata, files, blobs, etc., as described with the FIGS. and herein. Exemplary data that may be stored in memory 3404 are depicted. Exemplary data may include one or more data of system 400 of FIG. 4. Exemplary data may include one or more data of system 800 of FIG. 8. Exemplary data may include one or more data of system 1000 of FIG. 10. Exemplary data may include one or more data of system 1000 of FIG. 21. Exemplary data may include one or more data of system 2200 of FIG. 22. Exemplary data may include one or more data of system 2400 of FIG. 24. Exemplary data may include one or more data of system 2500 of FIG. 25. Exemplary data may include one or more data of system 2600 of FIG. 26. Exemplary data may include one or more data of system 2700 of FIG. 27. Exemplary data may include one or more data of system 2800 of FIG. 28. Exemplary data may include one or more data of system 2900 of FIG. 29. Exemplary data may include one or more data of system 3000 of FIG. 30.

In some embodiments, memory 3404 may store one or more machine learning models (and or parts thereof) that are used as LLM 110, model(s) 2690, and other large language models described herein. Memory 3404 may store training data for training the one or more machine learning models. Memory 3404 may store input data (e.g., input tokens), output data (e.g., output tokens), intermediate outputs, intermediate inputs of one or more machine learning models. Memory 3404 may store instructions to perform one or more operations of the machine learning model. Memory 3404 may store one or more parameters used by the machine learning model. Memory 3404 may store information that encodes how processing units of the machine learning model are connected with each other.

In some embodiments, the computing device 3400 may include a communication device 3412 (e.g., one or more communication devices). For example, the communication device 3412 may be configured for managing wired and/or wireless communications for the transfer of data to and from the computing device 3400. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not. The communication device 3412 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication device 3412 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication device 3412 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication device 3412 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication device 3412 may operate in accordance with other wireless protocols in other embodiments. The computing device 3400 may include an antenna 3422 to facilitate wireless communications and/or to receive other wireless communications (such as radio frequency transmissions). The computing device 3400 may include receiver circuits and/or transmitter circuits. In some embodiments, the communication device 3412 may manage wired communications, such as electrical, optical, or any other suitable communication protocols (e.g., the Ethernet). As noted above, the communication device 3412 may include multiple communication chips. For instance, a first communication device 3412 may be dedicated to shorter-range wireless communications such as Wi-Fi or Bluetooth, and a second communication device 3412 may be dedicated to longer-range wireless communications such as global positioning system (GPS), EDGE, GPRS, CDMA, WiMAX, LTE, EV-DO, or others. In some embodiments, a first communication device 3412 may be dedicated to wireless communications, and a second communication device 3412 may be dedicated to wired communications.

The computing device 3400 may include power source/power circuitry 3414. The power source/power circuitry 3414 may include one or more energy storage devices (e.g., batteries or capacitors) and/or circuitry for coupling components of the computing device 3400 to an energy source separate from the computing device 3400 (e.g., DC power, AC power, etc.).

The computing device 3400 may include a display device 3406 (or corresponding interface circuitry, as discussed above). The display device 3406 may include any visual indicators, such as a heads-up display, a computer monitor, a projector, a touchscreen display, a liquid crystal display (LCD), a light-emitting diode display, or a flat panel display, for example.

The computing device 3400 may include an audio output device 3408 (or corresponding interface circuitry, as discussed above). The audio output device 3408 may include any device that generates an audible indicator, such as speakers, headsets, or earbuds, for example.

The computing device 3400 may include an audio input device 3418 (or corresponding interface circuitry, as discussed above). The audio input device 3418 may include any device that generates a signal representative of a sound, such as microphones, microphone arrays, or digital instruments (e.g., instruments having a musical instrument digital interface (MIDI) output).

The computing device 3400 may include a GPS device 3416 (or corresponding interface circuitry, as discussed above). The GPS device 3416 may be in communication with a satellite-based system and may receive a location of the computing device 3400, as known in the art.

The computing device 3400 may include a sensor 3430 (or one or more sensors). The computing device 3400 may include corresponding interface circuitry, as discussed above). Sensor 3430 may sense physical phenomenon and translate the physical phenomenon into electrical signals that can be processed by, e.g., processing device 3402. Examples of sensor 3430 may include: capacitive sensor, inductive sensor, resistive sensor, electromagnetic field sensor, light sensor, camera, imager, microphone, pressure sensor, temperature sensor, vibrational sensor, accelerometer, gyroscope, strain sensor, moisture sensor, humidity sensor, distance sensor, range sensor, time-of-flight sensor, pH sensor, particle sensor, air quality sensor, chemical sensor, gas sensor, biosensor, ultrasound sensor, a scanner, etc.

The computing device 3400 may include another output device 3410 (or corresponding interface circuitry, as discussed above). Examples of the other output device 3410 may include an audio codec, a video codec, a printer, a wired or wireless transmitter for providing information to other devices, haptic output device, gas output device, vibrational output device, lighting output device, home automation controller, or an additional storage device.

The computing device 3400 may include another input device 3420 (or corresponding interface circuitry, as discussed above). Examples of the other input device 3420 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 3400 may have any desired form factor, such as a handheld or mobile computer system (e.g., a cell phone, a smart phone, a mobile internet device, a music player, a tablet computer, a laptop computer, a netbook computer, a personal digital assistant (PDA), an ultramobile personal computer, a remote control, wearable device, headgear, eyewear, footwear, electronic clothing, etc.), a desktop computer system, a server or other networked computing component, a printer, a scanner, a monitor, a set-top box, an entertainment control unit, a vehicle control unit, a digital camera, a digital video recorder, an Internet-of-Things device (e.g., light bulb, cable, power plug, power source, lighting system, audio assistant, audio speaker, smart home device, smart thermostat, camera monitor device, sensor device, smart home doorbell, motion sensor device), a virtual reality system, an augmented reality system, a mixed reality system, or a wearable computer system. In some embodiments, the computing device 3400 may be any other electronic device that processes data.

### Select Examples

Example 1 provides a method, including receiving a first product review for a product; generating a rate sentiment prompt and inputting the rate sentiment prompt into a large language model, the rate sentiment prompt including the first product review, a first rating instruction to return either an integer sentiment score or a null value for each one of a plurality of rating categories, and a first weighing instruction to increase a value for the integer sentiment score for a first presence of one or more first keywords having a specific connotation; receiving key-value pairs generated by the large language model in response to the large language model receiving the rate sentiment prompt, the key-value pairs having keys corresponding to the plurality of rating categories and values corresponding to the integer sentiment score or a null value; storing the key-value pairs in an enriched reviews database; and generating a graphical user interface for a dashboard based on information in the enriched reviews database.

Example 2 provides the method of example 1, further including generating a first summarize prompt and inputting the first summarize prompt into the large language model, the first summarize prompt including the first product review; and receiving a first summary of the first product review generated by the large language model in response to the large language model receiving the first summarize prompt.

Example 3 provides the method of example 2, further including storing the first summary in the enriched reviews database.

Example 4 provides the method of example 2 or 3, further including receiving a second product review for the product, the first product review and the second product review being associated with a same time-period; generating a second summarize prompt and inputting the second summarize prompt into the large language model, the second summarize prompt including the second product review; and receiving a second summary of the second product review generated by the large language model in response to the large language model receiving the second summarize prompt.

Example 5 provides the method of example 4, further including storing the second summary in the enriched reviews database.

Example 6 provides the method of example 4 or 5, further including generating a time-period summarize prompt and inputting the time-period summarize prompt into the large language model, the time-period summarize prompt including the first summary and the second summary; and receiving a time-period summary of the first summary and the second summary generated by the large language model in response to the large language model receiving the time-period summarize prompt.

Example 7 provides the method of example 6, where the time-period summarize prompt includes a role definition for the large language model; domain information about the product; and a first instruction to generate a first natural language summary of positive sentiment, one or more first topics associated with positive sentiment, one or more first examples associated with each one of the one or more first topics, a second natural language summary of negative sentiment, one or more second topics associated with negative sentiment, and one or more second examples associated with each one of the one or more second topics.

Example 8 provides the method of example 7, where the time-period summarize prompt further includes a second instruction to output a first number of mentions for each one of the one or more first topics and a second number of mentions for each one of the one or more second topics.

Example 9 provides the method of any one of examples 6-8, further including storing the time-period summary in the enriched reviews database.

Example 10 provides the method of any one of examples 1-9, where the rate sentiment prompt further includes the plurality of rating categories and definitions associated with the plurality of rating categories.

Example 11 provides the method of any one of examples 1-10, where the rate sentiment prompt further includes a first guiding instruction to include an integer sentiment score for a first rating category in the plurality of rating categories for a second presence of one or more second keywords associated with the first rating category.

Example 12 provides the method of any one of examples 1-11, further including generating a negative sentiment detection prompt and inputting the negative sentiment detection prompt into the large language model, the negative sentiment detection prompt including the first product review; and receiving a negative sentiment Boolean flag generated by the large language model in response to the large language model receiving the negative sentiment detection prompt.

Example 13 provides the method of example 12, where the negative sentiment detection prompt further includes a second weighing instruction to return a value of 1 when the first product review is completely positive without reservations.

Example 14 provides the method of example 12 or 13, where the negative sentiment detection prompt further includes a third weighing instruction to return a value of 0 when the first product review is incomplete or missing.

Example 15 provides the method of any one of examples 12-14, where the negative sentiment detection prompt further includes a fourth weighing instruction to return a value of 0 when the first product review is at least partly negative or has a qualifying statement.

Example 16 provides the method of any one of examples 12-15, where the negative sentiment Boolean flag has a value of 1 when negative sentiment is detected by the large language model, and the negative sentiment Boolean flag has a value of 0 when negative sentiment is not detected by the large language model.

Example 17 provides the method of any one of examples 12-15, further including storing the negative sentiment Boolean flag in the enriched reviews database.

Example 18 provides the method of any one of examples 12-17, further including in response to the negative sentiment Boolean flag indicating that negative sentiment is detected in the first product review, generating a main categories tagging prompt and inputting the main categories tagging prompt into the large language model, the main categories tagging prompt including the first product review, and a plurality of main categories tags; and receiving one or more main categories tags generated by the large language model in response to the large language model receiving the main categories tagging prompt.

Example 19 provides the method of example 18, where the main categories tagging prompt includes one or more sub-categories associated with each one of the main category tags.

Example 20 provides the method of example 18 or 19, where the main categories tagging prompt includes a second guiding instruction to include a first main categories tag rather than a second main categories tag for a third presence of an issue associated with the first main categories tag.

Example 21 provides the method of any one of examples 18-20, where the main categories tagging prompt includes a third instruction to first determine whether the first product review has a negative sentiment, and output one or more main categories tags only if the first product review is determined to have negative sentiment.

Example 22 provides the method of any one of examples 18-21, where the main categories tagging prompt includes a fourth instruction to output no main categories tags if the first product review is determined to have no negative sentiment.

Example 23 provides the method of any one of examples 18-22, further including storing the one or more main categories tags in the enriched reviews database.

Example 24 provides the method of any one of examples 18-23, further including for a first main categories tag in the one or more main categories tags, generating a first sub-categories tagging prompt and inputting the first sub-categories tagging prompt into the large language model, the first sub-categories tagging prompt including the first product review, and a first table having first sub-categories tags falling under the first main categories tag in a first column, first descriptions of the first sub-categories tags in a second column, and first examples of product reviews falling under the first sub-categories tags in a third column; and receiving one or more first sub-categories tags generated by the large language model in response to the large language model receiving the first sub-categories tagging prompt.

Example 25 provides the method of example 24, further including storing the one or more first sub-categories tags in the enriched reviews database.

Example 26 provides the method of any one of examples 18-23, further including for a second main categories tag in the one or more main categories tags, generating a second sub-categories tagging prompt and inputting the second sub-categories tagging prompt into the large language model, the second sub-categories tagging prompt including the first product review, and a second table having second sub-categories tags falling under the second main categories tag in a first column, second descriptions of the second sub-categories tags in a second column, and second examples of product reviews falling under the second sub-categories tags in a third column; and receiving one or more second sub-categories tags generated by the large language model in response to the large language model receiving the second sub-categories tagging prompt.

Example 27 provides the method of example 24, further including storing the one or more second sub-categories tags in the enriched reviews database.

Example 28 provides the method of any one of examples 1-27, further including identifying one or more data gaps based on the enriched reviews database; and in response to identifying the one or more data gaps, building one or more synthetic users to generate one or more product reviews for the one or more data gaps.

Example 29 provides the method of example 28, where identifying the one or more data gaps includes determining that a number of product reviews for the product being less than a threshold.

Example 30 provides the method of example 28, where identifying the one or more data gaps includes determining that a number of product reviews for the product from a specific demographic being less than a threshold.

Example 31 provides the method of any one of examples 1-30, further including receiving a third product review for the product originating from a first user; determining first user data corresponding to the first user; converting the first user data into first natural language log entries of a first memory log; incorporating the third product review of the product into the first memory log; prompting a model using a first subset of the first natural language log entries extracted from the first memory log using an extraction function; receiving a first generated response in response to prompting using the first subset; incorporating the first generated response into the first memory log; after incorporating the first generated response, extracting a second subset of the first natural language log entries from the first memory log using the extraction function; prompting the model using the second subset of the first natural language log entries; and receiving a second generated response in response to the prompting using the second subset, the second generated response including a fourth product review for a further product.

Example 32 provides the method of any one of examples 1-31, further including determining first user data corresponding to a first user who produced the first product review; converting the first user data into first natural language log entries of a first memory log; prompting a model using a first subset of the first natural language log entries extracted from the first memory log using an extraction function; receiving a first generated response in response to prompting using the first subset; incorporating the first generated response into the first memory log; after incorporating the first generated response, extracting a second subset of the first natural language log entries from the first memory log using the extraction function; prompting the model using the second subset of the first natural language log entries; and receiving a second generated response in response to the prompting using the second subset, the second generated response including the first product review.

Example 33 provides the method of any one of examples 1-32, further including determining first user data corresponding to a first user who produced the first product review; converting the first user data into first natural language log entries of a first memory log; incorporating the first product review of the product into the first memory log; prompting a model using a first subset of the first natural language log entries extracted from the first memory log using an extraction function; receiving a first generated response in response to prompting using the first subset; incorporating the first generated response into the first memory log; after incorporating the first generated response, extracting a second subset of the first natural language log entries from the first memory log using the extraction function; prompting the model using the second subset of the first natural language log entries; and receiving a second generated response in response to the prompting using the second subset, the second generated response including a predicted resolution to the first product review.

Example 34 provides the method of any one of examples 1-33, where the product is a consumer electronics device, and the first product review includes natural language text written by a purchaser of the consumer electronics device about one or more of: a user experience of the purchaser using the consumer electronics device and a purchasing experience of the purchaser purchasing the consumer electronics device.

Example 35 provides the method of any one of examples 1-33, where the product is a content item, and the first product review includes natural language text written by a quality control reviewer about a quality control aspect of a pipeline that delivers the content item to the quality control reviewer.

Example 36 provides the method of any one of examples 1-35, further including storing a feature vector generated by the large language model in response to receiving the rate sentiment prompt in a vector database as a first key; and storing a corresponding resolution to the first product review as a first value to the first key in the vector database.

Example 37 provides the method of example 36, further including receiving a fourth product review; generating a further rate sentiment prompt and inputting the further rate sentiment prompt into the large language model, the rate sentiment prompt including the fourth product review, the first rating instruction to return either an integer sentiment score or NULL for each one of a plurality of rating categories, and the first weighing instruction to increase a value for the integer sentiment score for a first presence of one or more first keywords having a specific connotation; searching for one or more matching feature vectors in the keys of the vector database that matches the feature vector generated by the large language model in response to receiving the further rate sentiment prompt; and determining one or more values in the vector database corresponding to the one or more matching feature vectors, where the one or more determined values include one or more resolutions to the fourth product review.

Example 38 provides a method, including identifying one or more data gaps in a reviews database; and in response to identifying the one or more data gaps, building one or more synthetic user to generate one or more product reviews for the one or more data gaps.

Example 39 provides a method, including receiving a feature vector generated by a large language model in response to receiving a prompt, the prompt including a first product review; storing the feature vector as a first key in a vector database; storing a corresponding resolution to the first product review as a first value to the first key in the vector database; receiving a further product review; generating and inputting a further prompt into the large language model, the further prompt including the further product review; searching for one or more matching feature vectors in the vector database that matches a further feature vector generated by the large language model in response to receiving the further prompt; and determining one or more values in the vector database corresponding to the one or more matching feature vectors, the one or more determined values including one or more resolutions to the further product review.

Example A provides one or more non-transitory computer-readable media storing instructions that, when executed by one or more processors, cause the one or more processors to perform any one of the methods provided in examples 1-39 and methods described herein.

Example B provides an apparatus comprising means to carry out or means for carrying out any one of the computer-implemented methods provided in examples 1-39 and methods described herein.

Example C provides a computer-implemented system, comprising one or more processors, and one or more non-transitory computer-readable media storing instructions that, when executed by the one or more processors, cause the one or more processors to perform any one of the methods provided in examples 1-39 and methods described herein.

Example D provides a computer-implemented system comprising one or more components illustrated in FIG. 1 to perform operations described herein.

Example E provides a computer-implemented system comprising one or more components illustrated in FIG. 4 to perform operations described herein.

Example F provides a computer-implemented system comprising one or more components illustrated in FIG. 8 to perform operations described herein.

Example G provides a computer-implemented system comprising one or more components illustrated in FIG. 10 to perform operations described herein.

Example H provides a computer-implemented system comprising one or more components illustrated in FIG. 21 to perform operations described herein.

Example I provides a computer-implemented system comprising one or more components illustrated in FIG. 22 to perform operations described herein.

Example J provides a computer-implemented system comprising one or more components illustrated in FIG. 24 to perform operations described herein.

Example K provides a computer-implemented system comprising one or more components illustrated in FIG. 25 to perform operations described herein.

Example L provides a computer-implemented system comprising one or more components illustrated in FIG. 26 to perform operations described herein.

Example M provides a computer-implemented system comprising one or more components illustrated in FIG. 28 to perform operations described herein.

Example N provides a computer-implemented system comprising one or more components illustrated in FIG. 29 to perform operations described herein.

Example O provides a computer-implemented system comprising one or more components illustrated in FIG. 30 to perform operations described herein.

### VARIATIONS AND OTHER NOTES

Although the operations of the example methods shown in and described with reference to the FIGS. are illustrated as occurring once each and in a particular order, it will be recognized that the operations may be performed in any suitable order and repeated as desired. Additionally, one or more operations may be performed in parallel. Furthermore, the operations illustrated in the FIGS. may be combined or may include more or fewer details than described.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well known features are omitted or simplified in order not to obscure the illustrative implementations.

Further, references are made to the accompanying drawings that form a part hereof, and in which are shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description and the accompanying drawings.

1. A method, comprising:
receiving a first product review for a product;
generating a rate sentiment prompt and inputting the rate sentiment prompt into a large language model, the rate sentiment prompt including the first product review, a first rating instruction to return either an integer sentiment score or a null value for each one of a plurality of rating categories, and a first weighing instruction to increase a value for the integer sentiment score for a first presence of one or more first keywords having a specific connotation;
receiving key-value pairs generated by the large language model in response to the large language model receiving the rate sentiment prompt, the key-value pairs having keys corresponding to the plurality of rating categories and values corresponding to the integer sentiment score or a null value;
storing the key-value pairs in an enriched reviews database; and
generating a graphical user interface for a dashboard based on information in the enriched reviews database.

2. The method of claim 1, further comprising:
generating a first summarize prompt and inputting the first summarize prompt into the large language model, the first summarize prompt including the first product review; and
receiving a first summary of the first product review generated by the large language model in response to the large language model receiving the first summarize prompt.

3. The method of claim 2, further comprising:
receiving a second product review for the product, the first product review and the second product review being associated with a same time-period;
generating a second summarize prompt and inputting the second summarize prompt into the large language model, the second summarize prompt including the second product review; and
receiving a second summary of the second product review generated by the large language model in response to the large language model receiving the second summarize prompt.

4. The method of claim 3, further comprising:
generating a time-period summarize prompt and inputting the time-period summarize prompt into the large language model, the time-period summarize prompt including the first summary and the second summary; and
receiving a time-period summary of the first summary and the second summary generated by the large language model in response to the large language model receiving the time-period summarize prompt.

5. The method of claim 4, wherein the time-period summarize prompt comprises:
a role definition for the large language model;
domain information about the product; and
a first instruction to generate a first natural language summary of positive sentiment, one or more first topics associated with positive sentiment, one or more first examples associated with each one of the one or more first topics, a second natural language summary of negative sentiment, one or more second topics associated with negative sentiment, and one or more second examples associated with each one of the one or more second topics.

6. The method of claim 5, wherein the time-period summarize prompt further comprises:
a second instruction to output a first number of mentions for each one of the one or more first topics and a second number of mentions for each one of the one or more second topics.

7. The method of claim 1, wherein the rate sentiment prompt further includes one or more of:
the plurality of rating categories and definitions associated with the plurality of rating categories; and
a first guiding instruction to include an integer sentiment score for a first rating category in the plurality of rating categories for a second presence of one or more second keywords associated with the first rating category.

8. The method of claim 1, further comprising:
generating a negative sentiment detection prompt and inputting the negative sentiment detection prompt into the large language model, the negative sentiment detection prompt including the first product review; and
receiving a negative sentiment Boolean flag generated by the large language model in response to the large language model receiving the negative sentiment detection prompt.

9. The method of claim 8, wherein the negative sentiment detection prompt further includes one or more of:
a second weighing instruction to return a value of 1 when the first product review is completely positive without reservations;
a third weighing instruction to return a value of 0 when the first product review is incomplete or missing; and
a fourth weighing instruction to return a value of 0 when the first product review is at least partly negative or has a qualifying statement.

10. The method of claim 8, further comprising:
in response to the negative sentiment Boolean flag indicating that negative sentiment is detected in the first product review, generating a main categories tagging prompt and inputting the main categories tagging prompt into the large language model, the main categories tagging prompt including the first product review, and a plurality of main categories tags; and
receiving one or more main categories tags generated by the large language model in response to the large language model receiving the main categories tagging prompt.

11. The method of claim 10, wherein the main categories tagging prompt comprises one or more of:
one or more sub-categories associated with each one of the main category tags;
a second guiding instruction to include a first main categories tag rather than a second main categories tag for a third presence of an issue associated with the first main categories tag;
a third instruction to first determine whether the first product review has a negative sentiment, and output one or more main categories tags only if the first product review is determined to have negative sentiment; and
a fourth instruction to output no main categories tags if the first product review is determined to have no negative sentiment.

12. The method of claim 10, further comprising:
for a first main categories tag in the one or more main categories tags, generating a first sub-categories tagging prompt and inputting the first sub-categories tagging prompt into the large language model, the first sub-categories tagging prompt including the first product review, and a first table having first sub-categories tags falling under the first main categories tag in a first column, first descriptions of the first sub-categories tags in a second column, and first examples of product reviews falling under the first sub-categories tags in a third column; and
receiving one or more first sub-categories tags generated by the large language model in response to the large language model receiving the first sub-categories tagging prompt.

13. The method of claim 10, further comprising:
for a second main categories tag in the one or more main categories tags, generating a second sub-categories tagging prompt and inputting the second sub-categories tagging prompt into the large language model, the second sub-categories tagging prompt including the first product review, and a second table having second sub-categories tags falling under the second main categories tag in a first column, second descriptions of the second sub-categories tags in a second column, and second examples of product reviews falling under the second sub-categories tags in a third column; and
receiving one or more second sub-categories tags generated by the large language model in response to the large language model receiving the second sub-categories tagging prompt.

14. The method of claim 1, further comprising:
identifying one or more data gaps in the enriched reviews database, wherein identifying the one or more data gaps includes one or more of: determining that a number of product reviews for the product being less than a threshold, and determining that a number of product reviews for the product from a specific demographic being less than a threshold; and
in response to identifying the one or more data gaps, building one or more synthetic users to generate one or more product reviews for the one or more data gaps.

15. The method of claim 1, wherein the product is a content item, and the first product review comprises natural language text written by a quality control reviewer about a quality control aspect of a pipeline that delivers the content item to the quality control reviewer.

16. The method of claim 1, further comprising:
storing a feature vector generated by the large language model in response to receiving the rate sentiment prompt in a vector database as a first key;
storing a corresponding resolution to the first product review as a first value to the first key in the vector database;
receiving a fourth product review;
generating a further rate sentiment prompt and inputting the further rate sentiment prompt into the large language model, the rate sentiment prompt including the fourth product review, the first rating instruction to return either an integer sentiment score or NULL for each one of a plurality of rating categories, and the first weighing instruction to increase a value for the integer sentiment score for a first presence of one or more first keywords having a specific connotation;
searching for one or more matching feature vectors in the keys of the vector database that matches the feature vector generated by the large language model in response to receiving the further rate sentiment prompt; and
determining one or more values in the vector database corresponding to the one or more matching feature vectors, wherein the one or more determined values include one or more resolutions to the fourth product review.

17. One or more non-transitory computer-readable media storing instructions that, when executed by one or more processors, cause the one or more processors to:
receive a first product review for a product;
generate a negative sentiment detection prompt and inputting the negative sentiment detection prompt into a large language model, the negative sentiment detection prompt including the first product review;
receive a negative sentiment Boolean flag generated by the large language model in response to the large language model receiving the negative sentiment detection prompt;
in response to the negative sentiment Boolean flag indicating that negative sentiment is detected in the first product review, generate a main categories tagging prompt and inputting the main categories tagging prompt into the large language model, the main categories tagging prompt including the first product review, and a plurality of main categories tags;
receive one or more main categories tags generated by the large language model in response to the large language model receiving the main categories tagging prompt;
storing the one or more main categories tags in an enriched reviews database; and
generate a graphical user interface for a dashboard based on information in the enriched reviews database.

18. The one or more non-transitory computer-readable media of claim 17, wherein the negative sentiment detection prompt further includes one or more of:
a second weighing instruction to return a value of 1 when the first product review is completely positive without reservations;
a third weighing instruction to return a value of 0 when the first product review is incomplete or missing; and
a fourth weighing instruction to return a value of 0 when the first product review is at least partly negative or has a qualifying statement.

19. A computer-implemented system, comprising:
one or more processors, and
one or more non-transitory computer-readable media storing instructions that, when executed by the one or more processors, cause the one or more processors to:
receive a first product review for a product;
in response to detecting negative sentiment in the first product review, generate a main categories tagging prompt and inputting the main categories tagging prompt into a large language model, the main categories tagging prompt including the first product review, and a plurality of main categories tags;
receive one or more main categories tags generated by the large language model in response to the large language model receiving the main categories tagging prompt;
store the one or more main categories tags in an enriched reviews database; and
generate a graphical user interface for a dashboard based on information in the enriched reviews database.

20. The computer-implemented system of claim 19, wherein the instructions cause the one or more processors to further:
for a first main categories tag in the one or more main categories tags, generating a first sub-categories tagging prompt and inputting the first sub-categories tagging prompt into the large language model, the first sub-categories tagging prompt including the first product review, and a first table having first sub-categories tags falling under the first main categories tag in a first column, first descriptions of the first sub-categories tags in a second column, and first examples of product reviews falling under the first sub-categories tags in a third column;
receiving one or more first sub-categories tags generated by the large language model in response to the large language model receiving the first sub-categories tagging prompt; and
storing the one or more first sub-categories tags in the enriched reviews database.
